(19) United States
(12) Patent Application Publication
(10) Pub. No.: US 2002/0133506 A1
(43) Pub. Date: Sep. 19, 2002

(54) Server delivering the degree of interest in broadcast programs and method thereof and computer program of the method

(76) Inventor: Jun-Ichi Yamato, Tokyo (JP)

Correspondence Address: McGinn & Gibb, PLLC, Suite 200, 8321 Old Courthouse Road, Vienna, VA, 22182-3817, US

(21) Appl. No.: 10/098,465

(22) Filed: Mar. 18, 2002

(30) Foreign Application Priority Data
Mar. 19, 2001 (JP) 079355/2001

(51) Int. Cl. G06F 7/00; H04H 9/00

(52) U.S. Cl. 707/104.1; 725/9

(57) ABSTRACT

A server delivering the degree of interest in broadcast programs and a method thereof and a computer program of the method are provided. The server utilizes information, which is being transmitted and has topics on the Internet, and delivers the information to users who use the information when the users select a broadcast program. Further, the server delivers a message list including reference information for programs to the users. With this, the users can easily collect the reaction of other users for programs. The server provides a message storing means for storing messages supplied from viewers, a message counting means for counting the number of messages for each program and stores the counted number of message for each program in a database of the degree of interest in broadcast programs. And the server delivers the number of message for each program, as the degree of interest in each program, to the users by obtaining from the database of the degree of interest in broadcast programs.

### BACKGROUND OF THE INVENTION

The present invention relates to a server delivering the degree of interest in broadcast programs and a method thereof and a computer program of the method, in particular, in which the degree of interest in each broadcast program is calculated based on messages supplied from viewers via a network and the calculated result is delivered to the users.

1. Description of the Related Art

Recently, a TV broadcast system and a radio broadcast system have been digitalized, further communication via a network such as the Internet has been widely used. Consequently, the number of channels, which users can watch or listen to, has largely increased, compared to the age when only ground wave analog broadcasts were used. Therefore, in order to meet the needs of many users, each broadcasting station produces various genres of programs and broadcasts the programs.

However, although the possibility, which user favorite programs are broadcast, has been becoming very high, users have to consume time very much to find their favorite programs, because the number of channels, from which the users must select one program, is very large. The number of broadcast programs broadcasting at present, by only broadcasting stations using ground waves, exceeds 100. However, when the broadcasting stations and CATV (cable television) stations increase their broadcast programs largely, it actually becomes impossible for the users to select their favorite programs. Therefore, the users need a tool to select their favorite programs effectively. That is, it has been desired that a method with which the users can select their favorite programs easily without consuming their time largely, by obtaining information being a judging reference for selecting their favorite programs.

In Japanese Patent Application Laid-Open No. HEI 9-261609, as a first conventional technology, popularity ratings of programs are used as a judging reference. At this technology, users can know the popularity rating of a program, that is, the users can know how many users are watching or watched the program. Therefore, the users can select the program based on this information.

However, the popularity rating of a program used at the first conventional technology is not considered as the best program selecting reference. Because the popularity rating of a program is an index only showing the number of users watching the program, and does not always show the degree of interest in the program exactly. That is, the popularity rating does not show how large the interest of the watching users is. For example, two cases are considered. One case is that many TV sets are only tuned on, and the other case is that many users are watching TV with high interest and they are seriously discussing the subject on the program. In these cases, if the number of watching users is the same in both cases, the popularity ratings of the two programs become the same.

Especially, when the number of channels is increased at the broadcast and the communication, it is supposed that the popularity rating of each program will become very low, compared with the popularity rating of the program broadcasting or communicating at present. And there is a possibility that the difference among the popularity ratings of programs becomes small, due to the large number of programs. Further, when recording by using a HD (hard disk) instrument prevails, there is a possibility that the current popularity rating calculated by counting the number of watching users at real time does not correctly show how many users are actually watching the program, when some users are recording the program.

As a second conventional technology, in Japanese Patent Application Laid-Open No. HEI 1-1187328, the degree of interest in programs are disclosed. In this second conventional technology, a keyword is attached to each program and users register keywords beforehand, and when a user registered keyword matches with the keyword of a program, the user can select the program. However, generally the interest of users changes in the passage of time. Consequently, in order to select programs correctly, the users always have to register keywords, by finding keywords that match with their own interest.

Generally, a user does not watch a program by selecting the program that matches with his/her interest, but in many cases, the user watches the program by selecting the program based on an empirical rule. The empirical rule is that a program, which other persons have interest in, is a program, which the user himself/herself must have interest in. Therefore, the popularity rating in the first conventional technology can be said to be an index that only satisfies the needs of this kind of users who judge by using the empirical rule. That is, this information of the popularity rating only shows how many other users are watching or watched the program.

On a network such as the Internet, by using Web sites, a lot of information has been transmitted. For example, so called the chat technology, the mail technology, and the mailing list technology such as the BBS (bulletin board system) technology, and the IRC (Internet relay chat (RFC1495, 2812) ) technology have been widely used, and direct communication among users have been able to used widely.

Some users transmit information introducing the contents of a program or commenting on the program by using the technologies mentioned above. This information is the information from the users (program viewers) and not from the persons in the broadcasting station sides, therefore, this information can be said to be objective information, and is very useful for an index at selecting a program. Especially, the users, who transmit messages concerning a program by using these technologies, can be said to be the users having strong interest in the program. Therefore, the contents of this message are important, further the number of times transmitting messages for the program can be considered as a useful index showing the degree of interest in the program of the users.

### SUMMARY OF THE INVENTION

It is therefore an object of the present invention to provide a server delivering the degree of interest in broadcast programs and a method thereof and a computer program of the method, in particular, in which the degree of interest in each broadcast program is made to be a numerical value based on messages supplied from viewers via a network such as the Internet and the numerical value is delivered to users so that the users use the delivered information as a judging reference at selecting a program. Further, at the present invention, the messages concerning the programs, supplied by various methods and means on the network from the viewers, are collected, and the collected messages being information are delivered to the users.

According to a first aspect of the present invention, there is provided a server delivering the degree of interest in broadcast programs. The server delivering the degree of interest in broadcast programs provides a counting means for counting the number of messages for each program supplied from viewers via a network, and a delivering means for delivering the number of messages for each program that was counted at the counting means to users via a network as the degree of interest in each program.

According to a second aspect of the present invention, in the first aspect, the server delivering the degree of interest in broadcast programs further provides a database of the degree of interest in broadcast programs for storing the number of messages for each program, counted at the counting means, and the delivering means delivers the number of messages for each program to the users via the network as the degree of interest in each program by taking out the number of messages for each program from the database of the degree of interest in broadcast programs.

According to a third aspect of the present invention, in the first aspect, the counting means further counts the number of messages for a scene of each program when the scene of each program is designated, and also further counts the number of messages for each of a series of programs when a program belongs to a series of programs.

According to a fourth aspect of the present invention, in the first aspect, each of the messages supplied from the viewers includes data identifying each of programs, and the counting means counts the number of messages for each program based on the data identifying each of programs, and the delivering means delivers the number of messages for each program to the users, based on the data identifying each of programs.

According to a fifth aspect of the present invention, in the third aspect, each of the messages supplied from the viewers includes data identifying each program and the scene of each program, and the counting means counts the number of messages for each program and the scene of each program based on the data identifying each program and the scene of each programs, and the delivering means delivers the number of messages for each program and the scene of each program to the users, based on the data identifying each program and the scene of each program, and each of the messages supplied from the viewers includes data identifying each program and a series of programs, when a program belongs to a series of programs, and the counting means counts the number of messages for each program and each of the series of programs based on the data identifying each program and the series of programs, and the delivering means delivers the number of messages for each program and the series of programs to the users, based on the data identifying each program and the series of programs.

According to a sixth aspect of the present invention, in the first aspect, the counting means counts the number of messages for each program supplied from the viewers via the network every designated period, and the delivering means delivers the number of messages for each program counted at the counting means every designated period, to the users via the network, as the degree of interest in each program.

According to a seventh aspect of the present invention, in the third aspect, the counting means counts the number of messages for each program and the scene of each program supplied from the viewers via the network every designated period, and the delivering means delivers the number of messages for each program and the scene of each program counted at the counting means every designated period, to the users via the network, as the degree of interest in each program and the scene of each program, and the counting means counts the number of messages for each program and each of a series of programs supplied from the viewers via the network every designated period, and the delivering means delivers the number of messages for each program and each of the series of programs counted at the counting means every designated period, to the users via the network, as the degree of interest in each program and each of the series of programs.

According to an eighth aspect of the present invention, in the first aspect, the server delivering the degree of interest in broadcast programs further provides a message list making means for making a message list for programs in which reference information for each program is stored, by obtaining the reference information for each program from the messages supplied from the viewers via the network, and the delivering means delivers the message list to the users.

According to a ninth aspect of the present invention, in the third aspect, the server delivering the degree of interest in broadcast programs further provides a message list making means for making a message list for each scene of programs in which reference information for each scene of programs is stored, by obtaining the reference information for each scene of programs from the messages supplied from the viewers via the network, and the delivering means delivers the message list to the users, further the message list making means for making a message list for each of a series of programs in which reference information for each of a series of programs is stored, by obtaining the reference information for each of a series of programs from the messages supplied from the viewers via the network, and the delivering means delivers the message list to the users,

According to a tenth aspect of the present invention, in the eighth aspect, the delivering means delivers a message in the message list to a user, when the message is selected by the user.

According to an eleventh aspect of the present invention, in the ninth aspect, the delivering means delivers a message every scene of a program in the message list to a user, when the scene is selected by the user, and the delivering means delivers a message for a series of programs in the message list to a user, when the series of programs is selected by the user.

According to a twelfth aspect of the present invention, in the tenth aspect, the delivering means delivers the message list every designated period when the messages were supplied from the viewers to the users.

According to a thirteenth aspect of the present invention, in the eleventh aspect, the delivering means delivers the message list every designated period when the messages were supplied from the viewers to the users.

According to a fourteenth aspect of the present invention, in the first aspect, the delivering means delivers a program list by designating a region or broadcasting stations and designating a broadcasting period to the users, and the program list includes program information in which a title of each program, the number of messages for each program or the modified degree of interest in each program that the number of messages for each program is divided by the number of messages for all programs in the program list are included.

According to a fifteenth aspect of the present invention, in the fourteenth aspect, in case that each scene of programs is handled, the program list is made for each scene of the programs, and in case that each of a series of programs is handled, the program list is made for each of the series of programs.

According to a sixteenth aspect of the present invention, in the first aspect, the delivering means delivers a ranking list by designating a region or broadcasting stations and designating a broadcasting period to the users, and the ranking list shows programs in the order that their number of messages is large.

According to a seventeenth aspect of the present invention, there is provided a method delivering the degree of interest in broadcast programs. The method delivering the degree of interest in broadcast programs provides the steps of; identifying each of messages, which include data identifying a program, supplied from viewers via a network, to which program each of the messages is related, calculating the degree of interest in each program by using the identified messages, and delivering the degree of interest in each program, calculated by using the identified messages, to users via a network.

According to an eighteenth aspect of the present invention, the method delivering the degree of interest in broadcast programs provides the steps of; identifying each of messages, which include data identifying a program and data identifying a scene in the program, supplied from viewers via a network, to which program and scene each of the messages is related, calculating the degree of interest in each program and each scene of the program by using the identified messages, and delivering the degree of interest in each program and each scene of the program, calculated by using the identified messages, to users via a network.

According to a nineteenth aspect of the present invention, the method delivering the degree of interest in broadcast programs provides the steps of; identifying each of messages, which include data identifying a program and data identifying a series of programs, supplied from viewers via a network, to which program and series of programs each of the messages is related, when the program belongs to a series of programs, calculating the degree of interest in each program and each of the series of programs by using the identified messages, and delivering the degree of interest in each program and each of the series of programs, calculated by using the identified messages, to users via a network.

According to a twentieth aspect of the present invention, in the seventeenth aspect, the degree of interest in each program is calculated every period when the messages were supplied from the viewers.

According to a twenty-first aspect of the present invention, in the eighteenth aspect, the degree of interest in each program and each scene of the program is calculated every period when the messages were supplied from the viewers.

According to a twenty-second aspect of the present invention, in the nineteenth aspect, the degree of interest in each program and each of the series of programs is calculated every period when the messages were supplied from the viewers.

According to a twenty-third aspect of the present invention, the method delivering the degree of interest in broadcast programs provides the steps of; identifying each of messages, which include data identifying a program and reference information for the program, supplied from viewers via a network, to which program each of the messages is related, making a message list for programs by using the identified messages, and delivering the message list to users via a network.

According to a twenty-fourth aspect of the present invention, the method delivering the degree of interest in broadcast programs provides the steps of; identifying each of messages, which include data identifying a program and data identifying a scene in the program, supplied from viewers via a network, to which program and scene each of the messages is related, making a message list for programs and scenes of the programs by using the identified messages, and delivering the message list to users via a network.

According to a twenty-fifth aspect of the present invention, the method delivering the degree of interest in broadcast programs provides the steps of; identifying each of messages, which include data identifying a program and data identifying a series of programs, supplied from viewers via a network, to which program and series of programs each of the messages is related, when the program belongs to a series of programs, making a message list for programs and the series of programs by using the identified messages, and delivering the message list to users via a network.

According to a twenty-sixth aspect of the present invention, in the seventeenth aspect, the method delivering the degree of interest in broadcast programs further provides the steps of; designating a region or broadcasting stations and designating a broadcasting period, making a program list by obtaining program information in the designated region or broadcasting stations and the designated period and the degree of interest in each program, and delivering the program list to the users via the network.

According to a twenty-seventh aspect of the present invention, in the eighteenth aspect, the method delivering the degree of interest in broadcast programs further provides the steps of; designating a region or broadcasting stations and designating a broadcasting period, making a program list by obtaining program information in the designated region or broadcasting stations and the designated period and the degree of interest in each program and each scene of the program, and delivering the program list to the users via the network.

According to a twenty-eighth aspect of the present invention, in the nineteenth aspect, the method delivering the degree of interest in broadcast programs further provides the steps of; designating a region or broadcasting stations and designating a broadcasting period, making a program list by obtaining program information in the designated region or broadcasting stations and the designated period and the degree of interest in each program and each of the series of programs, and delivering the program list to the users via the network.

According to a twenty-ninth aspect of the present invention, in the seventeenth aspect, the method delivering the degree of interest in broadcast programs further provides the steps of; designating a region or broadcasting stations and designating a broadcasting period, making a ranking list by obtaining program information in the designated region or broadcasting stations and the designated period and the degree of interest in each program, and by disposing programs in the program information in the order that their degree of interest is large, and delivering the ranking list to the users via the network.

According to a thirtieth aspect of the present invention there is provided a computer program delivering the degree of interest in broadcast programs. The computer program delivering the degree of interest in broadcast programs provides the steps of; identifying each of messages, which include data identifying a program, supplied from viewers via a network, to which program each of the messages is related, calculating the degree of interest in each program by using the identified messages, and delivering the degree of interest in each program, calculated by using the identified messages, to users via a network.

According to a thirty-first aspect of the present invention, the computer program delivering the degree of interest in broadcast programs provides the steps of; identifying each of messages, which include data identifying a program and data identifying a scene in the program, supplied from viewers via a network, to which program and scene each of the messages is related, calculating the degree of interest in each program and each scene of the program by using the identified messages, and delivering the degree of interest in each program and each scene of the program, calculated by using the identified messages, to users via a network.

According to a thirty-second aspect of the present invention, the computer program delivering the degree of interest in broadcast programs provides the steps of; identifying each of messages, which include data identifying a program and data identifying a series of programs, supplied from viewers via a network, to which program and series of programs each of the messages is related, when the program belongs to a series of programs, calculating the degree of interest in each program and each of the series of programs by using the identified messages, and delivering the degree of interest in each program and each of the series of programs, calculated by using the identified messages, to users via a network.

According to a thirty-third aspect of the present invention, in the thirtieth aspect, the degree of interest in each program is calculated every period when the messages were supplied from the viewers.

According to a thirty- fourth aspect of the present invention, in the thirty-first aspect, the degree of interest in each program and each scene of the program is calculated every period when the messages were supplied from the viewers.

According to a thirty-fifth aspect of the present invention, in the thirty-second aspect, the degree of interest in each program and each of the series of programs is calculated every period when the messages were supplied from the viewers.

According to a thirty-sixth aspect of the present invention, the computer program delivering the degree of interest in broadcast programs provides the steps of; identifying each of messages, which include data identifying a program and reference information for the program, supplied from viewers via a network, to which program each of the messages is related, making a message list for programs by using the identified messages, and delivering the message list to users via a network.

According to a thirty-seventh aspect of the present invention, the computer program delivering the degree of interest in broadcast programs provides the steps of; identifying each of messages, which include data identifying a program and data identifying a scene in the program, supplied from viewers via a network, to which program and scene each of the messages is related, making a message list for programs and scenes of the programs by using the identified messages, and delivering the message list to users via a network.

According to a thirty-eighth aspect of the present invention the computer program delivering the degree of interest in broadcast programs provides the steps of; identifying each of messages, which include data identifying a program and data identifying a series of programs, supplied from viewers via a network, to which program and series of programs each of the messages is related, when the program belongs to a series of programs, making a message list for programs and the series of programs by using the identified messages, and delivering the message list to users via a network.

According to thirty-ninth aspect of the present invention, in the thirtieth aspect, the computer program delivering the degree of interest in broadcast programs further provides the steps of; designating a region or broadcasting stations and designating a broadcasting period, making a program list by obtaining program information in the designated region or broadcasting stations and the designated period and the degree of interest in each program, and delivering the program list to the users via the network.

According to a fortieth aspect of the present invention, in the thirty-first aspect, the computer program delivering the degree of interest in broadcast programs further provides the steps of; designating a region or broadcasting stations and designating a broadcasting period, making a program list by obtaining program information in the designated region or broadcasting stations and the designated period and the degree of interest in each program and each scene of the program, and delivering the program list to the users via the network.

According to a forty-first aspect of the present invention, in the thirty-second aspect, the computer program delivering the degree of interest in broadcast programs further provides the steps of; designating a region or broadcasting stations and designating a broadcasting period, making a program list by obtaining program information in the designated region or broadcasting stations and the designated period and the degree of interest in each program and each of the series of programs, and delivering the program list to the users via the network.

According to a forty-second aspect of the present invention, in the thirtieth aspect, the computer program delivering the degree of interest in broadcast programs further provides the steps of; designating a region or broadcasting stations and designating a broadcasting period, making a ranking list by obtaining program information in the designated region or broadcasting stations and the designated period and the degree of interest in each program, and by disposing programs in the program information in the order that their degree of interest is large, and delivering the ranking list to the users via the network.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a conceptual structure of a system delivering the degree of interest in broadcast programs of the present invention;

FIG. 2 is a block diagram showing a detailed structure of the system delivering the degree of interest in broadcast programs shown in FIG. 1;

FIG. 3 is a block diagram showing a structure of a part of a server delivering the degree of interest in broadcast programs at a first embodiment of the present invention;

FIG. 4 is a diagram showing a data structure in a database of the degree of interest in broadcast programs shown in FIG. 3;

FIG. 5 is a flowchart showing operation of a message counting means shown in FIG. 3;

FIG. 6 is a flowchart showing operation of the message counting means at a first modified example of the first embodiment of the present invention;

FIG. 7 is a flowchart showing operation of the message counting means at a second modified example of the first embodiment of the present invention;

FIG. 8 is a block diagram showing a structure of a part of a server delivering the degree of interest in broadcast programs at a second embodiment of the present invention;

FIG. 9 is a diagram showing a data structure in a database of a series of programs shown in FIG. 8;

FIG. 10 is a flowchart showing operation of a message counting means shown in FIG. 8;

FIG. 11 is a block diagram showing a structure of a part of a server delivering the degree of interest in broadcast programs at a third embodiment of the present invention;

FIG. 12 is a flowchart showing operation of a message classifying means shown in FIG. 11;

FIG. 13 is a flowchart showing operation of the message classifying means at a first modified example of the third embodiment of the present invention;

FIG. 14 is a flowchart showing operation of the message classifying means at a second modified example of the third embodiment of the present invention;

FIG. 15 is a block diagram showing a structure of a part of a server delivering the degree of interest in broadcast programs at a fourth embodiment of the present invention;

FIG. 16 is a flowchart showing operation of a message classifying means shown in FIG. 15;

FIG. 17 is a block diagram showing a structure of a part of a server delivering the degree of interest in broadcast programs at a fifth embodiment of the present invention;

FIG. 18 is a diagram showing a data structure in a database of the degree of interest in broadcast programs shown in FIG. 17;

FIG. 19 is a flowchart showing operation of the message counting means 1b shown in FIG. 17;

FIG. 20 is a flowchart showing operation of a message counting means at a modified example of the fifth embodiment of the present invention;

FIG. 21 is a block diagram showing a structure of a part of a server delivering the degree of interest in broadcast programs at a sixth embodiment of the present invention;

FIG. 22 is a flowchart showing operation of a message classifying means shown in FIG. 21;

FIG. 23 is a flowchart showing operation of the message classifying means at a modified example of the sixth embodiment of the present invention;

FIG. 24 is a block diagram showing a structure of a part of a server delivering the degree of interest in broadcast programs at a seventh embodiment of the present invention;

FIG. 25 is a diagram showing a data structure in a database of the degree of interest in broadcast programs shown in FIG. 24;

FIG. 26 is a block diagram showing a structure of a part of the server delivering the degree of interest in broadcast programs at an eighth embodiment of the present invention;

FIG. 27 is a block diagram showing a structure of a part of a server delivering the degree of interest in broadcast programs at a ninth embodiment of the present invention;

FIG. 28 is a diagram showing a data structure of a database of message lists shown in FIG. 27;

FIG. 29 is a diagram showing operation for referring to a reference list table shown in FIG. 28;

FIG. 30 is a flowchart showing operation of a message list making means shown in FIG. 27;

FIG. 31 is a flowchart showing message list renewing operation at the message list making means shown in FIG. 27;

FIG. 32 is a flowchart showing operation of the message list making means at a modified example of the ninth embodiment of the present invention;

FIG. 33 is a block diagram showing a structure of a part of a server delivering the degree of interest in broadcast programs at a tenth embodiment of the present invention;

FIG. 34 is a diagram showing a data structure of a database of message lists shown in FIG. 33;

FIG. 35 is a diagram showing operation for referring to a reference list table shown in FIG. 34;

FIG. 36 is a flowchart showing operation of a message list making means shown in FIG. 33;

FIG. 37 is a flowchart showing message list renewing operation at the message list making means shown in FIG. 33;

FIG. 38 is a block diagram showing a structure of a part of a server delivering the degree of interest in broadcast programs at an eleventh embodiment of the present invention;

FIG. 39 is a flowchart showing operation at a program list delivering means shown in FIG. 38;

FIG. 40 is a diagram showing a program list made by the program list delivering means at the eleventh embodiment of the present invention;

FIG. 41 is a diagram showing formats of program information in the program list shown in FIG. 40;

FIG. 42 is a block diagram showing a structure of a part of a server delivering the degree of interest in broadcast programs at a twelfth embodiment of the present invention;

FIG. 43 is a flowchart showing operation at a program list delivering means shown in FIG. 42.

FIG. 44 is a diagram showing formats of program information in a program list formed at the program list delivering means at a modified example of the twelfth embodiment of the present invention;

FIG. 45 is a block diagram showing a structure of a part of a server delivering the degree of interest in broadcast programs at a fifteenth embodiment of the present invention;

FIG. 46 is a diagram showing formats of reference information for programs in the message list at the fifteenth embodiment of the present invention;

FIG. 47 is a block diagram showing a structure of a part of a server delivering the degree of interest in broadcast programs at a sixteenth embodiment of the present invention;

FIG. 48 is a diagram showing formats of program information in a program list formed at a program list delivering means at the sixteenth embodiment of the present invention;

FIG. 49 is a block diagram showing a structure of a part of a server delivering the degree of interest in broadcast programs at a seventeenth embodiment of the present invention;

FIG. 50 is a block diagram showing a structure of a part of a server delivering the degree of interest in broadcast programs at an eighteenth embodiment of the present invention;

FIG. 51 is a diagram showing formats of program information at a program information delivering means at the eighteenth embodiment of the present invention;

FIG. 52 is a block diagram showing a structure of a part of a server delivering the degree of interest in broadcast programs at a twentieth embodiment of the present invention;

FIG. 53 is a diagram showing formats of program information at a program information delivering means at the twentieth embodiment of the present invention;

FIG. 54 is a block diagram showing a structure of a part of a server delivering the degree of interest in broadcast programs at a twenty-first embodiment of the present invention;

FIG. 55 is a diagram showing formats of link information at a program information delivering means at the twenty-first embodiment of the present invention;

FIG. 56 is a block diagram showing a structure of a part of a server delivering the degree of interest in broadcast programs at a twenty-second embodiment of the present invention; and

FIG. 57 is a diagram showing formats of ranking information at a ranking delivering means at the twenty-second embodiment of the present invention.

### DESCRIPTION OF THE PREFERRED EMBODIMENTS

Referring now to the drawings, embodiments of the present invention are explained in detail. First, a server delivering the degree of interest in broadcast programs of the present invention is explained. Following this, a method delivering the degree of interest in broadcast programs and a computer program of the method are explained. In the embodiments of the present invention, the broadcast programs include communication programs.

The server delivering the degree of interest in broadcast programs calculates the degree of interest in broadcast programs of viewers and listeners (hereinafter referred to as viewers), based on messages concerning TV and radio broadcast programs in chats, bulletin boards, and mailing lists of Web sites on a network such as the Internet. This calculated degree of interest in broadcast programs is delivered to users via a network such as the Internet as an effective index at selecting a broadcast program by each user.

Moreover, the messages, supplied from the viewers by using technologies such as the BBS technology, the IRC technology, a Web site technology, an e-mail technology on the network, are classified into each broadcast program, and the classified messages (information) are delivered to the users.

Furthermore, program tags are used at calculating the degree of interest and classifying the messages, therefore, consuming labor and processes are very small at the present invention. The program tags are explained in detail later.

Especially, plural programs are handled as a series of programs, or a program is divided into an arbitrary number of parts and each of the divided parts of the program is handled as a scene. With this, a judging reference being more effective at selecting a program is delivered to the users.

Further, by counting the messages every arbitrary period, a judging reference at selecting a program by users, which matches with the change of the liking of the users, is delivered to the users.

As mentioned above, according to the present invention, the judging reference at selecting programs by users can be delivered to the users, by using messages supplied from the viewers via the network.

FIG. 1 is a block diagram showing a conceptual structure of a system delivering the degree of interest in broadcast programs of the present invention. As shown in FIG. 1, in the system delivering the degree of interest in broadcast programs of the present invention, a service delivering side 1000 communicates with viewers 2000 and users 3000, by using their servers and terminals. In this, actually the same person works as the viewer 2000 and the user 3000, however, in order to make the explanation simple, the viewers 2000 are separated from the users 3000 in the explanation. The service delivering side 1000 has a means for storing messages concerning programs supplied from the viewers 2000, and a means for delivering information, which the stored messages were processed, to the users 3000. The viewers 2000 supply the messages to the service delivering side 1000. The users 3000 utilize information, which the service delivering side 1000 applied designated processes to the messages. In this, the viewers 2000 do not only view programs but also listen to the programs, however, in the embodiments, the viewers 2000 are expressed as viewers not expressing viewers and listeners.

In this, the messages include at least data identifying a program (hereinafter referred to as program identifying data) and also data introducing and/or commenting the program made by the viewers arbitrarily (hereinafter referred to as content data). These data are not limited to data made of letters (characters), but can be image data.

The service delivering side 1000 can collect these messages by using arbitrary methods. For example, the service delivering side 1000 gives the viewers 2000 a message registering Web page, to which the viewers 200 can input at least the program identifying data and the content data, and the service delivering side 1000 makes information to be delivered to the users 3000 and stores the information, based on the data inputted to the Web page. Or the service delivering side 1000 decides a format, in which the program identifying data and the content data are written, and the viewers 2000 make messages corresponding to this format by using e-mails, and the service delivering side 1000 makes information to be delivered to the users 3000 and stores the information. Or the service delivering side 1000 gives the viewers 2000 a BBS, to which the viewers 2000 can input at least the program identifying data and the content data, and the service delivering side 1000 makes information to be delivered to the users 3000 and stores the information, based on the data inputted to the BBS. Or the service delivering side 1000 gives the viewers 2000 a chat system, to which the viewers 2000 can input at least the program identifying data and the content data, and the service delivering side 1000 makes information to be delivered to the users 3000 and stores the information, based on the data inputted to the chat system.

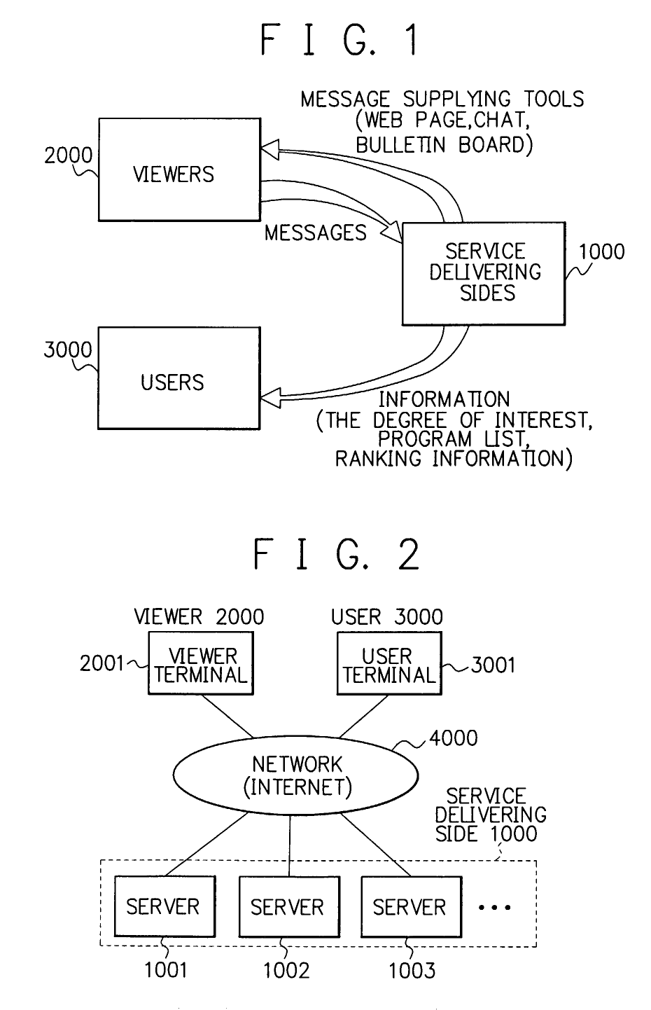

FIG. 2 is a block diagram showing a detailed structure of the system delivering the degree of interest in broadcast programs shown in FIG. 1. As shown in FIG. 2, the service delivering side 1000 provides plural servers delivering the degree of interest in broadcast programs 1001, 1002, 1003, . . . Each of the viewers 2000 provides a viewer terminal 2001, and each of the users 3000 provides a user terminal 3001. The servers 1001, 1002, 1003, . . . are connected to the viewer terminals 2001 and the user terminals 3001 via a network 4000 such as the Internet. Each of the servers 1001, 1002, 1003, . . . provides a communication means for connecting to the network 4000 and storage such as a HD for storing various data, so that the service delivering side 1000 realizes various functions that the viewers 2000 can supply messages and the users 3000 can receive the information. In this, plural viewers 2000 and plural users 3000 are actually connected to the service delivering side 1000, however, in order to make the explanation simple, one viewer 2000 and one user 3000 are used in the following explanation.

The viewer terminal 2001 and the user terminal 3001 are a PC (personal computer) or a Web terminal and provide a communication instrument such as a MODEM (modulator-demodulator), a terminal adapter, or a cable MODEM, and have a function to connect to the Internet. And the viewer terminal 2001 and the user terminal 3001 provides an input and output unit such as a keyboard, a mouse, and a remote control unit. Further, the viewer terminal 2001 and the user terminal 3001 can provide an antenna and a tuner for viewing and listening to programs. In this, the viewer terminal 2001 and the user terminal 3001 are defined by only providing in the viewer 2000 and the user 3000 respectively, actually, the both terminals 2001 and 3001 can be the same. Only for making the explanation easy, the viewer 2000 is defined as a message supplying side, and the user 3000 is defined as an information receiving side. As mentioned above, the viewer can become the user, and the user can become the viewer.

In the following explanation, the Internet is used as the network 4000, and as mentioned above, in order to make the explanation simple, one viewer terminal 2001 and one user terminal 3001 are used, further, the service delivering side 1000 provides plural servers 1001, 1002, 1003, . . . , however, actually it is enough that only one server 1001 is used. And it is possible that plural service delivering sides 1000, having the same functions and performance, are provided. As mentioned above, when the plural servers are provided in the service delivering side 1000 and a distributed processing system of a server and client type is used, the amount of information delivering to the users 2000 can be made to be very large and the information delivery speed can be made to be fast.

The system delivering the degree of interest in broadcast programs has the structure mentioned above, and obtains messages from viewers concerning programs via a network such as the Internet, and makes information, which becomes a judging reference at the time when the users select programs, based on the messages, and delivers the information to the users.

The server delivering the degree of interest in broadcast programs has plural functions combined the following three functions. A first function is a message counting function for counting the number of messages supplied from viewers. A second function is a message list making function for making the list of messages. And a third function is an information delivering function for delivering information made by the messages to users.

A method delivering the degree of interest in broadcast programs executes the three functions mentioned above in order.

A computer program of the method makes a computer realize the three functions mentioned above.

Plural examples are explained every function, however it is enough for the server, the method, and the computer program to adopt some of the plural examples being mentioned later. For example, in case that the first function is adopted, it does not need to realize all examples being shown later, but it is enough that at least one of the examples in the first function is adopted. Several examples combined the plural functions are shown later, however, the several examples are examples being suitable at the present invention, and the present invention is not limited to the examples being shown later.

First, a message counting function for counting the number of messages for each program supplied from viewers (1-1) is explained in detail. A first example (1-1-a) of the message counting function for counting the number of messages for each program is explained. The server counts the number of messages for each program supplied from viewers. This function can be realized by providing a message counting means in the server. This message counting means counts the number of supplied messages for each program and/or for each of a series of programs, based on the program identifying data such as a program tag including in each of the messages. This counted result is stored in a database of the degree of interest in broadcast programs, every program and/or every series of programs. In this, a series of programs is a unit in which plural programs are gathered as a group. For example, a dram, which is composed of total 12 times of broadcasting, can be said to be one series of 12 programs.

A second example (1-1-b) of the message counting function for counting the number of messages for each program is explained. The server classifies messages into relating programs and stores the number of messages every program. This function can be realized by providing a message classifying means in the server. This message classifying means counts up the number of messages for each program and/or for each of a series of programs in the database of the degree of interest in broadcast programs by classifying the messages, based on the program identifying data such as a program tag including in each of the messages.

Next, a message counting function for counting the number of messages every scene of a program (1-2) is explained. In this, a scene signifies a unit of which a program is composed, and is not a scene of English in the strict meaning. That is, one program is composed of plural scenes, and the scene is data (video data and/or audio data) being a part of a program, divided at an arbitrary or a designated interval. For example, a news program is taken up as an example. This news program provides scenes such as a scene reporting an international situation, a scene reporting a domestic political situation, a scene reporting an economic situation, a scene reporting the results of sports, and a scene reporting the weather forecast. It is desirable that how many scenes a program is divided into is decided by the broadcasting station. Or a program can be divided into scenes every designated equal interval.

A first example (1-2-a) of the message counting function for counting the number of messages every scene of a program is explained. The server counts the number of messages every designated interval of a program, and records the distribution of the number of messages every designated interval. This function can be realized by storing the number of messages every program and also every designated interval (scene) of the program in the database of the degree of interest in broadcast programs. In case that a message from a viewer includes a program tag designating a scene, the message counting means counts the message as a message including a designated interval (scene). And the message counting means stores the number of messages in the database of the degree of interest in broadcast programs every designated interval (scene).

A second example (1-2-b) of the message counting function for counting the number of messages every scene of a program is explained. The server classifies messages into which designated interval the messages are related to, at the time when the server stores the messages, and stores the number of messages every designated interval (scene) of the program. In the database of the degree of interest in broadcast programs, the number of messages is stored every program and also every designated interval (scene). In case that a message from a viewer includes a program tag designating a scene, the message classifying means classifies the message as a message including a designated interval (scene). And the message classifying means counts up the number of messages in the database of the degree of interest in broadcast programs every designated interval (scene) of the program.

Next, a message counting function for counting the number of messages every period when the messages were supplied (1-3) is explained. This function counts the number of messages every period (every one day, every one week, every one month) when the messages were supplied to the server.

A first example (1-3-a) of the message counting function for counting the number of messages every period when the messages were supplied is explained. In the database of the degree of interest in broadcast programs, the number of messages is stored every period when the messages were supplied to the server. In this first example, in addition to the examples (1-1-a) and (1-2-a), the message counting means counts the number of messages every period when the messages were supplied.

A second example (1-3-b) of the message counting function for counting the number of messages every period when the messages were supplied is explained. In the database of the degree of interest in broadcast programs, the number of messages is counted up every period when the messages were supplied to the server. In this second example, in addition to the examples (1-1-b) and (1-2-b), the message classifying means counts up the number of messages every period when the messages were supplied.

Next, a message list making function for making a list of messages relating to each program (2-1) is explained. An example (2-1-a) of the message list making function is explained. The server classifies messages including reference information for programs into each program, and makes a list of messages for each program. A message list making means classifies the messages every program and every series of programs based on a program tag in each message, and stores the number of messages in the list every program or every series of programs.

Next, a message list making function for making a list of messages relating to each scene of a program (2-2) is explained. An example (2-2-a) of the message list making function is explained. The server classifies messages including reference information for scenes of programs into which designated interval (scene) the messages of a program relate to, and makes a list of messages every scene of the program. The message list can be stored every program and also every designated interval (scene) of every program. In case that a program tag designating a scene is included in the message and the program is a program designated by the program tag, the message list making means stores the message in the message list in which the scene is designated.

Next, the information delivering function is explained. First, an information delivering function, in which the number of messages relating to a broadcast program list is delivered (3-1), is explained. The number of messages is considered as the degree of interest of viewers, therefore, information being the number of messages is delivered to the users, as the users can use the information as a judging reference when the users watch or record a program.

A first example (3-1-a) of delivering the number of messages relating to a broadcast program list is explained. A broadcast program list delivering means obtains the number of messages of each program from the database of the degree of interest in broadcast programs in the first (message counting) function mentioned above, and delivers users the number of messages as one of the broadcast program information.

A second example (3-1-b) of delivering the number of messages relating to the broadcast program list is explained. At the second example, in case that a program belongs to a series of programs, the number of messages of the series of programs is delivered to users. The broadcast program list delivering means obtains the number of messages of the series of programs from the database of the degree of interest in broadcast programs of the example (1-1-a) or the example (1-1-b) mentioned above, and delivers users the number of messages of the series of programs as one of the broadcast program information.

A third example (3-1-c) of delivering the number of messages relating to the broadcast program list is explained. At the third example, the number of messages supplied from viewers in a designated period is delivered to users. The broadcast program list delivering means obtains the number of messages in the designated period from the database of the degree of interest in broadcast programs of the example (1-3-a) or the example (1-3-b) mentioned above, and delivers users the number of messages in the designated period as one of the broadcast program information.

Second, an information delivering function, in which reference information of messages relating to a broadcast program list is delivered (3-2), is explained. Impressions or comments are extracted from the messages relating to a program, and the extracted information being the impressions or the comments is delivered to the users, as the users can use the information as a judging reference when the users watch or record a program.

A first example (3-2-a) of delivering the reference information of messages relating to a broadcast program list is explained. A message list delivering means obtains a message list relating to each program from the message list of each program made by the message list making means at the example (2-1-a) mentioned above, and delivers users the message list as one of the broadcast program information.

A second example (3-2-b) of delivering the reference information of messages relating to a broadcast program list is explained. The message list delivering means delivers the reference information of the message list made at the example (3-2-a) and information of a designated period to users as one of the broadcast program information.

A third example (3-2-c) of delivering the reference information of messages relating to the broadcast program list is explained. At the third example, in case that a program belongs to a series of programs, reference information is delivered as reference information of the series of programs. The message list delivering means delivers the reference information relating to the series of programs, made at the example (3-2-a), to users as one of the broadcast program information.

Third, an information delivering function, which the number of messages relating to a program every time after each designated period is passed from the beginning of the program (3-3) is delivered, is explained. The number of messages for the program after every designated period is passed shows which designated period of the program viewers have their interest. With this, users can watch only a scene (designated period of the program) which the users have the high degree of interest.

A first example (3-3-a) of delivering the number of messages relating to a program every time after each designated period is passed from the beginning of the program is explained. After a program was designated and a program information delivering means was started, the program information delivering means obtains the number of messages of the designated program every designated period from the database of the degree of interest in broadcast programs at the example (1-2-a) or the example (1-2-b). And the program information delivering means delivers users both the time passed from the beginning of the program and the number of messages in each designated period.

A second example (3-3-b) of delivering the number of messages relating to a program every time after each designated period is passed from the beginning of the program is explained. In this second example, the change of the number of messages of a designated program every designated period is shown in a graph. After a program was designated and the program information delivering means was started, the program information delivering means obtains the number of messages of the designated program every designated period from the database of the degree of interest in broadcast programs at the example (1-2-a) or the example (1-2-b). And the program information delivering means delivers users both the time passed from the beginning of the program and the number of messages in each designated period in a histogram.

A third example (3-3-c) of delivering the number of messages relating to a program every time after each designated period is passed from the beginning of the program is explained. In this third example, after a program was designated and the program information delivering means was started, the program information delivering means obtains the number of messages of the designated program every designated period from the database of the degree of interest in broadcast programs at the example (1-3-a) or the example (1-3-b). And the program information delivering means delivers users both the time passed from the beginning of the program and the number of messages in each designated period.

A fourth example (3-3-d) of delivering the number of messages relating to a program every time after each designated period is passed from the beginning of the program is explained. In this fourth example, the change of the number of messages of a designated program every designated period is shown in a graph. After a program was designated and the program information delivering means was started, the program information delivering means obtains the number of messages of the designated program every designated period from the database of the degree of interest in broadcast programs at the example (1-3-a) or the example (1-3-b). And the program information delivering means delivers users both the time passed from the beginning of the program and the number of messages in each designated period in a histogram.

Fourth, an information delivering function, in which a message list relating to a program every interval after each designated interval is passed from the beginning of the program (3-4), is explained. Messages relating to a program are classified every designated interval, and the classified messages are delivered to users. With this, the users can easily understand what scene (which period in designated intervals) viewers have some impressions and/or comments.

An example (3-4-a) of delivering a message list relating to a program every interval after each designated interval is passed from the beginning of the program is explained. When a program was designated and the program information delivering means was started, the program information delivering means obtains a message list including reference information of the designated program every interval, from the message list in the example (2-2-a). And the program information delivering means delivers users both the period passed from the beginning of the program and the message list including reference information.

Fifth, an information delivering function, in which programs are delivered to users in the order that their number of messages is large (3-5), is explained. By delivering the programs in the order that their number of messages is large, a program, in which viewers have high interest, is judged.

A first example (3-5-a) of delivering programs to users in the order that their number of messages is large is explained. A ranking delivering means obtains the number of messages for each program from the database of the degree of interest in broadcast programs at the example (1-1-a) or the example (1-1-b) mentioned above. And the ranking delivering means delivers users program information such as the program name, the broadcasting station, the broadcasting date, and the broadcasting time, or the program tag of the program, in the order that their number of messages is large.

A second example (3-5-b) of delivering programs to users in the order that their number of messages is large is explained. In the second example, the number of messages for a program is counted in a designated period, and this number of messages is used. The ranking delivering means obtains the number of messages for each program supplied from viewers in a designated period from the database of the degree of interest in broadcast programs at the example (1-3-a) or the example (1-3-b) mentioned above. And the ranking delivering means delivers users program information such as the program name, the broadcasting station, the broadcasting date, and the broadcasting time, or the program tag of the program, in the order that their number of messages is large.

Sixth, an information delivering function, in which scenes of programs are delivered to users in the order that the number of messages for each scene is large (3-6), is explained. By delivering the scenes of programs (in a designated period) in the order that the number of messages for each scene is large, a scene, in which viewers have high interest, is judged.

A first example (3-6-a) of delivering scenes of programs to users in the order that the number of messages for each scene is large is explained. The ranking delivering means obtains the number of messages for each program every designated interval (scene) from the database of the degree of interest in broadcast programs at the example (1-2-a) or the example (1-2-b). And the ranking delivering means delivers users program information such as the program name, the broadcasting station, the broadcasting date, the broadcasting time, and the designated interval (scene) of the program, or the program tag showing the first moment of the designated period of the program, in the order that their number of messages is large.

A second example (3-6-b) of delivering scenes of programs to users in the order that the number of messages for each scene is large is explained. In the second example, the number of messages for a program is counted in a designated period, and this number of messages is used. The ranking delivering means obtains the number of messages for each program every designated interval (scene) from the database of the degree of interest in broadcast programs at the example (1-3-a) or the example (1-3-b). And the ranking delivering means delivers users program information such as the program name, the broadcasting station, the broadcasting date, the broadcasting time, and the designated period (scene), of the program, or the program tag showing the first moment of the designated period of the program, in the order that their number of messages is large.

Next, the system delivering the degree of interest in broadcast programs is explained in detail, in this explanation, the server delivering the degree of interest in broadcast programs is also explained in detail. The method delivering the degree of interest in broadcast programs is explained in detail, in the operation of the server, and the method can be realized by making a computer process a computer program. And the server can be realized by not forming as a total one unit but by controlling each means being mentioned later.

Before explaining the system, the server, the method, and the computer program, the program tag is explained in detail.

The program tag is information expressed by a format which links a message, composed of information such as a text and an image, with a broadcast program. The message is structured information being mainly a text transmitting via a Web page, an e-mail, a BBS, or a chat. In this, one message may include plural program tags. By using the program tag, it can be judged to which broadcast program a message relates.

The program tags are mainly classified into the following three kinds of data formats. That is, there are a program identifying tag, a series of programs identifying tag, and a program identifying and a moment (scene) in the identified program identifying tag. The program identifying tag identifies each program. The series of programs identifying tag is a tag, which links programs having the same title with one unit, or links programs in a series of programs with one unit. In this, the series of programs is broadcast every week, periodically, or non-periodically. The program identifying and the moment (scene) in the identified program identifying tag is a tag, which identifies scenes in the identified program.

These program tags can be applied to programs broadcast in the past, programs broadcasting at present, and programs being broadcast in the future. The programs being objects at the present invention include not only TV broadcast programs and radio broadcast programs, but also CATV broadcast programs and the Internet broadcast programs.

It is necessary that the program tags in the present invention are included in the messages composed of text information, therefore the program tags must be distinguished from the original text (data) in the messages. In order to realize this distinction, in case that the message is formed by the HTML, the data format of the program tags is formed by a different data format from the HTML. By using a specialized tag as the program tag, the message formed by the HTML can be recognized.

In case that the message is composed of data that is not formalized by a text, the program tags are distinguished from the messages, by deciding a specialized format for the format of the program tags.

An example of this specialized format for the program tag is shown. First, “foo” is defined as program information, and “tvtag://” is attached in front of the “foo”, and “” is attached behind the “foo ”. In this, the “” shows a space, hereinafter the space shows as “]”. That is, from a character string “foo” disposed between the “tvtag://” and “]”, the program information “foo” corresponding to this message can be understood. The specialized format for the program tag is shown in “tvtag://foo]”.

As examples of the program tags, the program tags can be decided as follows:

“tvtag://broadcasting station name-broadcasting date-broadcast starting time]”,

“tvtag://broadcasting station name-broadcasting date-broadcast starting time-scene starting time]”,

“tvtag://broadcasting station name-broadcasting date-broadcast starting time-program name]”, and

“tvtag://broadcasting station name-broadcasting date-broadcast starting time-program name-scene starting time]”.

That is, the server searches the range between the “tvtag://” and “]” in the message, and analyzes the character string between the range based on the designated format, and judges the program information such as the broadcasting station name and the broadcasting date corresponding to the message.

In this, the program information in the program tag being delivered by a message delivering means can be a part of the program information, not all of the program information. That is, if users can understand program information corresponding to the message by watching a part of the program information, the program information can be limited to a part of the program information in the program tag. For example, even when the program tag includes “the broadcasting station name, the broadcasting date, the broadcast starting time, the program length, and the program name”, it is enough that the message delivering means only delivers “the program name” or “the program name and the broadcast starting time”, when the use can understand the program information.

In case that the program information in the program tag is composed of “program information (broadcasting station name broadcasting data-broadcast starting time)” and “delivering character string”, as shown in the following example, information, which is actually delivered by the message delivering means, can be only the “delivering character string.” The example of the program tag is: “tvtag://broadcasting station name-broadcasting date-broadcast starting time] delivering character string]”.

Next, examples of the program information including in the program tags are explained.

First, the program identifying tag for identifying a program is explained. Examples of the information including in the program identifying tag are shown as follows:

Example 1-1: broadcasting station+broadcasting date+broadcast starting time.

Example 1-2: region+channel No.+broadcasting date+broadcast starting time.

Example 1-3: the example 1-1 or the example 1-2+program length.

Example 1-4: the example 1-1, the example 1-2, or the example 1-3+program name.

Example 1-5: program name+broadcasting date.

Example 1-6: program name and/or series name+subtitle.

Example 1-7: program name and/or series name+the number of broadcasting times.

Example 1-8: the example 1-1, the example 1-2, or the example 1-3+the example 1-6 or the example 1-7.

In the examples of the program identifying tag, as the “broadcasting station”, the company name or the abbreviation of the broadcasting station can be used. And as the “region”, the region name such as “Kanto”, the abbreviation of the prefecture name, or the abbreviation of the region can be used.

Second, the series of programs identifying tag for identifying a series of programs as a whole is explained. Examples of the information including in the series of programs identifying tag are shown as follows:

Example 2-1: series name.

Example 2-2: broadcasting station+broadcasting date of the first broadcasting time of the series+broadcast starting time of the first broadcasting time of the series.

Example 2-3: broadcasting station+broadcasting period of the series +day(s) of the week of broadcast+broadcast starting time.

Example 2-4: the example 2-3+program length of the one time.

Example 2-5: the example 2-1+the example 2-2, the example 2-3, or the example 2-4.

Third, the program identifying and the moment in the identified program identifying tag for identifying a program and a moment of the identified program is explained. In the information of this tag, information identifying a scene/scenes of the program is added to the information identifying the program. At digital broadcasting such as by a broadcasting satellite (BS), a ground wave, and a CATV, not only images and sounds of a program, but also information relating to the program are included as data broadcasting. In this case, it can be said that information relating to the scene such as a scene starting moment is included in the information relating to the program. The present invention can be applied to this case. Examples of the information including in the program identifying and the moment in the identified program identifying tag are shown as follows:

Example 3-1: program identifying tag+relative time from starting the program to starting a scene.

Example 3-2: program identifying tag+scene designating information during data broadcasting.

Next, a distinguishing method of the data formats of the program tags is explained. As mentioned above, there are three kinds of data formats for the program tags. First, the program tag is distinguished by the data format. Second, the program tag is distinguished by the information added to the program information.

Next, a program tag searching method is explained. As the method searching a program tag form a message, data formed by the data format of the program tag are searched, or the character string (data string) in the program tag is searched.

In the following explanation, in order to make the explanation simple, a program is identified by using a program tag. However, the program can be identified by other methods (not shown) using program identifying data.

Referring to the drawings, a first embodiment of a server and a method delivering the degree of interest in broadcast programs of the present invention is explained. The first embodiment corresponds to the example (1-1-a) mentioned above.

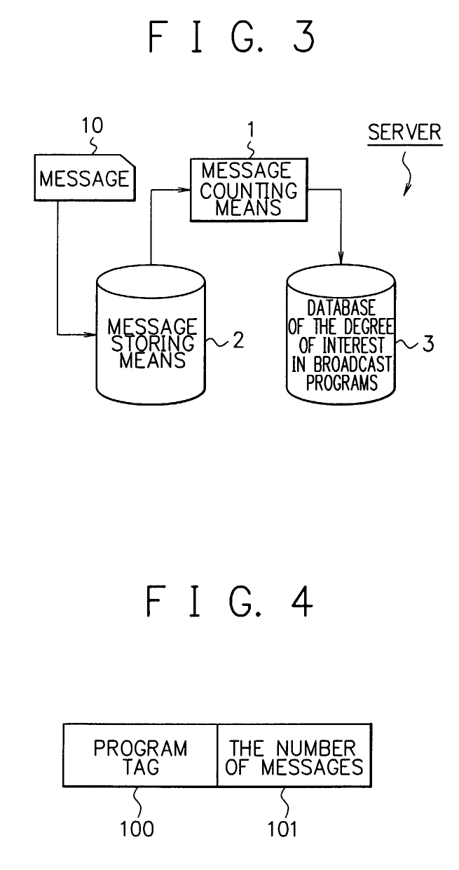

FIG. 3 is a block diagram showing a structure of a part of the server delivering the degree of interest in broadcast programs at the first embodiment of the present invention. As shown in FIG. 3, the server provides a message counting means 1, a message storing means 2, and a database of the degree of interest in broadcast programs 3. The message storing means 2 stores messages 10 supplied from viewers. The message counting means 1 counts the number of messages every program by searching the messages 10 storing in the message storing means 2. And the message counting means 1 stores the counted number of messages for each program in the database of the degree of interest in broadcast programs 3. That is, the database of the degree of interest in broadcast programs 3 stores the number of messages for each program.

The message storing means 2 can store the messages 10 by using an arbitrary method, however, for example, can store each message 10 as a file. That is, each message 10 is stored as each file, and each message 10 is distinguished by a file name. And it can be managed that supplied time of each message 10 is to be file forming time. Further, it is possible that the supplied time of each message is managed by recording the supplied time in file managing data.

FIG. 4 is a diagram showing a data structure in the database of the degree of interest in broadcast programs 3 shown in FIG. 3. As shown in FIG. 4, each entry in the database of the degree of interest in broadcast programs 3 consists of two fields, that is, one field, in which a program tag 100 showing a program is stored, and the other field, in which the number of messages 101 corresponding to the program tag 100 is stored. In this, the program tag 100 also shows a series of programs.

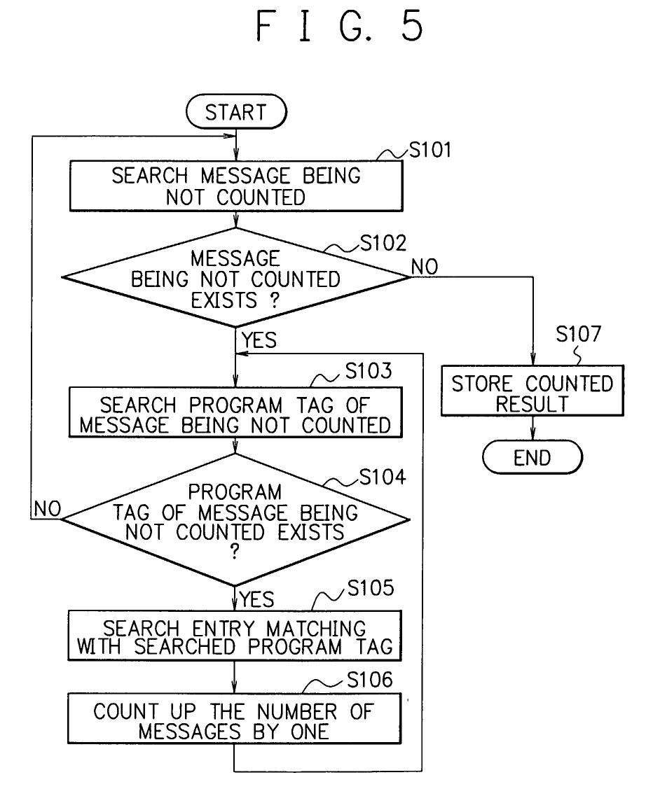

FIG. 5 is a flowchart showing operation of the message counting means 1 shown in FIG. 3. Referring to FIG. 5, the operation of the message counting means 1 is explained.

First, the message counting means 1 searches a message 10 being not counted from the message storing means 2 (step S101). When the message 10 being not counted does not exist (NO at step S102), that is, when all the messages 10 were counted, this counted result is stored in the database of the degree of interest in broadcast programs 3 (step S107), and the operation ends. When the message 10 being not counted exists (YES at the step S102), the message counting means 1 searches the program tag 100 of the message 10 being not counted (step S103). When the program tag 100 of the searched message 10 being not counted does not exist (NO at step S104), that is, when all of the program tags 100 of the message 10 were searched, the operation returns to the step S101, and next message 10 being not counted is searched. When the program tag 100 of the message 10 being not counted exists (YES at the step S104), the message counting means 1 searches the entry matching with the searched program tag 100 in the database of the degree of interest in broadcast programs 3 (step S105). And the message counting means 1 counts up the number of messages 101 by one (step S106). And the operation returns to the step S103, and next program tag in the same message 10 is searched.

As mentioned above, there are three kinds of data formats for the program tags 100, that is, the program identifying tag, the series of programs identifying tag, and the program identifying and the moment (scene) in the identified program identifying tag. Therefore, in case that the program identifying tag is used, the message counting means 1 counts the message having this tag as a message matching with the program. In case that the series of programs identifying tag is used, the message counting means 1 counts the message having this tag as a message matching with the series of programs. In case that the program identifying and the moment (scene) in the identified program identifying tag is used, the message counting means 1 counts the message having this tag as a message matching with the scene of program by using only the part designated the scene. In this, when plural program tags for plural programs are included in a message, the message counting means 1 handles the message as the message identified plural program tags 100, and counts the message as plural messages.

The first embodiment of the present invention can be modified to the following two modified examples. A first modified example of the first embodiment of the present invention is explained. In this first modified example, even when plural program tags 100 for one program or one series of programs are included in one message 10, one message is counted only once for one program or one series of programs at the server.

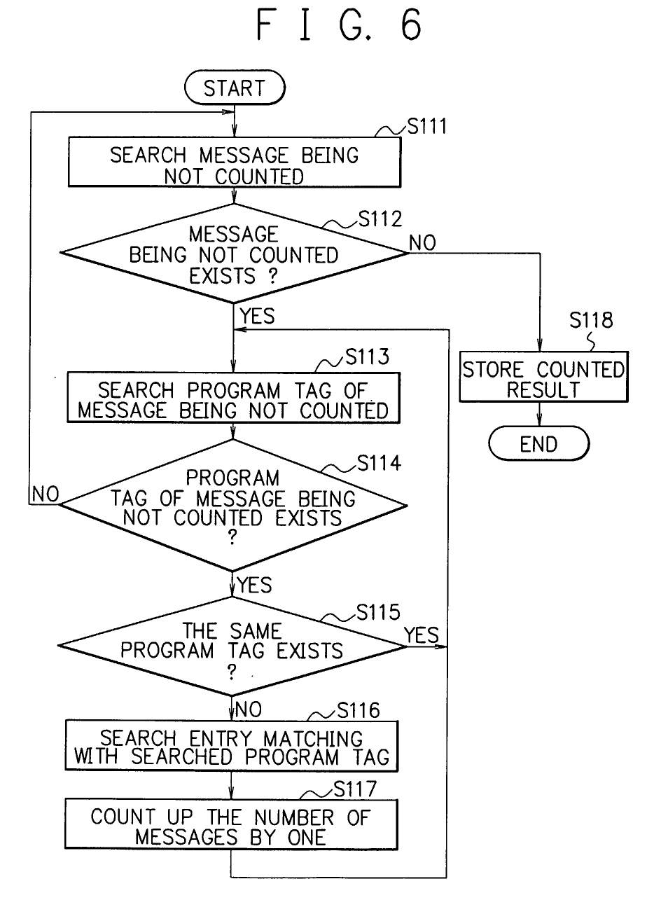

FIG. 6 is a flowchart showing operation of the message counting means 1 at the first modified example of the first embodiment of the present invention. Referring to FIG. 6, the operation of the message counting means 1 at the first modified example of the first embodiment of the present invention is explained.

First, the message counting means 1 searches a message 10 being not counted from the message storing means 2 (step S111). When the message 10 being not counted does not exist (NO at step S112), that is, when all the messages 10 were counted, this counted result is stored in the database of the degree of interest in broadcast programs 3 (step S118), and the operation ends. When the message 10 being not counted exists (YES at the step S112), the message counting means 1 searches the program tag 100 of the message 10 being not counted (step S113). When the program tag 100 of the searched message 10 being not counted does not exist (NO at step S114), that is, when all of the program tags 100 of the message 10 were searched, the operation returns to the step S111, and next message 10 being not counted is searched. When the program tag 100 of the message 10 being not counted exists (YES at the step S114), the message counting means 1 searches whether the message having the same program tag 100 exists or not in the message storing means 2 (step S115). When the same program tag 100 exists (YES at the step S115), the message counting means 1 counts the message once and the operation returns to the step S113, and next program tag in the same message 10 is searched. When the same program tag 100 does not exist (NO at the step S115), the message counting means 1 searches the entry matching with the searched program tag 100 in the database of the degree of interest in broadcast programs 3 (step S116). And the message counting means 1 counts up the number of messages 101 by one (step S117). And the operation returns to the step S113, and next program tag in the same message 10 is searched.

As the searching method whether the same program tag 100 exists or not at the step S115, there are methods. For example, when the plural same program tags 100 exist in the message 10 being not counted, the same program tags 100 are searched easily, or the same program tags 100 are searched in all the messages 10 being not counted. And when the program tag 100 is counted once, the same program tag 100 is not counted any more.

Next, a second modified example of the first embodiment of the present invention is explained. In this second modified example, when the program tag 100 of a message 10 is written in the format, which shows the message 10 belongs to a series of programs, such as “series name+subtitle” or “series name+the number of broadcasting times”, the message 10 is counted as the message for the program and also for the series of programs at the server. That is, in this case, the series of programs identifying tag is used.

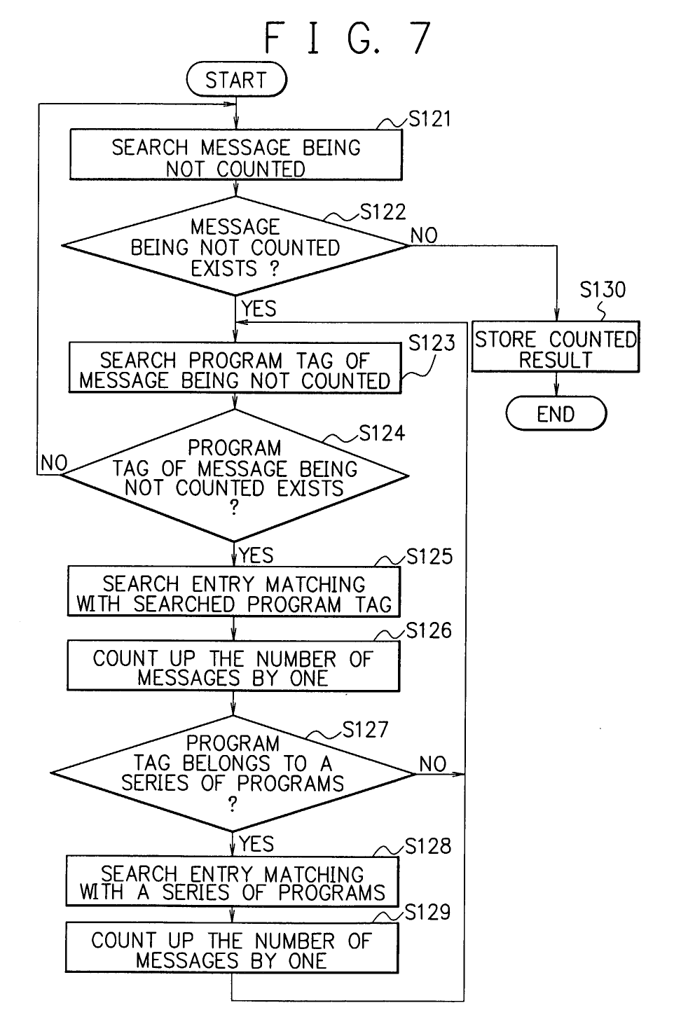

FIG. 7 is a flowchart showing operation of the message counting means 1 at the second modified example of the first embodiment of the present invention. Referring to FIG. 7, the operation of the message counting means 1 at the second modified example of the first embodiment of the present invention is explained.

First, the message counting means 1 searches a message 10 being not counted from the message storing means 2 (step S121). When the message 10 being not counted does not exist (NO at step S122), that is, when all the messages 10 were counted, this counted result is stored in the database of the degree of interest in broadcast programs 3 (step S130), and the operation ends. When the message 10 being not counted exists (YES at the step S122), the message counting means 1 searches the program tag 100 of the message 10 being not counted (step S123). When the program tag 100 of the searched message 10 being not counted does not exist (NO at step S124), that is, when all of the program tags 100 of the message 10 were searched, the operation returns to the step S121, and next message 10 being not counted is searched. When the program tag 100 of the message 10 being not counted exists (YES at the step S124), the message counting means 1 searches the entry matching with the searched program tag 100 in the database of the degree of interest in broadcast programs 3 (step S125). And the message counting means 1 counts up the number of messages 101 by one (step S126).

Next, when the program tag 100 does not identify a series of programs, and identifies a program but the identified program does not belong to a series of program (No at the step S127), the operation returns to the step S123. And next program tag 100 of the same message 10 is searched. When the program tag 100 identifies a series of programs, or identifies a program and the identified program belongs to a series of program (YES at the step S127), the message counting means 1 searches the entry matching with a series of programs in the database of the degree of interest in broadcast programs 3 (step S128). That is, when the identified program belongs to the series of programs, the message counting means 1 searches an entry matching with this series of programs. And the message counting means 1 counts up the number of messages 101 by one (step S129), as the message is a message for a series of programs. And the operation returns to the step S123.

Next, referring to the drawings, a second embodiment of a server and a method delivering the degree of interest in broadcast programs of the present invention is explained. The second embodiment also corresponds to the example (1-1-a) mentioned above.

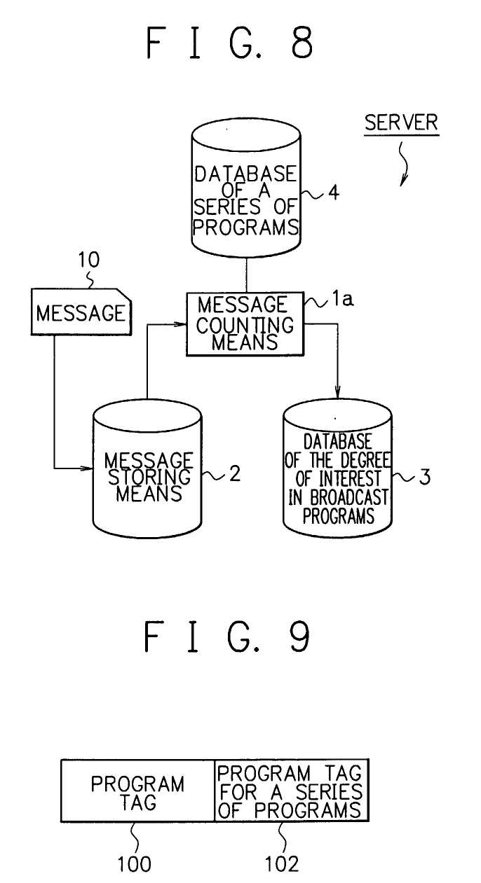

FIG. 8 is a block diagram showing a structure of a part of the server delivering the degree of interest in broadcast programs at the second embodiment of the present invention. As shown in FIG. 8, the server provides a message counting means 1a, a message storing means 2, a database of the degree of interest in broadcast programs 3, and a database of a series of programs 4. As the message storing means 2 and the database of the degree of interest in broadcast programs 3, the same ones used at the first embodiment can be used. Therefore, as the storing method of messages 10 in the message storing means 2, the same method mentioned at the first embodiment can be adopted at the second embodiment.

The database of a series of programs 4 records a program as a program in a series of programs, when the program belongs to a series of programs. That is, what series of programs the program belongs to is recorded in the database of a series of programs 4, when the program belongs to the series of programs.

The message counting means 1a counts the number of messages every program by searching messages storing in the message storing means 2. And the message counting means 1a judges whether a program belongs to a series of programs or not, by using the database of a series of programs 4. When the program belongs to a series of programs, the message counting means 1a counts the message for the program as the message for the series of programs. That is, the message counting means 1a counts up the number of messages in the database of the degree of interest in broadcast programs 3.

FIG. 9 is a diagram showing a data structure in the database of a series of programs 4 shown in FIG. 8. As shown in FIG. 9, each entry in the database of a series of programs 4 consists of two fields, that is, one field is for a program tag 100, and the other field is for a program tag 102 of a program belonging to a series of programs. That is, in the field of the program tag 102, the program tag of the program belonging to a series of programs is stored.

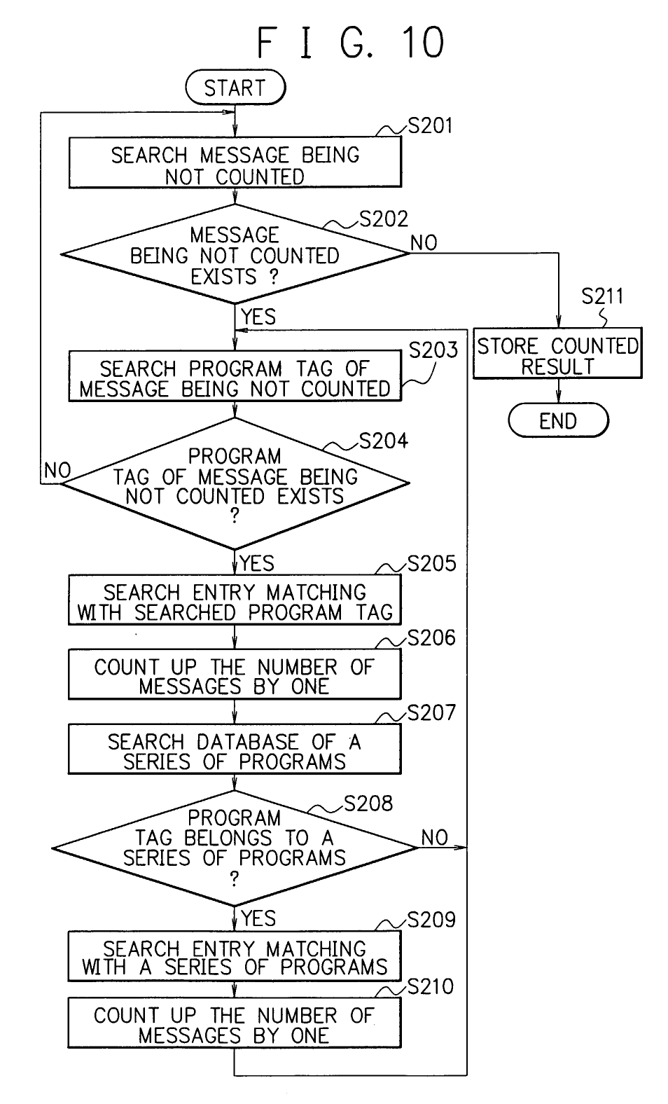

FIG. 10 is a flowchart showing operation of the message counting means 1a shown in FIG. 8. Referring to FIG. 10, the operation of the message counting means 1a is explained.

First, the message counting means 1a searches a message 10 being not counted from the message storing means 2 (step S201). When the message 10 being not counted does not exist (NO at step S202), that is, when all the messages 10 were counted, this counted result is stored in the database of the degree of interest in broadcast programs 3 (step S211), and the operation ends. When the message 10 being not counted exists (YES at the step S202), the message counting means 1a searches the program tag 100 of the message 10 being not counted (step S203). When the program tag 100 of the searched message 10 being not counted does not exist (NO at step S204), that is, when all of the program tags 100 of the message 10 were searched, the operation returns to the step S201, and next message 10 being not counted is searched. When the program tag 100 of the message 10 being not counted exists (YES at the step S204), the message counting means 1a searches the entry matching with the searched program tag 100 in the database of the degree of interest in broadcast programs 3 (step S205). And the message counting means la counts up the number of messages 101 by one (step S206).

Next, the message counting means 1a searches whether a series of programs, to which the program of the searched program tag 100 belongs, exists or not, by using the database of a series of programs 4 (step S207). That is, it is judged whether the program of the searched program tag 100 belongs to a series of programs or not. When the series of programs, to which the program of the searched program tag 100 belongs, does not exists (NO at step S208), the operation returns to the step S203, and next program tag 100 of the message not being counted is searched. When the series of programs, to which the program of the searched program tag 100 belongs, exists (YES at the step S208), the message counting means 1a searches the entry matching with the series of programs in the database of a series of programs 4 (step S209). And the message counting means 1a counts up the number of messages 101 by one (step S210). And the operation returns to the step S203, and next program tag in the same message 10 is searched.

As mentioned above, there are three kinds of data formats for the program tags 100, that is, the program identifying tag, the series of programs identifying tag, and the program identifying and the moment (scene) in the identified program identifying tag. At the second embodiment, these three kinds of the program tags 100 can be used. Therefore, in case that the program identifying tag is used, the message counting means 1a counts the message having this tag as a message matching with the program. In case that the series of programs identifying tag is used, the message counting means 1a counts the message having this tag as a message matching with the series of programs. In case that the program identifying and the moment (scene) in the identified program identifying tag is used, the message counting means 1a counts the message having this tag as a message matching with the scene of program by using only the part identified the scene.

When plural program tags of plural programs are included in a message, the message counting means 1a handles the message as the message identified plural program tags 100, and counts the message as plural messages. That is, each of the plural program tags is handled as each message, and the number of messages is counted up by each of the plural program tags.

The second embodiment of the present invention can be modified to the following modified example. In the modified example, even when plural program tags 100 for one program or one series of programs are included in one message 10, one message is counted only once for one program or one series of programs at the server. This is also possible at the second embodiment, as mentioned at the first embodiment.

Next, referring to the drawings, a third embodiment of a server and a method delivering the degree of interest in broadcast programs of the present invention is explained. The third embodiment corresponds to the example (1-1-b) mentioned above.

FIG. 11 is a block diagram showing a structure of a part of the server delivering the degree of interest in broadcast programs at the third embodiment of the present invention. As shown in FIG. 11, the server provides a message storing means 2, a database of the degree of interest in broadcast programs 3, and a message classifying means 5. The database of the degree of interest in broadcast programs 3 stores the number of messages every program. The message classifying means 5 counts up the number of messages in the database of the degree of interest in broadcast programs 3 by one, when the program tag of the message 10 matches with the program tag 100 in the database of the degree of interest in broadcast programs 3. The message storing means 2 stores the messages 10, after the number of messages of the messages 10 was counted up. As the database of the degree of interest in broadcast programs 3, the same one at the first embodiment can be used at the third embodiment.

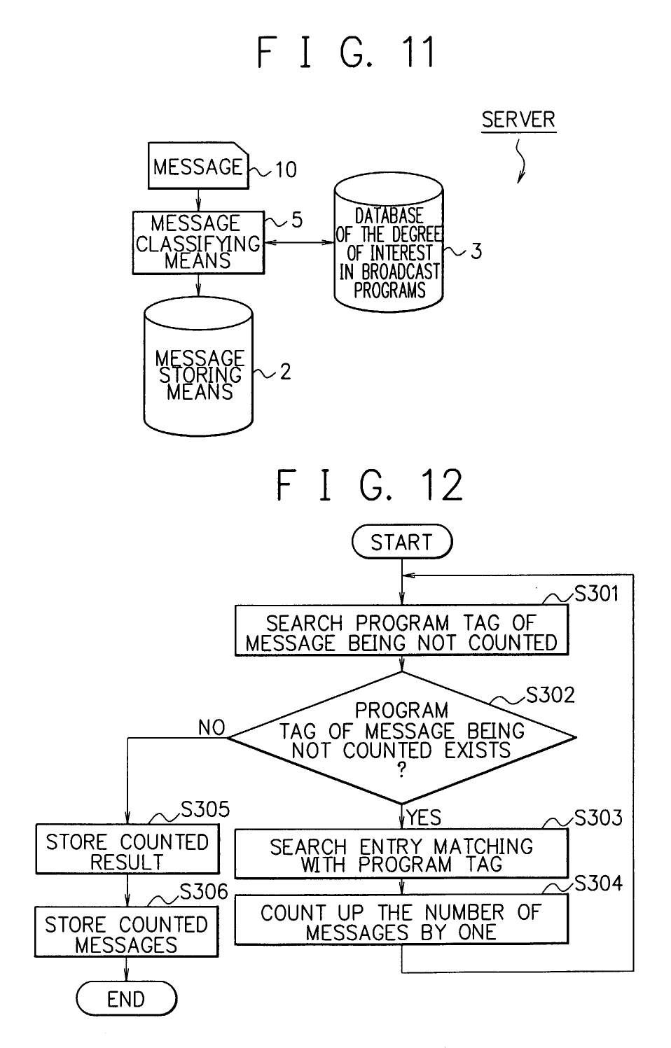

FIG. 12 is a flowchart showing operation of the message classifying means 5 shown in FIG. 11. Referring to FIG. 12, the operation of the message classifying means 5 is explained.

First, the message classifying means 5 searches the program tag 100 of a message 10 being not counted, when the message 10 was supplied from a viewer (step S301). When the program tag 100 of the message 10 being not counted does not exist (NO at step S302), that is, when all the messages 10 were counted, this counted result is stored in the database of the degree of interest in broadcast programs 3 (step S305). And the message classifying means 5 stores the counted messages in the message storing means 2 (step S306), and the operation ends. When the program tag 100 of the message 10 being not counted exists (YES at the step S302), the message classifying means 5 searches the entry (the number of messages) matching with the program tag 100 in the database of the degree of interest in broadcast programs (step S303). And the message classifying means 5 counts up the number of messages of the searched entry by one (step S304). And the operation returns to the step S301, and the message classifying means 5 searches the program tag 100 of next message being not counted.

As mentioned above, there are three kinds of data formats for the program tags 100, that is, the program identifying tag, the series of programs identifying tag, and the program identifying and the moment (scene) in the identified program identifying tag. At the third embodiment, these three kinds of the program tags 100 can be used. Therefore, in case that the program identifying tag is used, the message classifying means 5 counts the message having this tag as a message matching with the program. In case that the series of programs identifying tag is used, the message classifying means 5 counts the message having this tag as a message matching with the series of programs. In case that the program identifying and the moment (scene) in the identified program identifying tag is used, the message classifying means 5 counts the message having this tag as a message matching with the scene of program by using only the part identified the scene.

When plural program tags of plural programs are included in a message, the message classifying means 5 handles the message as the message identified plural program tags 100, and counts the message as plural messages. That is, each of the plural program tags is handled as each message, and the number of messages is counted up by each of the plural program tags.

The third embodiment of the present invention can be modified to the following two modified examples. In a first modified example, even when plural program tags 100 for one program or one series of programs are included in one message 10, one message is counted only once for one program or one series of programs at the server. This is also possible at the third embodiment, as mentioned at the first embodiment.

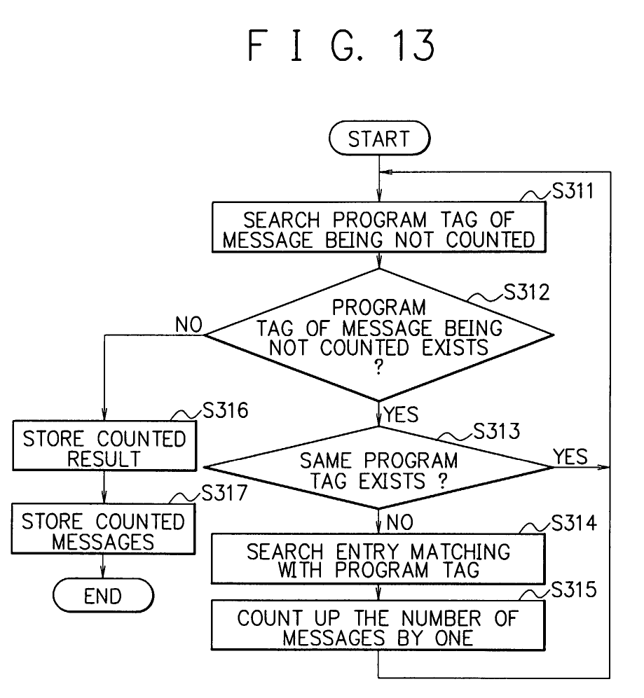

FIG. 13 is a flowchart showing operation of the message classifying means 5 at the first modified example of the third embodiment of the present invention. Referring to FIG. 13, the operation of the message classifying means 5 at the first modified example of the third embodiment of the present invention is explained.

First, the message classifying means 5 searches the program tag 100 of a message 10 being not counted, when the message 10 was supplied from a viewer (step S311). When the program tag 100 of the message 10 being not counted does not exist (NO at step S312), that is, when all the messages 10 were counted, this counted result is stored in the database of the degree of interest in broadcast programs 3 (step S316). That is, the number of messages in the database of the degree of interest in broadcast programs 3 is renewed. And the message classifying means 5 stores the counted messages in the message storing means 2 (step S317), and the operation ends. When the program tag 100 of the message 10 being not counted exists (YES at the step S312), the message classifying means 5 searches whether the same program tag exists or not in the message 10 (step S313). When the same program tag exists in the message 10 (YES at the step S313), the message classifying means 5 counts the message once, and the operation returns to the step S311, and the message classifying means 5 searches the program tag 100 of next message 10 being not counted. When the same program tag does not exist (NO at the step S313), the message classifying means 5 searches the entry (the number of messages) matching with the program tag 100 in the database of the degree of interest in broadcast programs 3 (step S314). And the message classifying means 5 counts up the number of messages of the searched entry by one (step S315). And the operation returns to the step S311, and the message classifying means 5 searches the program tag 100 of next message being not counted.

As the searching method whether the same program tag 100 exists or not at the step S313, there are methods. For example, when the plural same program tags 100 exist in the message 10 being not counted, the same program tags 100 are searched easily, or the same program tags 100 are searched in all the messages 10 being not counted. And when the program tag 100 is counted once, the same program tag 100 is not counted any more.

Next, a second modified example at the third embodiment of the present invention is explained. In the second modified example, when the program tag is the series of program identifying tag, that is, when the program tag is expressed in “series name+subtitle” or “series name+the number of broadcasting times”, the message is counted as the message for the program, and also as the message for the series of programs.

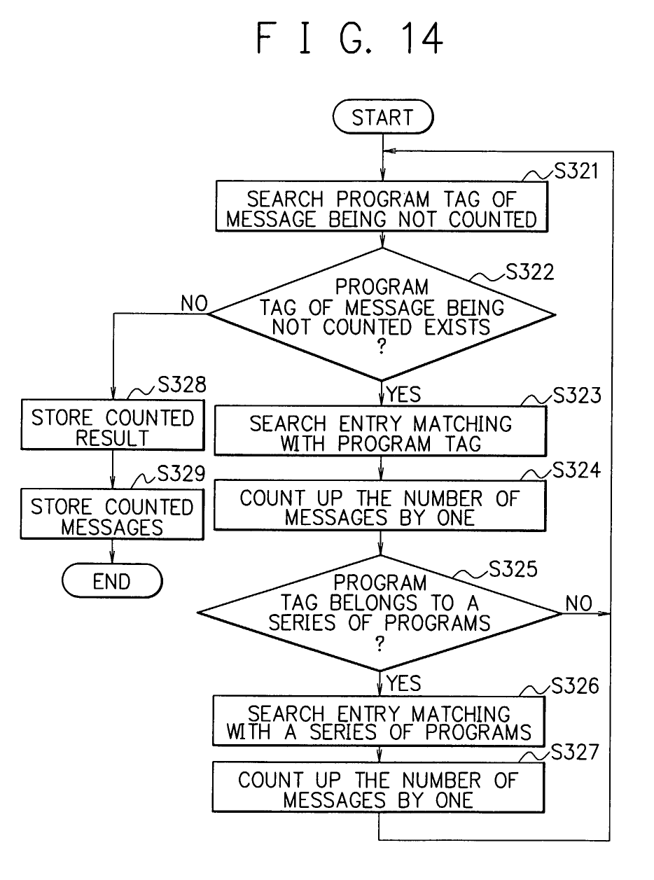

FIG. 14 is a flowchart showing operation of the message classifying means 5 at the second modified example of the third embodiment of the present invention. Referring to FIG. 14, the operation of the message classifying means 5 at the second modified example of the third embodiment of the present invention is explained.

First, the message classifying means 5 searches the program tag 100 of a message 10 being not counted, when the message 10 was supplied from a viewer (step S321). When the program tag 100 of the message 10 being not counted does not exist (NO at step S322), that is, when all the messages 10 were counted, this counted result is stored in the database of the degree of interest in broadcast programs 3 (step S328). That is, the number of messages in the database of the degree of interest in broadcast programs 3 is renewed. And the message classifying means 5 stores the counted messages in the message storing means 2 (step S329), and the operation ends. When the program tag 100 of the message 10 being not counted exists (YES at the step S322), the message classifying means 5 searches the entry matching with this program tag 100 in the database of the degree of interest in broadcast programs 3 (step S323). And the message classifying means 5 counts up the number of messages of the searched entry by one (step S324).

Next, the message classifying means 5 judges whether the program tag 100 belongs to a series of programs or not (step S325). When the program tag 100 is a program identifying tag and does not belong to a series of programs (NO at the step S325), the operation returns to the step S321. And the message classifying means 5 searches the program tag 100 of next message being not counted. When the program tag 100 is a series of programs identifying tag, or a program identifying tag and also a series of programs identifying tag (YES at the step S325), the message classifying means 5 searches the entry matching with a series of programs corresponding to the program tag 100 in the database of the degree of interest in broadcast programs 3 (step S326). And the message classifying means 5 counts up the number of messages of the searched entry by one (step S327). And the operation returns to the step S321, and the message classifying means 5 searches the program tag 100 of next message 10 being not counted.

Next, referring to the drawings, a fourth embodiment of a server and a method delivering the degree of interest in broadcast programs of the present invention is explained. The fourth embodiment also corresponds to the example (1-1-b) mentioned above.

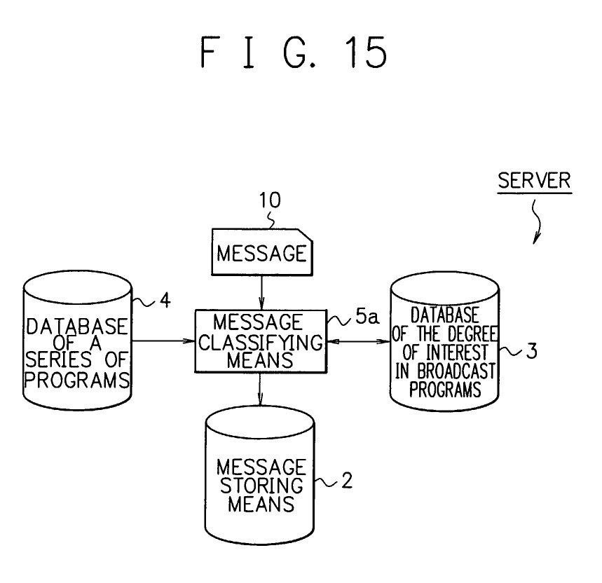

FIG. 15 is a block diagram showing a structure of a part of the server delivering the degree of interest in broadcast programs at the fourth embodiment of the present invention. As shown in FIG. 15, the server provides a message storing means 2, a database of the degree of interest in broadcast programs 3, a database of a series of programs 4, and a message classifying means 5a. As the message storing means 2, and the database of the degree of interest in broadcast programs 3, the same ones, used at the third embodiment, can be used at the fourth embodiment. The message classifying means 5a counts up the number of messages in the database of the degree of interest in broadcast programs 3 by one, when the program tag of the message 10 matches with the program tag 100 in the database of the degree of interest in broadcast programs 3. In case that a program belongs to a series of programs, a message for the program is also counted as a message for the series of programs, by using the database of a series of programs 4. The message storing means 2 stores the messages 10, after the number of messages of the messages 10 was counted up.

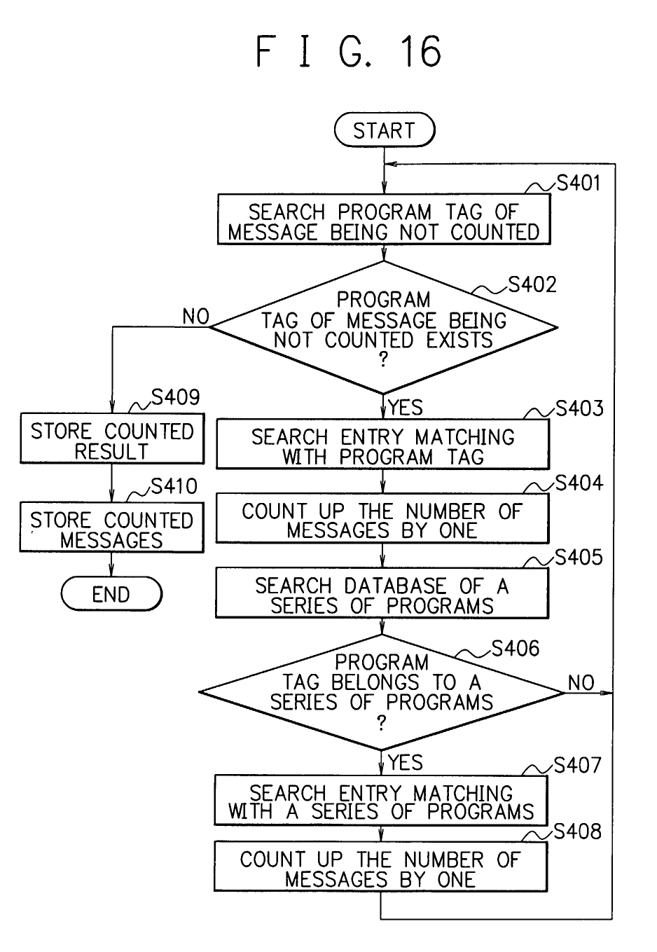

FIG. 16 is a flowchart showing operation of the message classifying means 5a shown in FIG. 15. Referring to FIG. 16, the operation of the message classifying means 5a at the fourth embodiment of the present invention is explained.

First, the message classifying means 5a searches the program tag 100 of a message 10 being not counted, when the message 10 was supplied from a viewer (step S401). When the program tag 100 of the message 10 being not counted does not exist (NO at step S402), that is, when all the messages 10 were counted, this counted result is stored in the database of the degree of interest in broadcast programs 3 (step S409). That is, the number of messages in the database of the degree of interest in broadcast programs 3 is renewed. And the message classifying means 5a stores the counted messages in the message storing means 2 (step S410), and the operation ends. When the program tag 100 of the message 10 being not counted exists (YES at the step S402), the message classifying means 5a searches the entry matching with this program tag 100 in the database of the degree of interest in broadcast programs 3 (step S403). And the message classifying means 5a counts up the number of messages of the searched entry by one (step S404).

Next, the message classifying means 5a searches whether a series of programs, to which the program tag 100 belongs, exists or not, by using the database of a series of programs 4 (step S405). When a series of programs, to which the program tag 100 belongs, does not exist (NO at step S406), the operation returns to the step S401. And the message classifying means 5a searches the program tag 100 of next message being not counted. When a series of programs, to which the program tag 100 belongs, exists (YES at the step S406), the message classifying means 5a searches the entry matching with a series of programs corresponding to the program tag 100 in the database of the degree of interest in broadcast programs 3 (step S407). And the message classifying means 5 counts up the number of messages 101 of the searched entry by one (step S408). And the operation returns to the step S401, and the message classifying means 5a searches the program tag 100 of next message 10 being not counted.

The fourth embodiment of the present invention can be modified to a modified example. In this modified example, even when plural program tags 100 for one program or one series of programs are included in one message 10, one message is counted only once for one program or one series of programs at the server, as same as at the first modified example of the third embodiment. That is, even when plural program tags to identify the same program are included in one message, the message classifying means 5a counts the message only once.

Next, referring to the drawings, a fifth embodiment of a server and a method delivering the degree of interest in broadcast programs of the present invention is explained. The fifth embodiment corresponds to the example (1-2-a) mentioned above. That is, at the fifth embodiment, the number of messages every scene of a program is counted.

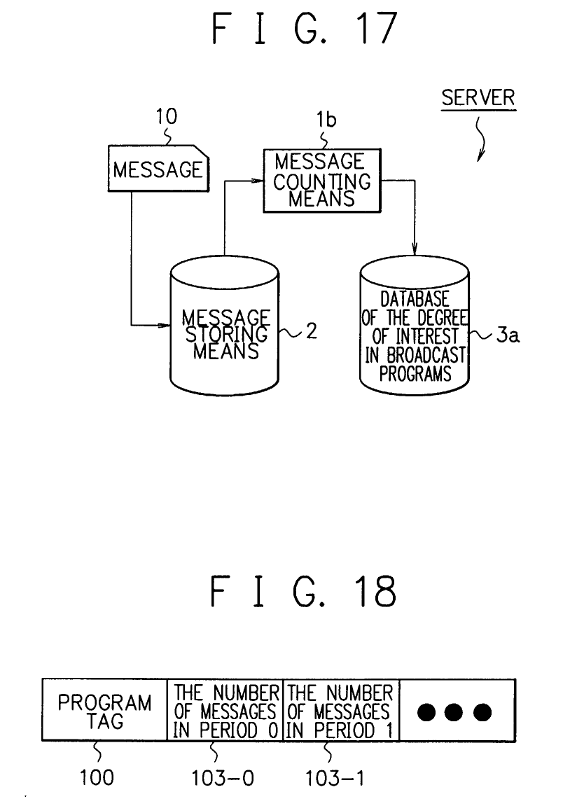

FIG. 17 is a block diagram showing a structure of a part of the server delivering the degree of interest in broadcast programs at the fifth embodiment of the present invention. As shown in FIG. 17, the server provides a message counting means 1b, a message storing means 2, and a database of the degree of interest in broadcast programs 3a. The message storing means 2 stores messages supplied from viewers, as the same as at the first and second embodiments. The database of the degree of interest in broadcast programs 3a stores the number of messages for a program every scene (every designated interval of the program). The message counting means 1b counts the number of messages of a program every designated interval, by searching messages 10 storing in the message storing means 2. And the message counting means 1b stores the counted number of messages of the program every designated interval in the database of the degree of interest in broadcast programs 3a .

FIG. 18 is a diagram showing a data structure in the database of the degree of interest in broadcast programs 3a shown in FIG. 17. As shown in FIG. 18 at the fifth embodiment, each entry in the database of the degree of interest in broadcast programs 3a provides a program tag 100 and a group of fields. The program tag 100 identifies a program. In the group of fields, the number of messages for the program designated by the program tag 100 is stored every designated period. For example, as shown in FIG. 18, the number of messages in the period 0 is shown in the field 103-0, the number of messages in the period 1 is shown in the field 103-1, . . . .

The number of the group of fields is decided by the length of a program. When it is defined that the length of a program is L and the designated period is t, the number of the group of fields N, in which the number of messages is stored, is shown in a following equation (1).

N=ceil (L÷t) . . . (1)

In this, the ceil (x) is a function that gives a minimum integer exceeding the x.

FIG. 19 is a flowchart showing operation of the message counting means 1b shown in FIG. 17. Referring to FIG. 19, the operation of the message counting means 1b at the fifth embodiment of the present invention is explained.

First, the message counting means 1b searches a message 10 being not counted from the message storing means 2 (step S501). When the message 10 being not counted does not exist (NO at step S502), that is, when all the messages 10 were counted, this counted result is stored in the database of the degree of interest in broadcast programs 3a (step S507), and the operation ends. When the message 10 being not counted exists (YES at the step S502), the message counting means 1b searches the program tag 100 designating a scene in this message 10 being not counted (step S503). When the program tag 100 designating a scene of the searched message 10 being not counted does not exist (NO at step S504), that is, when all of the program tags 100 designating the scenes of the message 10 were searched, the operation returns to the step S501, and next message 10 being not counted is searched. When the program tag 100 designating a scene of the searched message 10 being not counted exists (YES at the step S504), the message counting means 1b searches the entry matching with the searched program tag 100 in the database of the degree of interest in broadcast programs 3a (step S505). And the message counting means 1b counts up the number of messages 103 by one (step S506). And the operation returns to the step S503, and next program tag designating a scene in the message 10 is searched.

In this, in case that the number of messages is counted every scene, it is necessary that each scene has an identifier such as a name. As this identifier, an index i can be used. The index i of a period including a scene is shown in a following equation (2), when it is defined that time after a program started is s seconds (or minutes) and the designated period is t as mentioned above.

i=floor(s÷t) . . . (2)

In this, the floor (x) is a function that gives a maximum integer not exceeding the x.

And as mentioned above, in case that scenes are decided by diving a program into some parts, a side, who divides the program into the scenes, for example, a broadcasting station side gives an identifier to each scene. This is also possible. With this, the message counting means 1b can judge scenes in the program corresponding to messages by identifiers such as indices given to the scenes including in the program tags.

There are three kinds of data formats for the program tag 100 as mentioned above. However, the message counting means 1b uses the program identifying and the scene in the identified program identifying tag. And when plural program tags of plural programs are included in a message, the message is handled as plural message identified by the plural program tags, and the message is counted as the plural messages.

The fifth embodiment of the present invention can be modified to a modified example. In this modified example, even when plural program tags 100 for one program or one series of programs are included in one message 10, one message is counted only once for one program or one series of programs at the server, as same as at the modified example of the fourth embodiment.

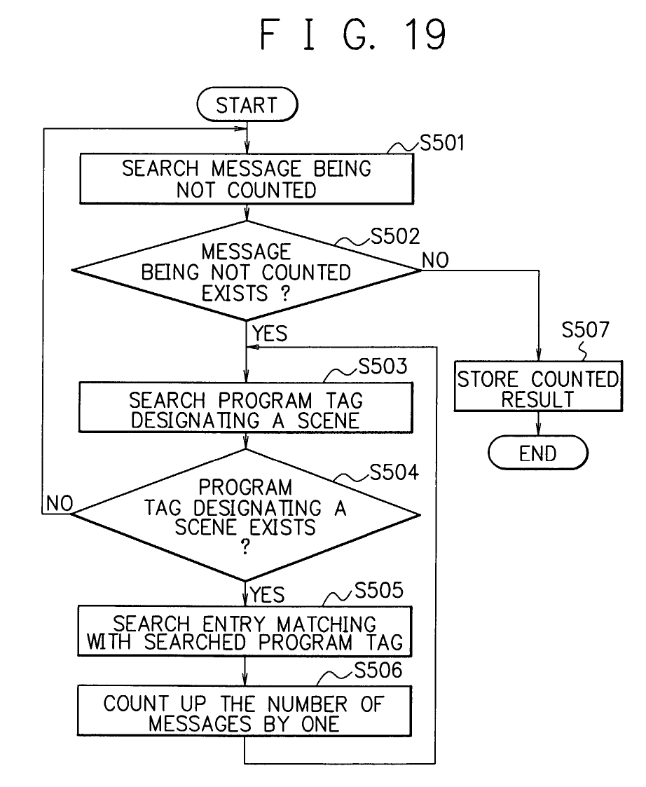

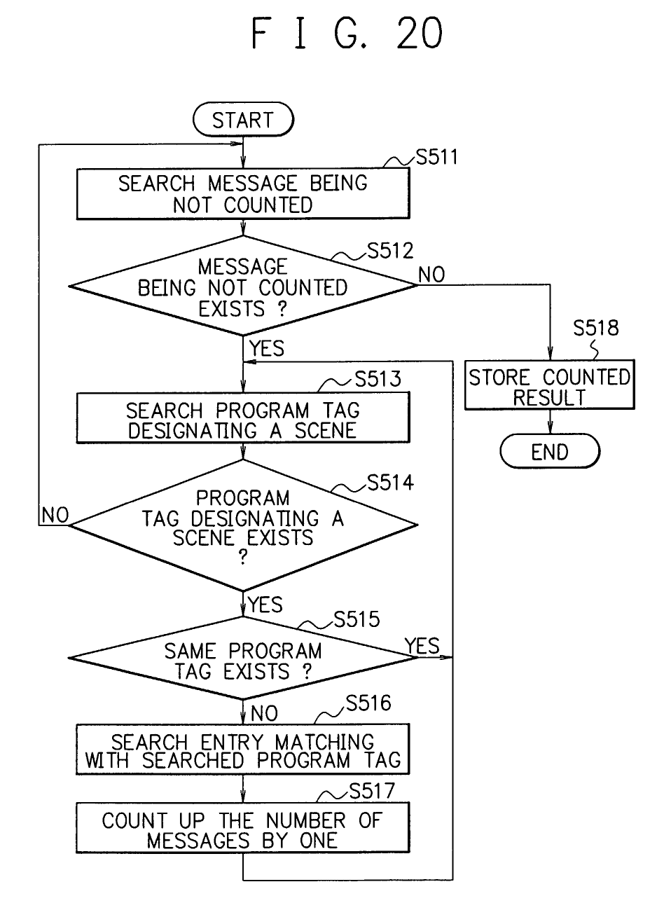

FIG. 20 is a flowchart showing operation of the message counting means 1b at the modified example of the fifth embodiment of the present invention. Referring to FIG. 20, the operation of the message counting means 1b at the modified example of the fifth embodiment of the present invention is explained.

First, the message counting means 1b searches a message 10 being not counted from the message storing means 2 (step S511). When the message 10 being not counted does not exist (NO at step S512), that is, when all the messages 10 were counted, this counted result is stored in the database of the degree of interest in broadcast programs 3a (step S518), and the operation ends. When the message 10 being not counted exists (YES at the step S512), the message counting means 1b searches the program tag 100 designating a scene in this message 10 being not counted (step S513). When the program tag 100 designating a scene of the searched message 10 being not counted does not exist (NO at step S514), that is, when all of the program tags 100 designating the scenes of the message 10 were searched, the operation returns to the step S511, and next message 10 being not counted is searched.

When the program tag 100 designating a scene of the searched message 10 being not counted exists (YES at the step S514), the message counting means 1b searches whether the same program tag designating the same scene exists or not in the message storing in the message storing means 2 (step S515). When the same program tag exists in the message storing in the message storing means 2 (YES at the step S515), the message counting means 1b counts the message once, and the operation returns to the step S513. And the message counting means 1b searches next program tag designating other scene in this message 10. When the same program tag does not exist (NO at the step S515), the message counting means 1b searches the entry matching with the searched program tag 100 in the database of the degree of interest in broadcast programs 3a (step S516). And the message counting means 1b counts up the number of messages 103 by one (step S517). And the operation returns to the step S513, and next program tag designating other scene in the message 10 is searched.

As the searching method whether the same program tag 100 exists or not at the step S515, there are methods. For example, when the plural same program tags 100 exist in the message 10 being not counted, the same program tags 100 are searched easily, or the same program tags 100 are searched in all the messages 10 being not counted. And when the program tag 100 is counted once, the same program tag 100 is not counted any more.

Next, referring to the drawings, a sixth embodiment of a server and a method delivering the degree of interest in broadcast programs of the present invention is explained. The sixth embodiment corresponds to the example (1-2-b) mentioned above. That is, at the sixth embodiment, the number of messages every scene of a program is also counted.

FIG. 21 is a block diagram showing a structure of a part of the server delivering the degree of interest in broadcast programs at the sixth embodiment of the present invention. As shown in FIG. 21, the server provides a message storing means 2, a database of the degree of interest in broadcast programs 3a, and a message classifying means 5b. As the database of the degree of interest in broadcast programs 3a , the same one at the fifth embodiment can be used at the sixth embodiment. The message classifying means 5b counts up the number of messages concerning a scene in a period in the database of the degree of interest in broadcast programs 3a, when the program tag 100 of the message 10 matches with the program tag 100 of a scene in a period in the database of the degree of interest in broadcast programs 3a. And the message classifying means 5b stores the counted messages in the message storing means 2.

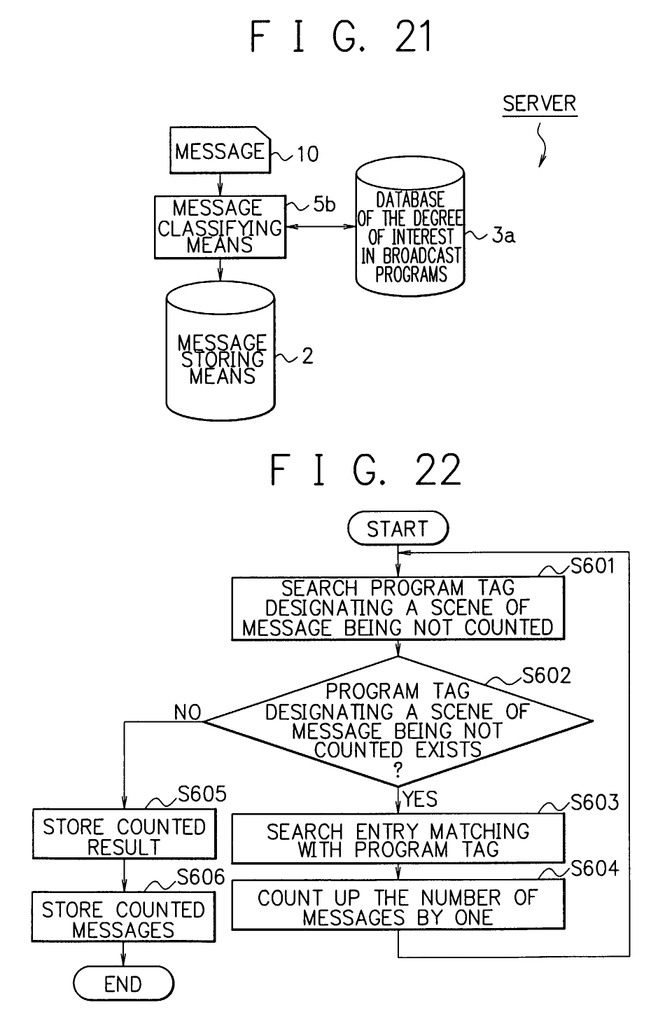

FIG. 22 is a flowchart showing operation of the message classifying means 5b shown in FIG. 21. Referring to FIG. 22, the operation of the message classifying means 5b at the sixth embodiment of the present invention is explained.

First, the message classifying means 5b searches the program tag 100 designating a scene of a message 10 being not counted, when the message 10 was supplied from a viewer (step S601). When the program tag 100 designating a scene of the message 10 being not counted does not exist (NO at step S602), that is, when all the messages 10 were counted, this counted result is stored in the database of the degree of interest in broadcast programs 3a (step S605). That is, the message classifying means 5b renews the entry in the database of the degree of interest in broadcast programs 3a. And the message classifying means 5b stores the counted messages in the message storing means 2 (step S606), and the operation ends. When the program tag 100 designating a scene of the message 10 being not counted exists (YES at the step S602), the message classifying means 5b searches the entry (the number of messages) matching with the program tag 100 in the database of the degree of interest in broadcast programs 3a (step S603). And the message classifying means 5b counts up the number of messages of the searched entry by one (step S604). And the operation returns to the step S601, and the message classifying means 5b searches the program tag 100 designating a scene of next message being not counted.

As mentioned above, by using the index i shown in the equation (2), and by giving the index i to each scene as the identifier, the number of messages can be counted every scene.

There are three kinds of data formats for the program tag 100 as mentioned above. However, the message classifying means 5b uses the program identifying and the scene in the identified program identifying tag. And when plural program tags of plural programs are included in a message, the message is handled as plural message identified by the plural program tags, and the message is counted as the plural messages.

The sixth embodiment of the present invention can be modified to a modified example. In this modified example, when plural program tags 100 for one program or one series of programs are included in one message 10, one message is counted only once for one program or one series of programs at the server, as same as at the modified example of the fifth embodiment.

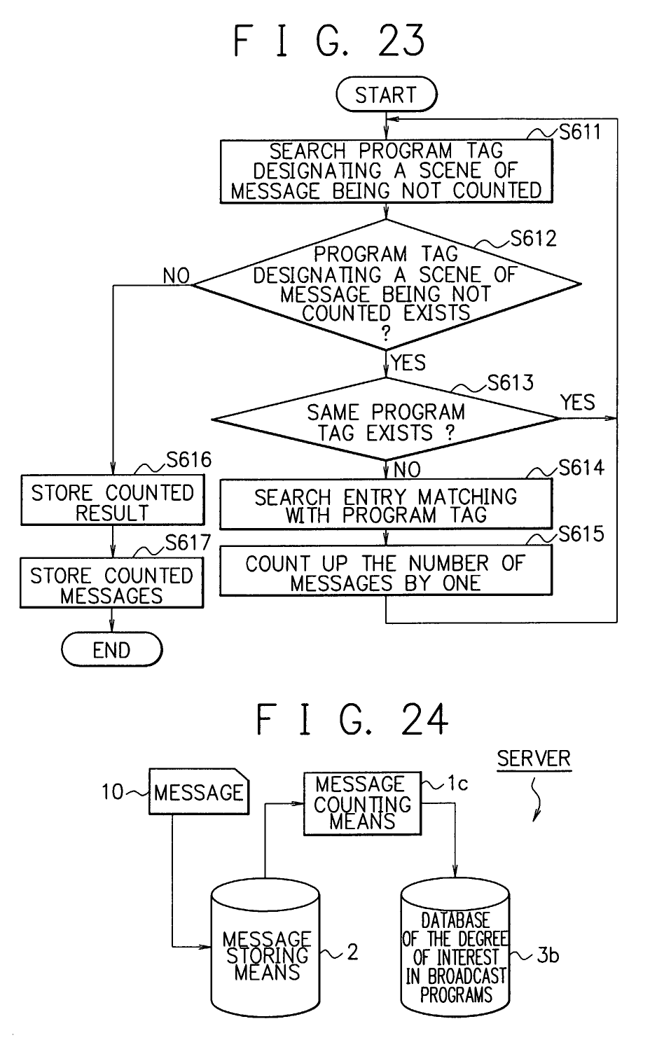

FIG. 23 is a flowchart showing operation of the message classifying means 5b at the modified example of the sixth embodiment of the present invention. Referring to FIG. 23, the operation of the message classifying means 5b at the modified example of the sixth embodiment of the present invention is explained.

First, the message classifying means 5b searches the program tag 100 designating a scene of a message 10 being not counted, when the message 10 was supplied from a viewer (step S611). When the program tag 100 designating a scene of the message 10 being not counted does not exist (NO at step S612), that is, when all the messages 10 were counted, this counted result is stored in the database of the degree of interest in broadcast programs 3a (step S616). That is, the message classifying means 5b renews the entry in the database of the degree of interest in broadcast programs 3a. And the message classifying means 5b stores the counted messages in the message storing means 2 (step S617), and the operation ends. When the program tag 100 designating a scene of the message 10 being not counted exists (YES at the step S612), the message classifying means 5b judges whether the same program tag designating a scene exists or not in the message 10 (step S613). When the same program tag 100 exists in the message (YES at the step S613), the message classifying means 5b counts the message 10 once, and the operation returns to the step S611, and the message classifying means 5b searches the program tag 100 designating a scene of next message being not counted.

When the same program tag 100 does not exist in the message 10 (NO at the step S613), the message classifying means 5b searches the entry matching with the program tag 100 in the database of the degree of interest in broadcast programs 3a (step S614). And the message classifying means 5b counts up the number of messages of the searched entry by one (step S615). And the operation returns to the step S611, and the message classifying means 5b searches the program tag 100 designating a scene of next message being not counted.

As the searching method whether the same program tag 100 exists or not at the step S613, there are methods. For example, when the plural same program tags 100 exist in the message 10 being not counted, the same program tags 100 are searched easily, or the same program tags 100 are searched in all the messages 10 being not counted. And when the program tag 100 is counted once, the same program tag 100 is not counted any more.

Next, referring to the drawings, a seventh embodiment of a server and a method delivering the degree of interest in broadcast programs of the present invention is explained. The seventh embodiment corresponds to the example (1-3-a) mentioned above. That is, at the seventh embodiment, the number of messages is counted every period when messages were supplied from viewers.

FIG. 24 is a block diagram showing a structure of a part of the server delivering the degree of interest in broadcast programs at the seventh embodiment of the present invention. As shown in FIG. 24, the server provides a message counting means 1c, a message storing means 2, and a database of the degree of interest in broadcast programs 3b. The message storing means 2 stores messages 10 supplied from viewers. The database of the degree of interest in broadcast programs 3b stores the number of messages every program and every period when the messages 10 were supplied. The message counting means 1c counts the number of messages every program and every period when the messages were supplied, by searching the messages 10 in the message storing means 2. And the message counting means 1c stores the number of messages every program and every period when the messages were supplied in the database of the degree of interest in broadcast programs 3b.

In this, the database of the degree of interest in broadcast programs 3b and the message counting means 1c can be used as follows. That is, the database of the degree of interest in broadcast programs 3b stores the number of messages every designated interval (scene) of a program in every period when the messages 10 were supplied. The message counting means 1c counts the number of messages every designated interval (scene) of a program in every period when the messages were supplied, by searching the messages 10 in the message storing means 2. And the message counting means 1c stores the number of messages every designated interval (scene) of the program and every period when the messages were supplied.

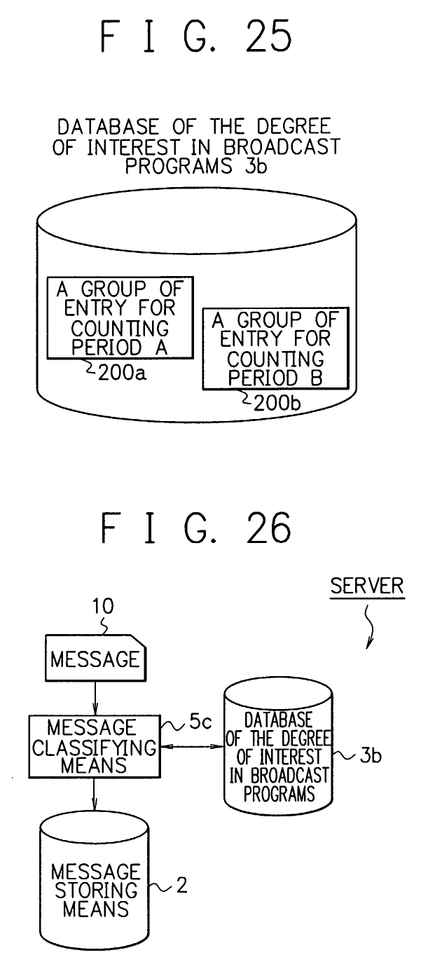

FIG. 25 is a diagram showing a data structure in the database of the degree of interest in broadcast programs 3b shown in FIG. 24. As shown in FIG. 25 at the seventh embodiment, the database of the degree of interest in broadcast programs 3b provides a group of entry every period in which the number of messages is counted. That is, the group of entry is provided every period when the messages were supplied, like a group of entry 200a for counting period A, a group of entry 200b for counting period B, . . . The group of entries (200a, 200b, . . . ) for the counting periods A, B . . . can be also used at the database of the degree of interest in broadcast programs 3 or 3a.

The message counting means 1c is different from the message counting means 1, 1a, or 1b, at the point that the number of messages is counted every message counting period. As the message counting period at the message counting means 1c, periods such as one day (from 0:00 to 24:00), one week (from 0:00 of Sunday to 24:00 of Monday, or from 0:00 of Monday to 24:00 of Sunday), and one month (from 0:00 of the first day to 24:00 of the last day of the month) are suitable.

The seventh embodiment of the present invention can be modified to two modified examples. At a first modified example, when plural program tags 100 for one program or one series of programs are included in one message 10, one message is counted only once for one program or one series of programs at the server, as the same as at the first modified example of the first embodiment.

At a second modified example of the seventh embodiment, as the same as at the second modified example of the first embodiment, when the program tag 100 of a message 10 is written in the format, which shows the message 10 belongs to a series of programs, such as “series name+subtitle” or “series name+the number of broadcasting times”, the message 10 is counted as the message for the program and also for the series of programs at the server.

Further, at the seventh embodiment, as the same as at the second embodiment, by using the database of a series of programs 4, the message is counted for the program and also for the series of programs, by judging that the program belongs to the series of programs. This operation is also possible at the seventh embodiment.

Next, referring to the drawing, an eighth embodiment of a server and a method delivering the degree of interest in broadcast programs of the present invention is explained. The eighth embodiment corresponds to the example (1-3-b) mentioned above. That is, at the eighth embodiment, the number of messages is counted every period when messages were supplied from viewers.

FIG. 26 is a block diagram showing a structure of a part of the server delivering the degree of interest in broadcast programs at the eighth embodiment of the present invention. As shown in FIG. 26, the server provides a message storing means 2, a database of the degree of interest in broadcast programs 3b, and a message classifying means 5c. As the message storing means 2, the one, which was used at the third and fourth embodiments, can be used. And as the database of the degree of interest in broadcast programs 3b, the one, which was used at the seventh embodiment, can be used. The database of the degree of interest in broadcast programs 3b stores the number of messages every program and every period when the messages 10 were supplied. The message classifying means 5c counts the number of messages every program and every period corresponding to the message counting period in the database of the degree of interest in broadcast programs 3b. And the message classifying means 5c stores the messages 10 after the messages were counted.

In this, the database of the degree of interest in broadcast programs 3b and the message classifying means 5c can be used as follows. That is, the database of the degree of interest in broadcast programs 3b stores the number of messages every designated interval (scene) of a program in every period when the messages 10 were supplied. The message classifying means 5c counts the number of messages every designated interval (scene) of a program in every period when the messages were supplied. And the message classifying means 5c stores the number of counted messages in the message storing means 2.

The message classifying means 5c at the eighth embodiment counts the number of messages every period when the messages were supplied, that is, every group of entry of message counting period in the database of the degree of interest in broadcast programs 3b. This is different from the third, fourth, and sixth embodiments. As the message counting period at the message classifying means 5c, periods such as one day (from 0:00 to 24:00), one week (from 0:00 of Sunday to 24:00 of Monday, or from 0:00 of Monday to 24:00 of Sunday), and one month (from 0:00 of the first day to 24:00 of the last day of the month) are suitable.

The eighth embodiment of the present invention can be modified to three modified examples. At a first modified example, when plural program tags 100 for one program or one series of programs are included in one message 10, one message is counted only once for one program or one series of programs at the server, as the same as at the first modified example of the third embodiment.

At a second modified example of the eighth embodiment, as the same as at the second modified example of the third embodiment, when the program tag 100 of a message 10 is written in the format, which shows the message 10 belongs to a series of programs, such as “series name+subtitle” or “series name+the number of broadcasting times”, the message 10 is counted as the message for the program and also for the series of programs at the server.

And as a third modified example at the third embodiment, when plural program tags of plural programs are included in a message, the message classifying means 5c handles the message as the message identified plural program tags 100, and counts the message as plural messages. That is, each of the plural program tags is handled as each message, and the number of messages is counted up by each of the plural program tags. This operation is also possible at the seventh embodiment.

Further, at the eighth embodiment, as the same as at the fourth embodiment, by using the database of a series of programs 4, the message is counted for the program and also for the series of programs, by judging that the program belongs to the series of programs. This operation is also possible at the eighth embodiment.

As a third modified example of the eighth embodiment, the modified example of the sixth embodiment can be applied to the eighth embodiment. That is, when plural program tags 100 of one program in one period are included in one message, this message is counted only once.

Next, referring to the drawings, a ninth embodiment of a server and a method delivering the degree of interest in broadcast programs of the present invention is explained. The ninth embodiment corresponds to the example (2-1-a) mentioned above. That is, at the ninth embodiment, a list of messages relating to each program is made.

FIG. 27 is a block diagram showing a structure of a part of the server delivering the degree of interest in broadcast programs at the ninth embodiment of the present invention. As shown in FIG. 27, the server provides a message storing means 2, a message list making means 6, and a database of message lists 7. The message storing means 2 stores messages 10 supplied from viewers. The database of message lists 7 stores reference information of messages 10 relating to each program. The message list making means 6 receives the messages 10 from the message storing means 2 and stores reference information relating to a program and/or a series of programs matching with program tags 100 of the received messages 10 in the database of message list 7. In this, the reference information is impressions and comments for the program and/or the series of programs form the viewers.

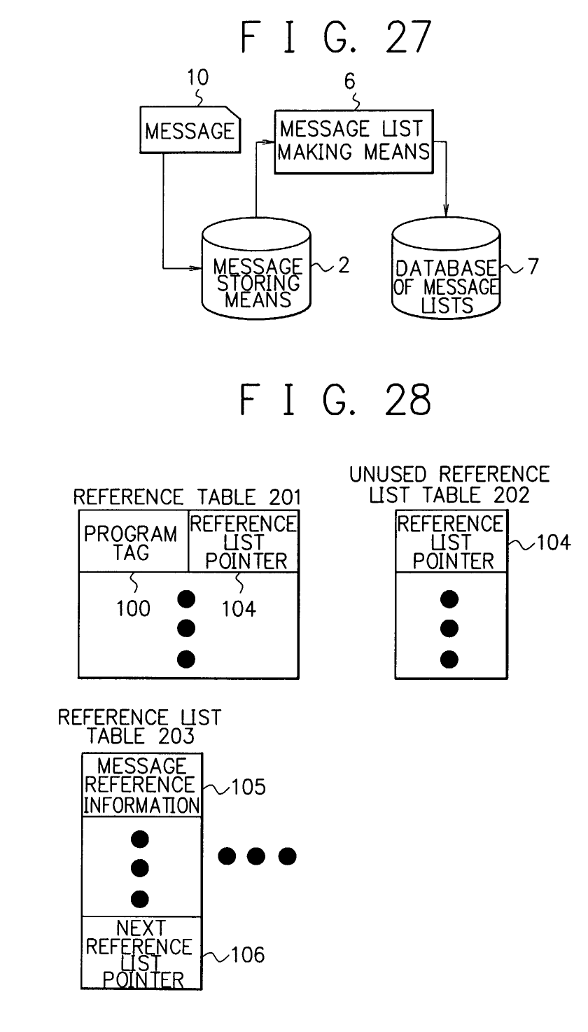

FIG. 28 is a diagram showing a data structure of the database of message lists 7 shown in FIG. 27. As shown in FIG. 28, the database of message lists 7 provides a reference table 201, an unused reference list table 202, and plural reference list tables 203 . . . Each entry of the reference table 201 provides a program tag 100 and a reference list pointer 104 for referring to the first reference list table 203. The reference list table 203 provides plural entries for message reference information 105 and the next reference list pointer 106. In each of plural entries (message reference information 105), reference information relating to messages 10 having the same program tag 100 is stored. The next reference list pointer 106 is used to refer to the next message list table 203, in which reference information of the messages 10 relating to the same program tag 100 is stored.

In this, when any reference information relating to messages 10 is not stored in entries (message reference information 105, . . . ), a value, showing that reference information does not exist, is stored in the entries. Further, in case that the next reference list table 203 does not exist, a value showing the last is stored in the next reference list pointer 106 in the reference list table 203.

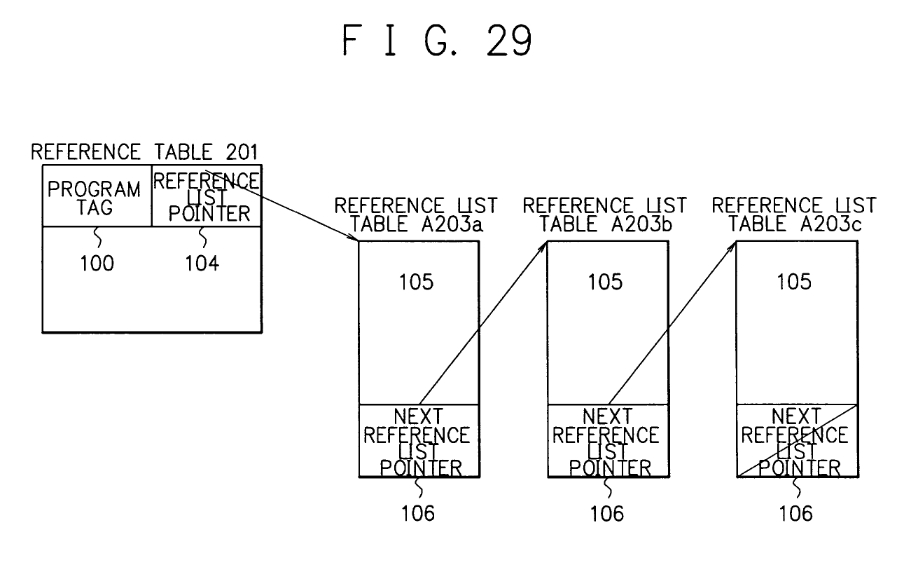

FIG. 29 is a diagram showing operation for referring to the reference list table 203 shown in FIG. 28. As shown in FIG. 29, first, the reference list pointer 104 corresponding to the program tag 100 refers to the reference list table A203a, after this, the reference list tables A 203b, A203c are referred to sequentially in the one direction, by using the next reference list pointer 106. And when the last exists in the next reference list pointer 106 in the reference list table A203c, the operation ends.

The unused reference list table 202 provides plural reference list pointers 104 for referring to the reference list tables 203. In this, the reference list tables 203, which are not used, are registered in the unused reference list table 202.

The message list making means 6 works at the time when the messages 10 were stored in the message storing means 2 and works for the stored messages 10.

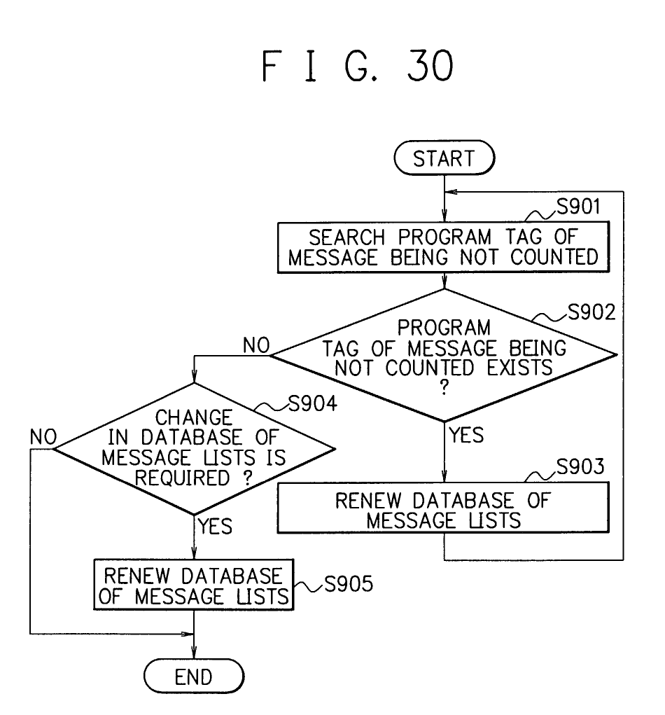

FIG. 30 is a flowchart showing operation of the message list making means 6 shown in FIG. 27. Referring to FIG. 30, the operation of the message list making means 6 at the ninth embodiment of the present invention is explained. In this, the message list making means 6 starts to work at the time when a message 10 having reference information was designated.

First, the message list making means 6 searches the program tag 100 of a message 10 being not counted (step S901). When the program tag 100 of the message 10 being not counted does not exist (NO at step S902), that is, all the program tags 100 of the messages 10 were counted, therefore, it is judged whether a change in the database of message lists 7 is required or not (step S904). When the change is not required (NO at the step S904), the operation ends. When the change is required (YES at the step S904), the database of message lists 7 is renewed (step S905), and the operation ends. When the program tag 100 of the message 10 being not counted exists (YES at the step S902), the program tag 100 of the message 10 being not counted and reference information of the message 10 are designated, and the message list in the database of message lists 7 is renewed (step S903). And the operation returns to the step S901, and the program tag 100 of next message 10 being not counted is searched.

At the ninth embodiment, as the program tag 100, any of the three kinds of program tags 100, mentioned above, can be used. At the message list making means 6, in case that the program identifying tag, the series of programs identifying tag, or the program identifying and the moment (scene) in the identified program identifying tag is used, only a part identifying the program is used.

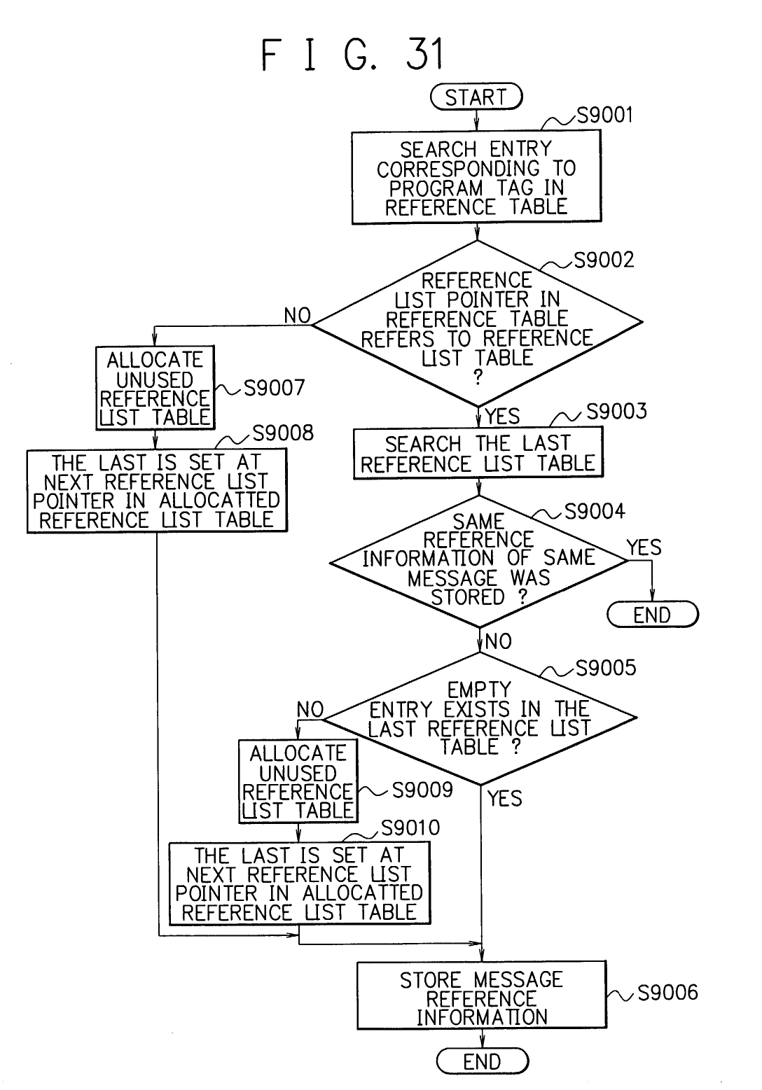

FIG. 31 is a flowchart showing message list renewing operation at the message list making means 6 shown in FIG. 27. Referring to FIG. 31, the message list renewing operation at the message list making means 6 in the ninth embodiment of the present invention is explained.

First, the message list making means 6 searches an entry corresponding to a designated program tag 100 in the reference table 201 (step S9001). When the reference list pointer 104 in the searched entry is stored in a state that any reference list table 203 is not referred to (NO at step S9002), a reference list table being not used is taken out from the unused reference list table 202. And the reference list pointer 104 in the reference table 201 is set to refer to the reference list table 203 taken out from the unused reference list table 202, that is, one of the unused reference list tables 202 is allocated (step S9007). The last is set at the next reference list pointer 106 in the reference list table 203 (step S9008). And the message reference information 105 of the message 10 is stored in the reference list table 203 (step S9006), and the operation ends.

When information referring to a reference list table 203 was stored in the reference list pointer 104 of the searched reference table 201, (YES at the step S9002), the message list making means 6 refers to reference list tables 203 having the message reference information 105 for the designated message 10, sequentially from the first reference list table 203 in order. And a reference list table 203 being the last is searched (step S9003). When a reference list table 203 having message reference information 105 is found, and next, a reference list table 203 having no message reference information 105, that is, an empty entry is found, the reference list table 203 having the message reference information 105 is judged as the last. The message list making means 6 continues to search the next reference list table 203 by using the next reference list pointer 106 until the last is found.

When the message list making means 6 found that the same message reference information 105 was stored in the reference list table 203 (YES at step S9004), the operation ends. When the message list making means 6 could not find that the same message reference information 105 was stored in the reference list table 203 (NO at the step S9004), the message list making means 6 judges whether an empty entry exists or not in the last reference list table 203 (step S9005). When an empty entry exists in the last reference list table 203 (YES at the step S9005), the message reference information 105 in the message 10 is stored in the reference list table 203 (the step S9006), and the operation ends.

When an empty entry does not exist in the last reference list table 203 (NO at the step S9005), a reference list table being not used is taken out from the unused reference list table 202, that is, one of the unused reference list tables 202 is allocated (step S9009). And the next reference list pointer 106 is set in the last reference list table 203, and the last is set in the next reference list pointer of the taken out reference list table 203 (step S9010). After setting the last, the message reference information 105 of the message 10 is stored in the taken out reference list table 203 (the step S9006), and the operation ends.

Next, a modified example of the ninth embodiment of the present invention is explained. In this modified example, as the same as at the second modified example of the first embodiment, when the program tag 100 of a message 10 is written in the format, which shows the message 10 belongs to a series of programs, such as “series name+subtitle” or “series name+the number of broadcasting times”, the message 10 is counted as the message for the program and also for the series of programs at the server.

Further, at the ninth embodiment, as the same as at the second embodiment of the present invention, by using a database of a series of programs 4, a program is judged whether the program belongs to a series of programs or not, and the program is stored in the message list of the program and also in the message list of the series of programs, when the program belongs to the series of programs. This modified example of the ninth embodiment is also possible.

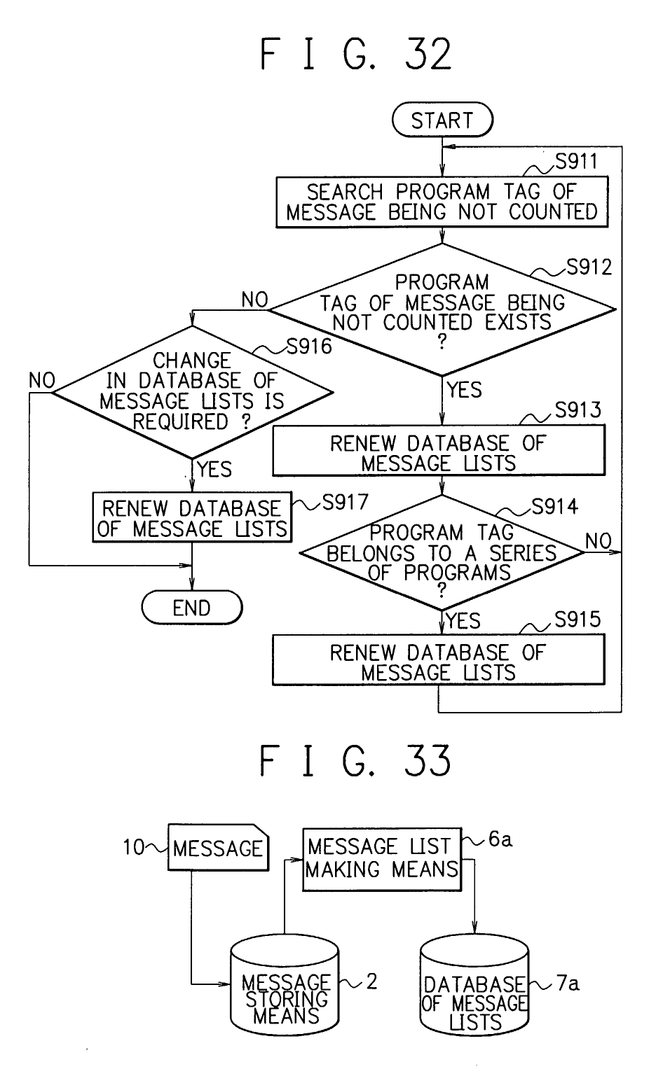

FIG. 32 is a flowchart showing operation of the message list making means 6 at the modified example of the ninth embodiment of the present invention. Referring to FIG. 32, the operation of the message list making means 6 at the modified example of the ninth embodiment of the present invention is explained.

First, the message list making means 6 searches the program tag 100 of a message 10 being not counted (step S911). When the program tag 100 of the message 10 being not counted does not exist (NO at step S912), that is, all the program tags 100 of the messages 10 were counted, therefore, it is judged whether a change in the database of message lists 7 is required or not (step S916). When the change is not required (NO at the step S916), the operation ends. When the change is required (YES at the step S916), the database of message lists 7 is renewed (step S917), and the operation ends.

When the program tag 100 of the message 10 being not counted exists (YES at the step S912), the program tag 100 of the message 10 being not counted and reference information of the message 10 are designated, and a message list is renewed (step S913). Next, the message list making means 6 judges whether the program tag 100 belongs to a series of programs or not (step S914). When the program tag 100 of the message 10 does not belong to the series of programs (NO at the step S914), the operation returns to the step S911, and searches the program tag 100 of the next message 10 being not counted. When the program tag 100 of the message 10 belongs to the series of programs (YES at the step S914), reference information of the program tag 100 of the message 10 being not counted and the message 10 is designated, and a message list is renewed (step S915). And the operation returns to the step S911, and searches the program tag 100 of the next message 10 being not counted. This message renewing operation is the same at the ninth embodiment.

Next, referring to the drawings, a tenth embodiment of a server and a method delivering the degree of interest in broadcast programs of the present invention is explained. The tenth embodiment corresponds to the example (2-2-a) mentioned above. That is, at the ninth embodiment, a list of messages relating to every scene of each program is made.

FIG. 33 is a block diagram showing a structure of a part of the server delivering the degree of interest in broadcast programs at the tenth embodiment of the present invention. As shown in FIG. 33, the server provides a message storing means 2, a message list making means 6a, and a database of message lists 7a. The message storing means 2 stores messages 10 supplied from viewers. The database of message lists 7a stores reference information of messages 10 relating to every scene (every designated interval) of each program. The message list making means 6a receives the messages 10 from the message storing means 2 and makes a message list of reference information relating to scenes of a program matching with program tags 100 of the received messages 10. And the message list making means 6a stores the message list of the reference information relating to every scene (every designated interval) of the program in the database of message lists 7a .

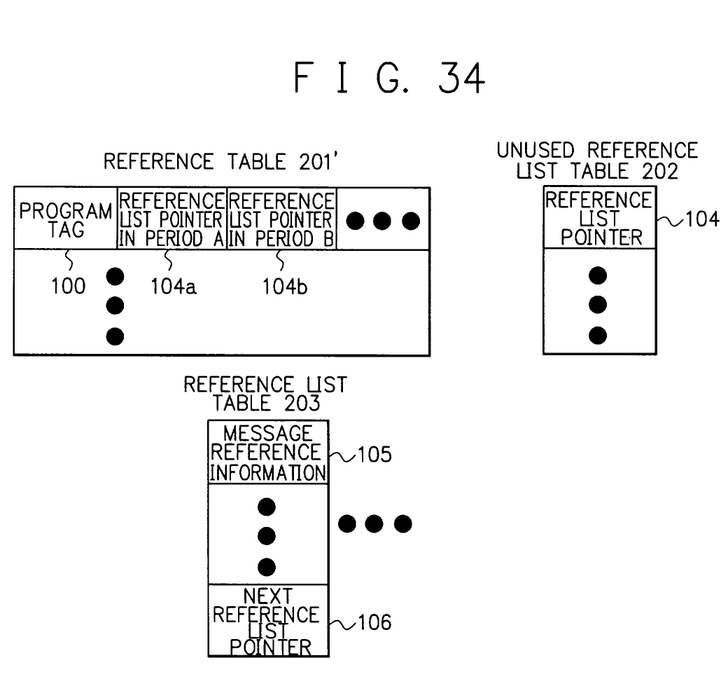

FIG. 34 is a diagram showing a data structure of the database of message lists 7a shown in FIG. 33. As shown in FIG. 33, the database of message lists 7a provides a reference table 201′, an unused reference list table 202, and plural reference list tables 203 . . . Each entry of the reference table 201′ provides a program tag 100 and a reference list pointer for referring to the first reference list table 203 every designated period. The reference list pointers in FIG. 34 are shown as a reference list pointer 104a in the period A, a reference list pointer 104b in the period B, . . . .

The number of fields, in which the reference list pointer 104a in the period A, the reference list pointer 104b in the period B, . . . are stored, is decided by the length of a program. As mentioned at the equation (1), when it is defined that the length of a program is L and the designated period is t, the number of fields N is shown in an equation being the same equation (1).

N=ceil(L÷t) . . . (1)

In this, the ceil (x) is a function that gives a minimum integer exceeding the x. Therefore, the equation (1) is also used at the tenth embodiment.

The reference list table 203 provides plural entries for message reference information 105 and a next reference list pointer 106. In each of plural entries (message reference information 105), reference information relating to every scene (designated interval) of the messages 10 having the same program tag 100 is stored. The next reference list pointer 106 is used to refer to the next message list table 203, in which reference information of every scene (designated interval) of the messages 10 relating to the same program tag 100 is stored.

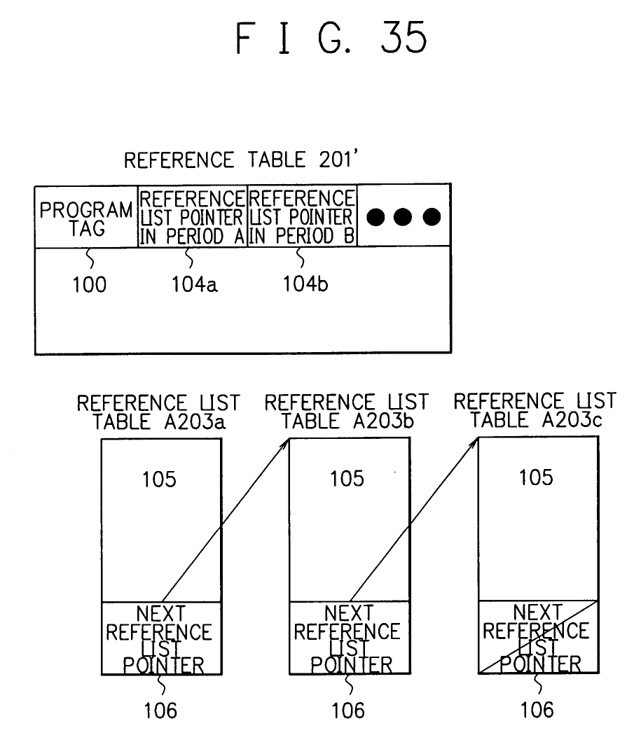

FIG. 35 is a diagram showing operation for referring to the reference list table 203 shown in FIG. 34. As shown in FIG. 35, at the reference list table, in which the message reference information 105 every scene of each program is stored, the next reference list pointer 106 is used, and the reference list tables A203a, A203b, A203c, . . . are referred to sequentially in the one direction. In this, the reference list pointer 104a in the reference table 201′ stores information for referring to the first reference list table A203a, in which the message reference information 105 of every scene of the program designated by the program tag 100 is stored. And the reference list pointer 104b stores information referring to the first reference list table, which is related to the message 10 of the reference list pointer 104b. In this case, the reference list pointer 104b refers to the reference list table B203a, B203b, B203c, . . . (not shown).

Therefore, when any reference information relating to messages 10 is not stored in entries (message reference information 105, . . . ), a value, showing that reference information does not exist, is stored. Further, in case that the next reference list table 203 does not exist, a value showing the last is stored in the next reference list pointer 106 in the reference list table 203.

The unused reference list table 202 provides plural reference list pointers 104 for referring to the reference list tables 203. Therefore, the reference list tables 203, which are not used, are registered in the unused reference list table 202.

The message list making means 6a works at the time when the messages 10 were stored in the message storing means 2 and works for the stored messages 10.

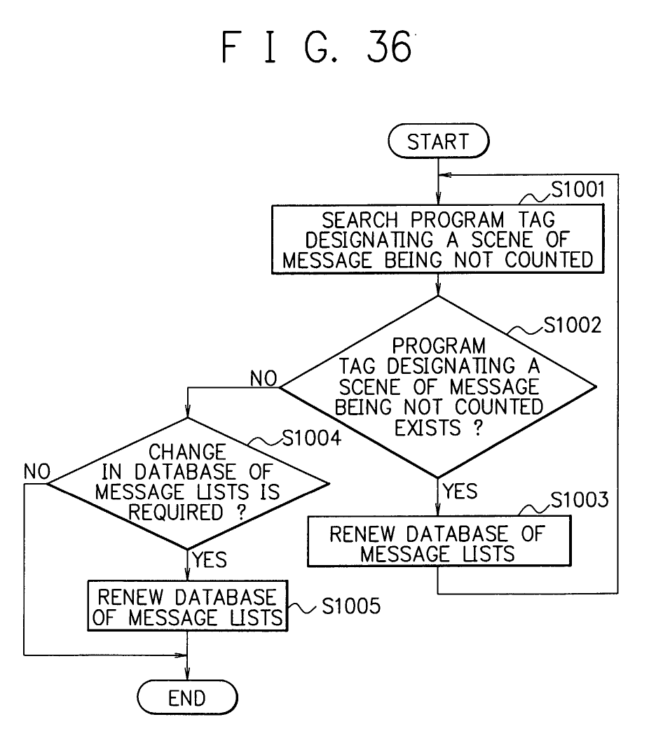

FIG. 36 is a flowchart showing operation of the message list making means 6a shown in FIG. 33. Referring to FIG. 36, the operation of the message list making means 6a at the tenth embodiment of the present invention is explained. In this, the message list making means 6a starts to work at the time when a message 10 and reference information of the message 10 are designated.

First, the message list making means 6a searches the program tag 100 designating a scene of a message 10 being not counted (step S1001). When the program tag 100 designating a scene of the message 10 being not counted does not exist (NO at step S1002), that is, all the program tags 100 designating scenes of the messages 10 were counted, therefore, it is judged whether a change in the database of message lists 7a is required or not (step S1004). When the change is not required (NO at the step S1004), the operation ends. When the change is required (YES at the step S1004), the database of message lists 7a is renewed (step S1005), and the operation ends. When the program tag 100 designating a scene of the message 10 being not counted exists (YES at the step S1002), the program tag 100 having a designating scene and reference information of the message 10 are designated, and the database of message list 7a is renewed (step S1003). And the operation returns to the step S1001, and the program tag 100 designating a scene of next message 10 being not counted is searched.

FIG. 37 is a flowchart showing message list renewing operation at the message list making means 6a shown in FIG. 33. Referring to FIG. 37, the message list renewing operation at the message list making means 6a in the tenth embodiment of the present invention is explained.

First, the message list making means 6a searches an entry corresponding to a designated program tag 100 in the reference table 201′ (step S10001). When the reference list pointer 104 in the period including a designated scene in the searched entry is stored in a state that any reference list table 203 is not referred to (NO at step S10002), a reference list table being not used is taken out from the unused reference list table 202. And the reference list pointer 104 in the entry of the reference table 201′ is set to refer to the reference list table 203 taken out from the unused reference list table 202, that is, one of the unused reference list tables 202 is allocated (step S10007). The last is set at the next reference list pointer 106 in the reference list table 203 (step S10008). And the message list making means 6a stores the message reference information 105 of the message 10 in the reference list table 203 (step S10006), and the operation ends.

When in the reference list pointer 104 of the searched reference table 201′, information referring to a reference list table 203 was stored (YES at the step S10002), the message list making means 6a refers to reference list tables 203, in which the message reference information 105 to the designated message 10 was stored, sequentially from the first reference list table 203 in order. And a reference list table 203 being the last is searched (step S10003). When a reference list table 203 having message reference information 105 is found, and next, a reference list table 203 having no message reference information 105, that is, an empty entry is found, the reference list table 203 having the message reference information 105 is judged as the last. The message list making means 6a continues to search the next reference list table 203 by using the next reference list pointer 106 until the last is found.

When the message list making means 6a found that the same reference information of the same message 10 was stored in the reference list table 203 (YES at step S10004), the operation ends. When the message list making means 6 could not find that the reference information for the same message 10 was stored in the reference list table 203 (NO at the step S10004), the message list making means 6a judges whether an empty entry exists or not in the last reference list table 203 (step S10005). When an empty entry exists in the last reference list table 203 (YES at the step S10005), the message reference information 105 of the message 10 is stored in the reference list table 203 (the step S10006), and the operation ends.

When an empty entry does not exist in the last reference list table 203 (NO at the step S10005), a reference list table being not used is taken out from the unused reference list table 202, that is, one of the unused reference list tables 202 is allocated (step S10009). And the next reference list pointer 106 is set in the last reference list table 203, and the last is set in the next reference list pointer of the taken out reference list table 203 (step S10010). After setting the last, the message reference information 105 of the message 10 is stored in the taken out reference list table 203 (the step S10006), and the operation ends.

As mentioned above, it is desirable that each scene is decided by using an identifier. As this identifier, an index i can be used, and the equation (2) was introduced. That is, the index i of a period including a scene is shown in the following equation (2), when it is defined that time after a program started is s seconds (or minutes) and the designated period is t as mentioned above.

i=floor(s÷t) . . . (2)

In this, the floor (x) is a function that gives a maximum integer not exceeding the x. Therefore, the equation (2) s also used at the tenth embodiment.

Next, referring to the drawings, an eleventh embodiment of a server and a method delivering the degree of interest in broadcast programs of the present invention is explained. The eleventh embodiment corresponds to the example (3-1-a) mentioned above. That is, at the eleventh embodiment, the number of messages relating to a program in a program list is delivered to users.

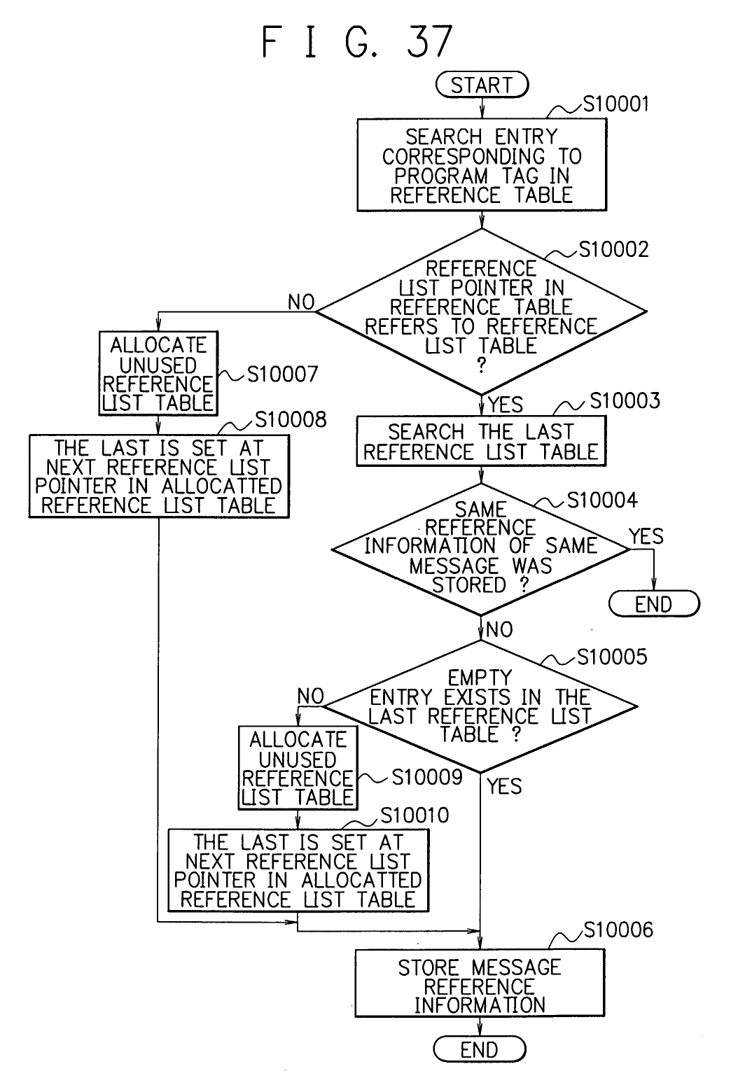

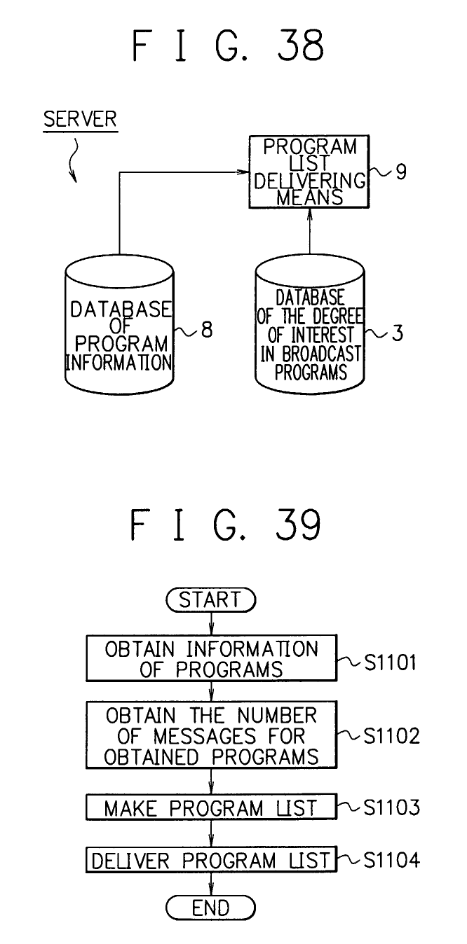

FIG. 38 is a block diagram showing a structure of a part of the server delivering the degree of interest in broadcast programs at the eleventh embodiment of the present invention. As shown in FIG. 38, the server provides a database of the degree of interest in broadcast programs 3, a database of program information 8, and a program list delivering means 9. The database of program information 8 stores information of programs, at least stores information for making a program list. In the database of the degree of interest in broadcast programs 3, for example, the number of messages, collected at the first or third embodiment, is stored. The program list delivering means 9 makes program list information by using the database of the degree of interest in broadcast programs 3 and the database of program information 8, and delivers a program list, made by the program list information, to users.

FIG. 39 is a flowchart showing operation at the program list delivering means 9 shown in FIG. 38. The program list delivering means 9 starts to work, after the delivering period, the delivering region or the broadcasting stations, of a program list to be delivered, were designated. This delivering period can be designated as, for example, from Hs:Ms to He:Me time, Y year, M month, D day. And the region can be designated by using a prefecture name, a city name, a zip code, or an area code.

Referring to FIG. 39, the operation at the program list delivering means 9 is explained. First, the program list delivering means 9 obtains information of programs in a designated region or designated broadcasting stations in a designated period from the database of program information 8, after the program list delivering means 9 was started (step S1101). Next, the program list delivering means 9 obtains the number of messages for the obtained programs from the database of the degree of interest in broadcast programs 3 (step S1102). And the program list delivering means 9 makes delivering data (program list) by using the obtained data (step S1103), and delivers the made data (program list) (step S1104). In this, the program list delivering means 9 transmits the data to clients (not shown) which can display or print the data and the clients show the data to users, or directly displays or prints the data by using an external output instrument such as a display and a printer.

The program list delivering means 9 makes data which the clients can use by using the obtained data, and the made data are delivered to the clients. For example, in case that the program list (data) is delivered via the Internet, the program list is made by the HTML format, and transmitted to the clients having a Web browser by the HTTP (hyper text transfer protocol) by using a Web server.

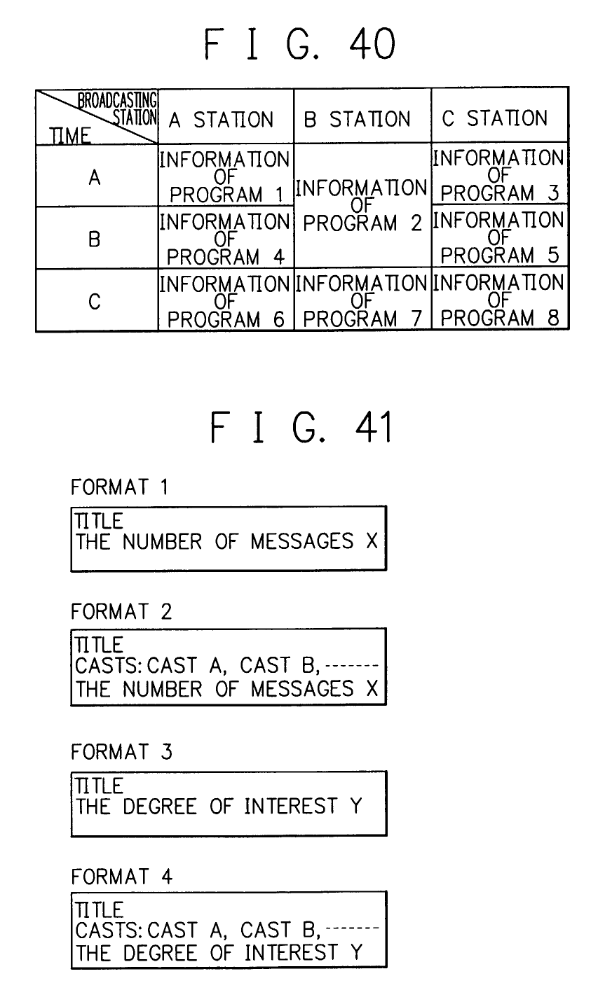

FIG. 40 is a diagram showing a program list made by the program list delivering means 9 at the eleventh embodiment of the present invention. In FIG. 40, the vertical axis shows the time when each program is broadcast, and the horizontal axis shows each name of broadcasting stations. This is a format, which is used as a program list in a newspaper, and in which programs of plural broadcast stations are shown at the same time. And as shown in FIG. 40, information of each program is shown in each column.

FIG. 41 is a diagram showing formats of program information in the program list shown in FIG. 40. In FIG. 41, as examples, four formats for the program information are shown. In the format 1, the title (name of a program) obtained from the database of program information 8, and the number of messages X for the program, obtained from the database of the degree of interest in broadcast programs 3, are shown. In the format 2, the title of a program and names of casts (cast A, cast B, . . . ), obtained from the database of program information 8, and the number of messages X for the program, obtained from the database of the degree of interest in broadcast programs 3, are shown. In the format 3, the title of a program obtained from the database of program information 8, and the degree of interest Y in the program, are shown. In this, the degree of interest Y in the program is calculated by that the number of messages for the program is divided by the total number of program tags for the programs in the program list. In the format 4, the title of a program and names of casts (cast A, cast B, . . . ), obtained from the database of program information 8, and the degree of interest Y in the program, are shown. In the formats 3 and 4, the total number of program tags for the programs in the program list is calculated at the time when the program list is formed.

In case that the database of the degree of interest in broadcast programs 3 is the same at the first modified example of the first embodiment or the first modified example of the third embodiment, the degree of interest Y in the formats 3 and 4 is calculated by that the number of messages for the program is divided by the total number of messages for the programs in the program list. And the degree of interest Y in the program information can be shown as %.

Next, referring to the drawings, a twelfth embodiment of a server and a method delivering the degree of interest in broadcast programs of the present invention is explained. The twelfth embodiment corresponds to the example (3-1-b) mentioned above. That is, at the twelfth embodiment, the number of messages relating to a series of programs in a program list is delivered to users.

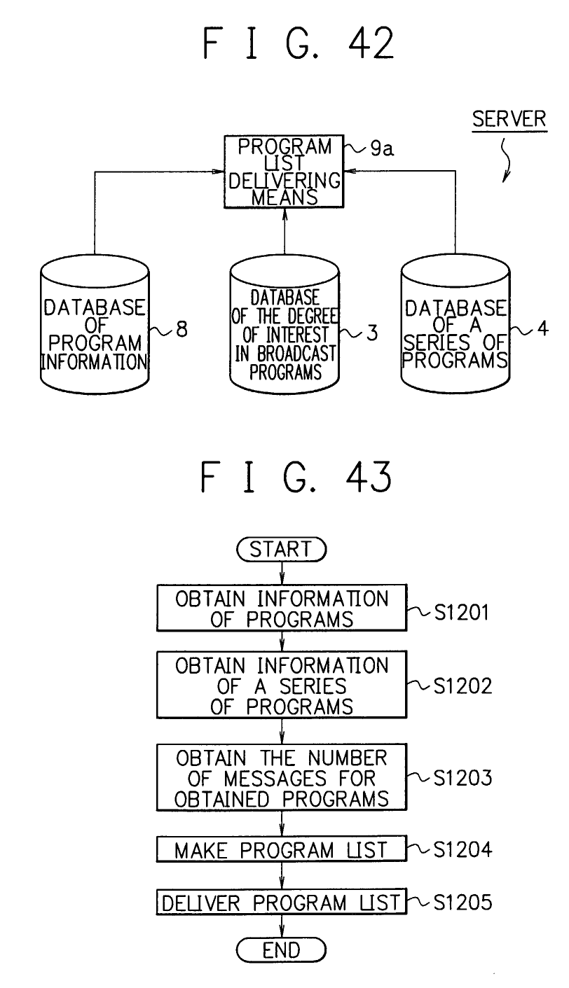

FIG. 42 is a block diagram showing a structure of a part of the server delivering the degree of interest in broadcast programs at the twelfth embodiment of the present invention. As shown in FIG. 40, the server provides a database of the degree of interest in broadcast programs 3, a database of a series of programs 4, a database of program information 8, and a program list delivering means 9a. The database of program information 8 stores information of programs, as the same as at the eleventh embodiment. In the database of the degree of interest in broadcast programs 3, for example, the number of messages for a program and a series of programs, collected at the first, second, third, or fourth embodiment, is stored. The database of a series of programs 4 records what series of programs a program belongs to, when the program belongs to a series of program, as the same as at the second embodiment. The program list delivering means 9a makes program list information by using the database of the degree of interest in broadcast programs 3, the database of a series of programs 4, and the database of program information 8, and delivers a program list, made by the program list information, to users.

FIG. 43 is a flowchart showing operation at the program list delivering means 9a shown in FIG. 42. The program list delivering means 9a starts to work, after the delivering period, the delivering region or the broadcasting stations, of a program list to be delivered, were designated. This delivering period can be designated as, for example, from Hs:Ms to He:Me time, Y year, M month, D day. And the region can be designated by using a prefecture name, a city name, a zip code, or an area code.

Referring to FIG. 43, the operation at the program list delivering means 9a is explained. First, the program list delivering means 9a obtains information of programs of a designated region or designated broadcasting stations in a designated period from the database of program information 8, after the program list delivering means 9a was started (step S1201). Next, the program list delivering means 9a obtains information, whether a program belongs to a series of programs or not, from the database of a series of programs 4 (step S1202). And the program list delivering means 9a obtains the number of messages for the obtained program or the obtained series of programs from the database of the degree of interest in broadcast programs 3 (step S1203). And the program list delivering means 9a makes delivering data (program list) by using the obtained data (step S1204), and delivers the made data (program list) (step S1205).

In this, the program list delivering means 9a transmits the data to clients (not shown) which can display or print the data and the clients show the data to users, or directly displays or prints the data by using an external output instrument such as a display and a printer.

The program list delivering means 9a makes data which the clients can use by using the obtained data, and the made data are delivered to the clients. For example, in case that the program list (data) is delivered via the Internet, the program list is made by the HTML format, and transmitted to the clients having a Web browser by the HTTP by using a Web server.

That is, as the program list delivering means 9a, any means, which can make data to be delivered to users and can deliver the data to the users, can be used, and its delivering method is not limited to the method mentioned above.

At the twelfth embodiment, as formats, by which the program information for the programs is shown, the formats used at the eleventh embodiment shown in FIG. 41 can be used. However, in case that a program does not belongs to a series of programs, the number of messages X is the one for the program, but, in case that the program belongs to a series of programs, the number of messages X is the one for the series of programs. And in case that a program does not belongs to a series of programs, the degree of interest Y is calculated by that the number of messages for the program is divided by the total number of program tags in the program list, but in case that a program belongs to a series of programs, the degree of interest Y is calculated by that the number of messages for the series of programs is divided by the total number of program tags in the program list.

And when the format 3 or 4 is used, the total number of program tags is counted at the time when the program list is formed.

When the database of the degree of interest in broadcast programs 3, at the second modified example of the first embodiment, or at the second modified example of the second embodiment, is used at the twelfth embodiment, the degree of interest Y at the format 3 or 4 is calculated by that the number of messages for a program in the program list is divided by the total number of messages in the program list. In this case, the total number of messages is counted at the time when the program list is formed. And as mentioned above, the degree of interest Y in the program information can be shown as %.

Next, a modified example of the twelfth embodiment of the present invention is explained. In this modified example, in case that a program belongs to a series of programs, the number of messages for the program at each broadcasting time and the number of messages for the series of programs are shown.

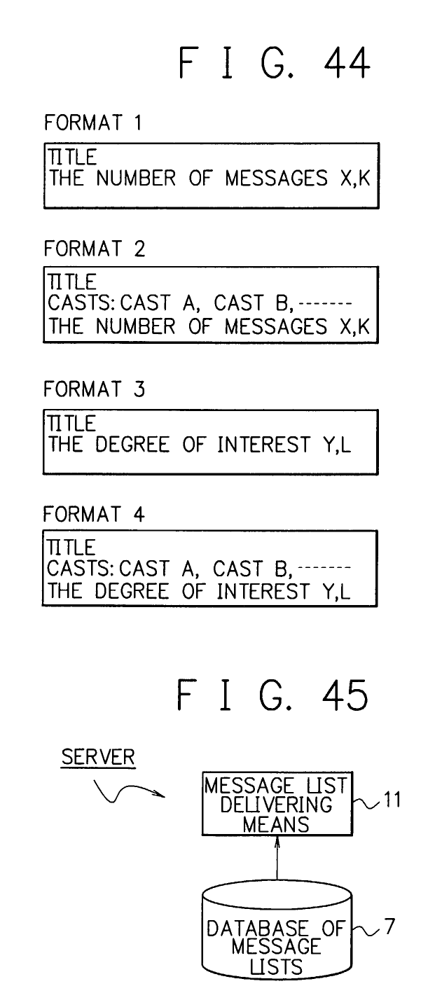

FIG. 44 is a diagram showing formats of program information in a program list formed at the program list delivering means 9a at the modified example of the twelfth embodiment of the present invention. In FIG. 44, as examples, four formats are shown. In the format 1, the title (name of a program) obtained from the database of program information 8, the number of messages X for the program and the number of messages K for the series of programs to which the program belongs, obtained from the database of the degree of interest in broadcast programs 3, are shown. In the format 2, the title of a program and names of casts (cast A, cast B, . . . ), obtained from the database of program information 8, and the number of messages X for the program and the number of messages K for the series of programs to which the program belongs, obtained from the database of the degree of interest in broadcast programs 3, are shown. In the format 3, the title of a program obtained from the database of program information 8, and the degree of interest Y in the program and the degree of interest L in the series of programs to which the program belongs, obtained from the database of the degree of interest in broadcast programs 3, are shown. In this, the degree of interest Y in the program is calculated by that the number of messages for the program is divided by the total number of program tags for the programs in the program list. And the degree of interest L in the series of programs is calculated by that the number of messages for the series of programs is divided by the total number of program tags for the programs in the program list. In the format 4, the title of a program and names of casts (cast A, cast B, . . . ), obtained from the database of program information 8, and the degree of interest Y in the program and the degree of interest L in the series of programs to which the program belongs, obtained from the database of the degree of interest in broadcast programs 3, are shown. In the formats 3 and 4, the total number of program tags for the programs in the program list is calculated at the time when the program list is formed.

In case that the database of the degree of interest in broadcast programs 3 is the same at the first modified example of the first embodiment or the first modified example of the third embodiment, the degree of interest Y in the formats 3 and 4 is calculated by the following method. That is, the degree of interest Y is calculated by that the number of messages for the program is divided by the total number of messages for the programs in the program list, obtained from the database of the degree of interest in broadcast programs 3. And the degree of interest L is calculated by that the number of messages for the series of programs to which the program belongs is divided by the total number of messages for the programs in the program list, obtained from the database of the degree of interest in broadcast programs 3. In this case, the total number of messages is counted at the time when the program list is formed. And the degree of interest Y and L can be shown as % in the formats 3 and 4.

Next, a thirteenth embodiment of the present invention is explained. The thirteenth embodiment of the present invention corresponds to the example (3-1-c) mentioned above. That is, at the thirteenth embodiment, the number of messages supplied in a designated period is delivered to users. At the thirteenth embodiment, the server uses the database of the degree of interest in broadcast programs 3b used at the seventh and eighth embodiments. The database of the degree of interest in broadcast programs 3b stores the number of messages for a program every designated period when the messages 10 were supplied. That is, the server at the thirteenth embodiment provides the database of the degree of interest in broadcast programs 3b, the database of program information 8, and the program list delivering means 9. This is the same at the eleventh embodiment except the database of the degree of interest in broadcast programs 3b is used at the thirteenth embodiment.

When the program list delivering means 9 was started, the period, when the messages were stored, is designated, and the program list delivering means 9 obtains the number of messages supplied during the designated period from the database of the degree of interest in broadcast programs 3b. And the program list to be delivered is the same at the eleventh embodiment, except the number of messages is in the designated period. This is different from the eleventh embodiment. As the period in which the messages are stored, a period such as today, this week, this month, or this year, in which the day delivering the program list is included, can be used. Further, as the period, a period being previous to the delivering day such yesterday, last week, last month, and last year, can be use. Further, the number of messages can be delivered by adding the number of messages in plural periods such as in four days, two weeks, and three months.

Next, a fourteenth embodiment of the present invention is explained. The fourteenth embodiment of the present invention also corresponds to the example (3-1-c) mentioned above. That is, at the fourteenth embodiment, the number of messages supplied in a designated period is delivered to users, but the number of messages for a program and for a series of programs is counted. At the fourteenth embodiment, the server uses the database of the degree of interest in broadcast programs 3b used at the seventh and eighth embodiments. The database of the degree of interest in broadcast programs 3b stores the number of messages for a program and for a series of programs every designated period when the messages 10 were supplied. That is, the server at the fourteenth embodiment provides the database of the degree of interest in broadcast programs 3b, the database of a series of programs 4, the database of program information 8, and the program list delivering means 9a. This is the same at the twelfth embodiment except the database of the degree of interest in broadcast programs 3b is used at the fourteenth embodiment. And the number of messages for a series of programs is also delivered at the fourteenth embodiment.

When the program list delivering means 9a was started, the period, when the messages were stored, is designated, and the program list delivering means 9 obtains the number of messages supplied during the designated period from the database of the degree of interest in broadcast programs 3b. And the program list to be delivered is the same at the modified example of the twelfth embodiment, except the number of messages is in the designated period. This is different from the twelfth embodiment. As the period in which the messages are stored, a period such as today, this week, this month, or this year, in which the day delivering the program list is included, can be used. Further, as the period, a period being previous to the delivering day such yesterday, last week, last month, and last year, can be use. Further, the number of messages can be delivered by adding the number of messages in plural periods such as in four days, two weeks, and three months.

Next, referring to the drawings, a fifteenth embodiment of a server and a method delivering the degree of interest in broadcast programs of the present invention is explained. The fifteenth embodiment corresponds to the example (3-2-a) mentioned above. That is, at the fifteenth embodiment, the reference information of messages 10 relating to a program is delivered to users.

FIG. 45 is a block diagram showing a structure of a part of the server delivering the degree of interest in broadcast programs at the fifteenth embodiment of the present invention. As shown in FIG. 45, the server provides a database of message lists 7 and a message list delivering means 11. The database of message lists 7 is the same at the ninth embodiment. The message list delivering means 11 makes a message list of reference information for a designated program or a designated series of programs, by using the database of message lists 7. And the message list delivering means 11 delivers the message list of the reference information to users.

The message list delivering means 11 starts to work, after a program or a series of programs was designated. After the message list delivering means 11 was started, the message list delivering means 11 obtains reference information of a designated program or a designated series of programs from the database of message lists 7. And the message list making means 11 makes a message list of the reference information and delivers the made message list to users. As a delivering function of the message list delivering means 11, an instrument, being capable of transmitting the message list to clients that can display or print the message list, can be used. And the clients display or print the message list to users. Or an external output instrument such as a display and a printer can be used. And the message list delivering means 11 delivers the message list to users when the users designates an arbitrary program, by obtaining the message list of the program from the database of message lists 7. And in case that the message list is delivered to users via the Internet, the message list is transmitted by the HTML format. With this, the usability for the users increases largely.

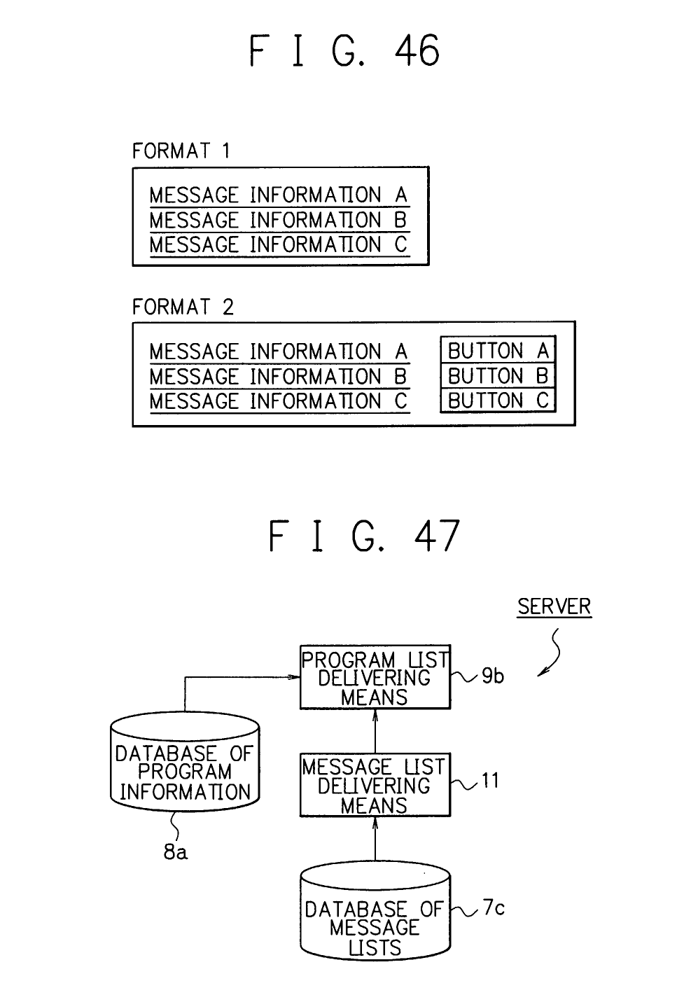

FIG. 46 is a diagram showing formats of message information for programs in the message list at the fifteenth embodiment of the present invention. In FIG. 46, as examples, two formats for the message information are shown. In the format 1, message information A, B, and C is shown sequentially from the top. The message information includes, for example, the title of the message, the supplying date, the name of the supplier (viewer), and the reference information for the program. And it is desirable that a user obtains the message by selecting a character string in the message information from the message list shown in the format 1. In the format 2, in addition to the message information, a button for selecting the message is attached to each message information. In the format 2, a button A is attached to the message information A, a button B is attached to the message information B, and a button C is attached to the message information C. That is, when a user selects a button attached to message information, the message is delivered to the user.

Next, referring to the drawings, a sixteenth embodiment of a server and a method delivering the degree of interest in broadcast programs of the present invention is explained. The sixteenth embodiment corresponds to the example (3-2-b) mentioned above. That is, at the sixteenth embodiment, the reference information of messages 10 relating to a program is delivered to users.

FIG. 47 is a block diagram showing a structure of a part of the server delivering the degree of interest in broadcast programs at the sixteenth embodiment of the present invention. As shown in FIG. 47, the server provides a database of message lists 7c, a database of program information 8a, a program list delivering means 9b, and a message list delivering means 11. The database of message lists 7c stores message lists. The database of program information 8a stores information of programs. The message list delivering means 11 is the same at the fifteenth embodiment. The program list delivering means 9b makes a program list from a message list made at the message list delivering means 11 and the program information from the database of program information 8a. And the program list delivering means 9b delivers the made program list to users.

The program list delivering means 9b starts to work, when the period (from Hs:Ms to He:Me time, Y year, M month, D day) of a program list to be delivered, the region (prefecture, city, a zip coed, or an area code) of the program list to be delivered, or broadcasting stations were designated.

The program list delivering means 9b obtains program information of the designated region or the designated broadcasting stations in the designated period from the database of program information 8a, after the program list delivering means 9b was started. And the program list delivering means 9b makes a program list to be delivered to users by using the obtained program information and the message list from the message list delivering means 11. After this, the program list delivering means 9b delivers the made program list to the users.

As a delivering function of the program list delivering means 9b, an instrument, being capable of transmitting the program list to clients which can display or print the program list, can be used, or an external output instrument such as a display and a printer can be used. And in case that the program list is delivered to users via the Internet, the message list is transmitted by the HTML format. With this, the usability for the users increases largely. The program list at the eleventh embodiment shown in FIG. 40 can be used at the sixteenth embodiment.

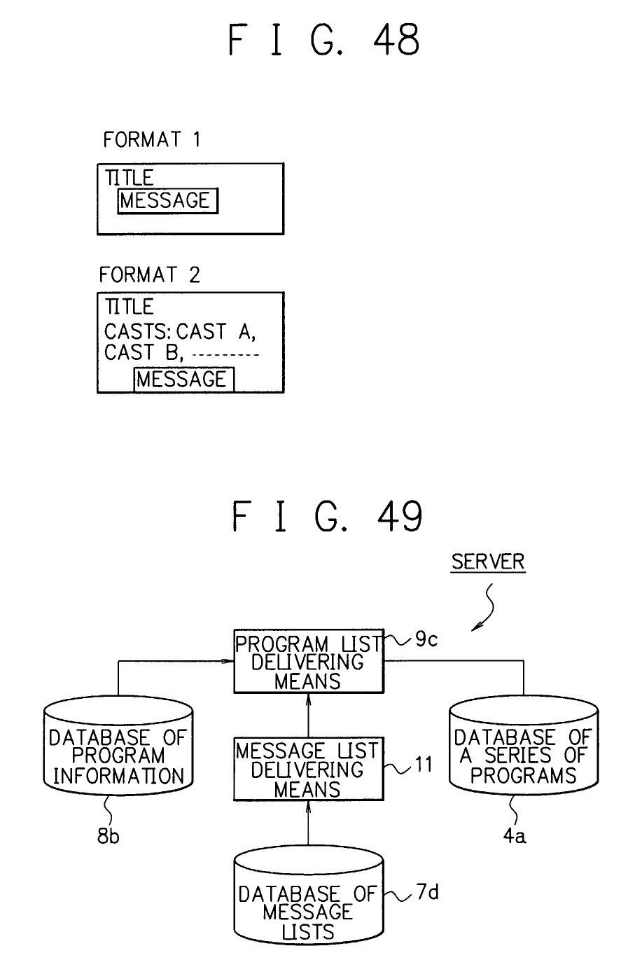

FIG. 48 is a diagram showing formats of program information in a program list formed at the program list delivering means 9b at the sixteenth embodiment of the present invention. In FIG. 48, as examples, two formats for the program information are shown. In the format 1, the title (name of a program) obtained from the database of program information 8a, and a button for displaying a message list for the title, are shown. In the format 2, the title of a program and names of casts (cast A, cast B, . . . ), obtained from the database of program information 8a, and a button for displaying a message list for the title, are shown.

In other words, when a user selects a program by using a button in the program information, the program list delivering means 9b make the message list delivering means 11 start by designating the selected program. The message list delivering means 11 displays the message list shown in FIG. 46 used at the fifteenth embodiment.

Next, referring to the drawings, a seventeenth embodiment of a server and a method delivering the degree of interest in broadcast programs of the present invention is explained. The seventeenth embodiment corresponds to the example (3-2-c) mentioned above. That is, at the seventeenth embodiment, the reference information of messages 10 relating to a program list including a series of programs is delivered to users.

FIG. 49 is a block diagram showing a structure of a part of the server delivering the degree of interest in broadcast programs at the seventeenth embodiment of the present invention. As shown in FIG. 49, the server provides a database of a series of programs 4a, a database of message lists 7d, a database of program information 8b, a program list delivering means 9c, and a message list delivering means 11. The database of a series of programs 4a stores what series of programs a program belongs to, when the program belongs to a series of programs. The database of message lists 7d stores message lists. The database of program information 8b stores information of programs. The message list delivering means 11 is the same at the fifteenth embodiment. The program list delivering means 9c makes a program list from a message list made at the message list delivering means 11 and the program information from the database of program information 8b. And when a program belongs to a series of programs, the program list delivering means 9c makes a program list including information of the series of programs. And the program list delivering means 9c delivers the made program list to users.

Operation of the program list delivering means 9c is explained. The program list delivering means 9c starts to work, when the period (from Hs:Ms to He:Me time, Y year, M month, D day) of a program list to be delivered, the region (prefecture, city, a zip coed, or an area code) of the program list to be delivered, or broadcasting stations are designated.

The program list delivering means 9c obtains program information of the designated region or the designated broadcasting stations in the designated period from the database of program information 8b, after the program list delivering means 9c was started. And the program list delivering means 9c makes a program list to be delivered to users by using the obtained program information and a message list from the message list delivering means 11. And when a program belongs to a series of programs, the program list delivering means 9c makes a program list including information of the series of programs. After this, the program list delivering means 9c delivers the made program list to the users.

As a delivering function of the program list delivering means 9c, an instrument, being capable of transmitting the program list to clients which can display or print the program list, can be used, or an external output instrument such as a display and a printer can be used. And in case that the program list is delivered to a user via the Internet, the program list is transmitted by the HTML format. And the program list is transmitted to the clients from a Web server by the HTTP, and the users obtains the program list by using a Web browser.

The formats of program information in a program list shown in FIG. 48, used at the sixteenth embodiment, can be used at the seventeenth embodiment. Referring to FIG. 48, the formats are explained. In the format 1, the title (name of a program) obtained from the database of program information 8b, and a button for displaying a message list for the title, are shown. In the format 2, the title of a program and names of casts (cast A, cast B, . . . ), obtained from the database of program information 8b , and a button for displaying a message list for the title, are shown.

Operation of the program list delivering means 9c is explained, at the case when a user selects a message list in the program information shown in the one of the formats. When a user selects a program by using a button in the program information, the program list delivering means 9c searches the program selected by the button from the database of a series of programs 4a. In case that the program belongs to a series of programs, the series of programs, to which the program belongs, is designated, and the message list delivering means 11 is started as the same as at the fifteenth embodiment. And the message list delivering means 11 delivers a message list concerning the series of programs including the program. In case that the program does not belong to a series of programs, the program is designated and the message list delivering means 11 is started as the same as at the fifteenth embodiment. And the message list delivering means 11 delivers a message list concerning the program.

The following two modified examples can be used at seventeenth embodiment of the present invention. First, a first modified example of the seventeenth embodiment of the present invention is explained. At the first modified example, in case that the program belongs to a series of programs, a user selects the message list of the program or of the series of programs.

Operation of the program list delivering means 9c at the time when a user selects the message list of the program or of the series of programs is explained. First, when the user selects a button in the program information, the program list delivering means 9c searches the database of a series of programs 4a whether the program selected by the button belongs to a series of programs or not. When the program belongs to a series of program, the program list delivering means 9c delivers information by which the user selects a message list of the program or of the series of programs. When the user selected the message list of the program, the program list delivering means 9c makes the message list delivering means 11 work and makes it deliver the message list of the program mentioned at the fifteenth embodiment. When the user selected the message list of the series of programs, the program list delivering means 9c makes the message list delivering means 11 work and makes it deliver the message list of the series of programs mentioned at the fifteenth embodiment. In this, when the program does not belong to a series of programs, the message list delivering means 11 delivers the message list of the program.

Next, a second modified example of the seventeenth embodiment of the present invention is explained. At the second modified example, before the program list is delivered, the program list delivering means 9c judges whether a program belongs to a series of programs or not. In case that the program belongs to a series of programs, the program list delivering means 9c shows the program information with a button showing the program and a button showing the series of programs, when the program belongs to a series of programs. And the user selects one of the two buttons. And as mentioned above, when the user selected the message list of the program, the program list delivering means 9c makes the message list delivering means 11 work and makes it deliver the message list of the program mentioned at the fifteenth embodiment. When the user selected the message list of the series of programs, the program list delivering means 9c makes the message list delivering means 11 work and makes it deliver the message list of the series of programs mentioned at the fifteenth embodiment.

Next, referring to the drawings, an eighteenth embodiment of a server and a method delivering the degree of interest in broadcast programs of the present invention is explained. The eighteenth embodiment corresponds to the examples (3-3-a) and (3-3-b) mentioned above. That is, at the eighteenth embodiment, the number of messages every period for a program is delivered to users. In this, the period is a period that a designated period is passed from the beginning of the program, and plural periods are provided by having the same time interval.

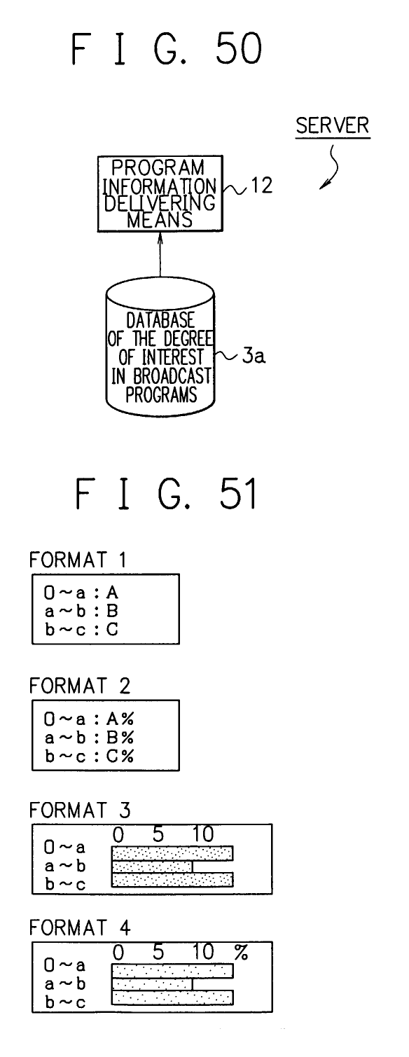

FIG. 50 is a block diagram showing a structure of a part of the server delivering the degree of interest in broadcast programs at the eighteenth embodiment of the present invention. As shown in FIG. 50, the server provides a database of the degree of interest in broadcast programs 3a and a program information delivering means 12. The database of the degree of interest in broadcast programs 3a is the same at the fifth or sixth embodiment, in which the number of messages for each program is stored every designated period. The program information delivering means 12 delivers the number of messages every designated period for each program to users, by using the database of the degree of interest in broadcast programs 3a.

Operation of the program information delivering means 12 is explained. The program information delivering means 12 starts to work when a program was designated. The program information delivering means 12 obtains the number of messages for the program to be delivered every period from the database of the degree of interest in broadcast programs 3a, after the program information delivering means 12 was started. And the program information delivering means 12 makes delivering data by using the obtained data, and delivers the made data to users. As a delivering function of the program information delivering means 12, an instrument, being capable of transmitting the program information to clients which can display the program information, can be used, or an external output instrument such as a display and a printer can be used. And the program information delivering means 12 delivers the program information to the user when the user designates an arbitrary program, is by obtaining the number of messages every designated period from the database of the degree of interest in broadcast programs 3a. And in case that the program information is delivered via the Internet, the program information is made by the HTML format, and transmitted to the clients having a Web browser by the HTTP by using a Web server.

FIG. 51 is a diagram showing formats of program information at the program information delivering means 12 at the eighteenth embodiment of the present invention. Referring to FIG. 51, examples of the program information to be delivered are explained. In FIG. 51, as examples, four formats are shown. In the format 1, each line shows “the starting time of a designated period˜the ending time of the designated period” and “the number of messages in the designated period”. That is, the first line shows that the period is from 0 to a and the number of messages is A, the second line shows that the period is from a to b and the number of messages is B, and the third line shows that the period is from b to c and the number of messages is C. In this, it is desirable that the time is relative time from the program starting time. In the format 2, each line shows “the starting time of a designated period˜the ending time of the designated period” and “the ratio (%) of the number of messages”. In this, the ratio (%) of the number of messages is calculated by that the number of messages for the program in a designated period is divided by the total number of messages for the program in all periods. In the format 3, the number of messages in the format 1 is shown in a histogram (bar graph), and in the format 4, the ratio (%) of the number of messages is shown in a histogram (bar graph).

Next, a modified example of the eighteenth embodiment of the present invention is explained. At this modified example, in the program list being made by the program list delivering means 9c in the seventeenth embodiment, a button to start the program information delivering means 12 can be shown. In this case, when a user selects a program by using the button, the program information delivering means 12 is started, and the program information delivering means 12 delivers the number of messages for the program to the user.

Next, a nineteenth embodiment of a server and a method delivering the degree of interest in broadcast programs of the present invention is explained. The nineteenth embodiment corresponds to the examples (3-3-c) and (3-3-d) mentioned above. That is, at the nineteenth embodiment, both the time passed from the beginning of the program and the number of messages in each designated period are delivered to users.

The server at the nineteenth embodiment provides a database of the degree of interest in broadcast programs 3b and a program information delivering means 12. The database of the degree of interest in broadcast programs 3b is the same at the seventh or eighth embodiment, in which the number of messages for each program is stored every designated period. The program information delivering means 12 delivers the number of messages for each program every designated period to users, by using the database of the degree of interest in broadcast programs 3b. That is, the nineteenth embodiment is the same as the eighteenth embodiment except the database of the degree of interest in broadcast programs 3b is used at the nineteenth embodiment.

Operation of the program information delivering means 12 is explained. The program information delivering means 12 starts to work when a program and a period when messages for the program are stored were designated. The program information delivering means 12 obtains the number of messages for the program to be delivered every period and the time passed from the beginning of the program from the database of the degree of interest in broadcast programs 3b, after the program information delivering means 12 was started. And the program information delivering means 12 makes delivering data by using the obtained data, and delivers the made data to users. As a delivering function of the program information delivering means 12, an instrument, being capable of transmitting the program information to clients which can display or print the program information, can be used, or an external output instrument such as a display and a printer can be used. And the program information delivering means 12 delivers the program information to the user when the user designates an arbitrary program, by obtaining the number of messages every designated period from the database of the degree of interest in broadcast programs 3b. And in case that the program information is delivered via the Internet, the program information is made by the HTML format, and transmitted to the clients having a Web browser by the HTTP by using a Web server.

As the formats for delivering the data, the same formats used at the eighteenth embodiment shown in FIG. 51 can be used at the nineteenth embodiment. As the period in which the messages are stored, a period such as today, this week, this month, or this year, in which the day delivering the program information is included, can be used. Further, as the period, a period being previous to the delivering day such yesterday, last week, last month, and last year, can be use. With this, the usability for the users increases largely. Further, the number of messages can be delivered by adding the number of messages in plural periods such as in four days, two weeks, and three months.

Next, a modified example of the nineteenth embodiment of the present invention is explained. At this modified example, in the program list being made by the program list delivering means 9c in the seventeenth embodiment, a button to start the program information delivering means 12 can be shown. In this case, when a user selects a program by using the button, the program information delivering means 12 is started, and the program information delivering means 12 delivers the number of messages every designated period for the program, stored in a designated period, to the user.

As the period in which the messages are stored, a period such as today, this week, this month, or this year, in which the day delivering the program information is included, can be used. Further, as the period, a period being previous to the delivering day such yesterday, last week, last month, and last year, can be use. And also, the users can select the period when the messages were stored.

Next, referring to the drawings, a twentieth embodiment of a server and a method delivering the degree of interest in broadcast programs of the present invention is explained. The twentieth embodiment corresponds to the example (3-4-a) mentioned above. That is, at the twentieth embodiment, the message list including reference information for the program is delivered every interval after a designated interval passed from the beginning of the program, in other words, the message list is delivered every scene of the program.

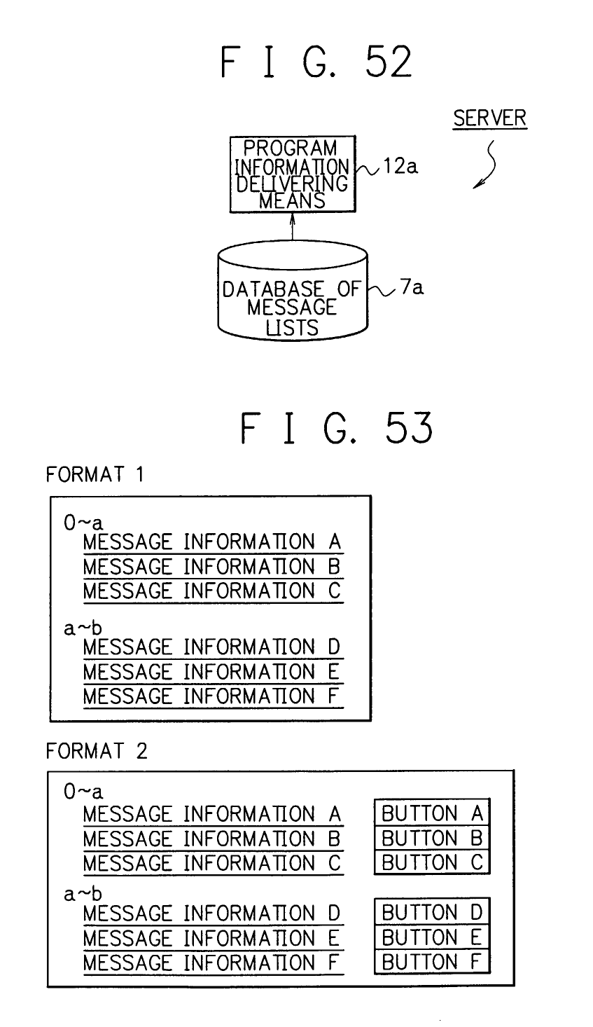

FIG. 52 is a block diagram showing a structure of a part of the server delivering the degree of interest in broadcast programs at the twentieth embodiment of the present invention. As shown in FIG. 52, the server provides a database of message lists 7a and a program information delivering means 12a. The database of message lists 7a is the same at the tenth embodiment, in which reference information of messages 10 for each program is stored. The program information delivering means 12a delivers the message list including the reference information for the program every scene of the program.

Operation of the program information delivering means 12a is explained. The program information delivering means 12a starts to work when a program was designated. The program information delivering means 12a obtains the message list every scene for the program from the database of message lists 7a, after the program information delivering means 12a was started. And the program information delivering means 12a makes delivering data by using the obtained data, and delivers the made data to users. As a delivering function of the program information delivering means 12a, an instrument, being capable of transmitting the program information to clients which can display or print the program information, can be used, or an external output instrument such as a display and a printer can be used. When a user selects one of message information from the shown message information, this selection is inputted to a message displaying means (not shown). The message displaying means obtains this message and displays the obtained message. In case that the program information is delivered via the Internet, the program information is made by the HTML format, and transmitted to the clients having a Web browser by the HTTP by using a Web server.

FIG. 53 is a diagram showing formats of program information at the program information delivering means 12a at the twentieth embodiment of the present invention. In FIG. 53, as examples, two formats are shown. In the format 1, message information A, B, and C is shown sequentially from the top in the period from 0 to a, and message information D, E, and F is shown sequentially from the top in the period from a to b. As the message information, there are, for example, the title of the message, the supplying date, the name of the supplier (viewer), and the reference information. And when a user selects a character string in message information, the selected message information is delivered to the user. In the format 2, in addition to the message information, a button for selecting the message information is attached to each message information. And when a user selects a button attached to message information, the selected message information is delivered to the user.

Next, a modified example of the twentieth embodiment is explained. At this modified example, further an additional button for starting the program information delivering means 12a can be attached in the program information. By pushing this button, a program is designated and the program information delivering means 12a is started.

Next, referring to the drawings, a twenty-first embodiment of a server and a method delivering the degree of interest in broadcast programs of the present invention is explained. The twenty-first embodiment also corresponds to the example (3-4-a) mentioned above. That is, at the twenty-first embodiment, the message list including reference information for the program is delivered every interval after a designated interval passed from the beginning of the program, in other words, the message list is delivered every scene of the program.

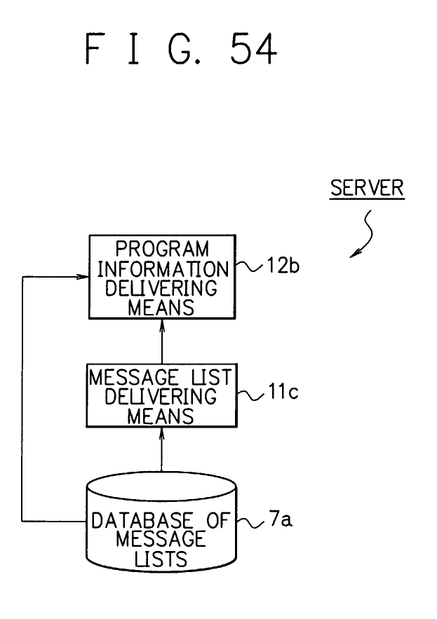

FIG. 54 is a block diagram showing a structure of a part of the server delivering the degree of interest in broadcast programs at the twenty-first embodiment of the present invention. As shown in FIG. 54, the server provides a database of message lists 7a, a message list delivering means 11c, and a program information delivering means 12b. The database of message lists 7a is the same at the tenth embodiment, in which reference information of messages 10 for each program is stored. The message list delivering means 11c delivers a message list of scenes of the program by obtaining from the database of message lists 7a. The program information delivering means 12b makes the message list delivering means 11c deliver the message list.

Operation of the program information delivering means 12b is explained. The program information delivering means 12b starts to work when a program was designated. The program information delivering means 12b makes a screen from which a user selects a message list to be displayed, and displays the message list. When the user selects a scene from the screen, the program information delivering means 12b makes the message list delivering means 11c start by designating the program and the scene. As a displaying function of the program information delivering means 12b, an external output instrument such as a display can be used. Or the program information delivering means 12b forms the screen as data being transmitted to clients. And in case that a list of scenes is delivered to users via the Internet, link information, in which a program and scenes are stored, is formed by the HTML format. And the link information is transmitted to the clients from a Web server by the HTTP, and the users obtains the link information by using a Web browser.

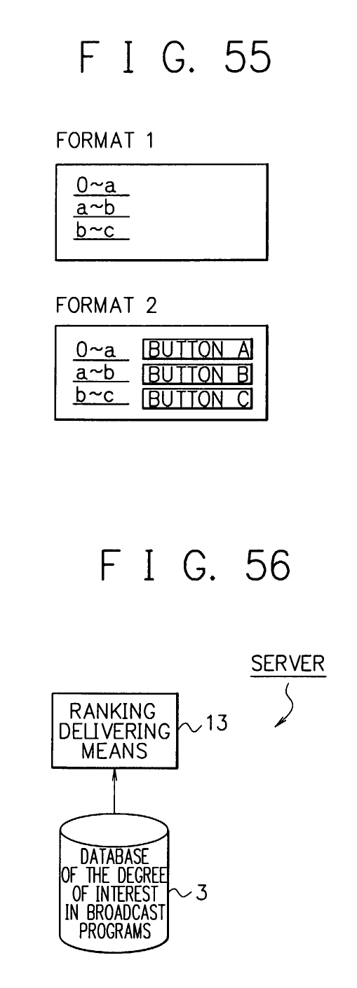

FIG. 55 is a diagram showing formats of link information at the program information delivering means 12b at the twenty-first embodiment of the present invention. Referring to FIG. 55, examples of the link information are explained. In FIG. 55, as examples, two formats are shown. In the format 1, each line shows a period, that is, the first line shows a period from 0 to a, the second line shows a period from a to b, and the third line shows a period from b to c. In the format 2, in addition to the periods shown in the format 1, each line has a button for selecting a period by a user. That is, when the user selects, for example, the button A, the message list in the period from 0 to a is displayed.

Operation of the message list delivering means 11c is explained. The message list delivering means 11c starts to work, when a program and a designated interval (scene) in the broadcasting time of the program are designated. The message list delivering means 11c obtains the program and the reference information for the program in the scene from the database of message lists 7a, after starting. And the message list delivering means 11c delivers the obtained reference information as message information to users. For example, the reference information is displayed on an external output instrument such as a display, or is formed to be data that can be transmitted to the users.

When a user selects one of link information from the shown link information, this selection is inputted to a message displaying means (not shown). The message displaying means obtains this message and displays the obtained message. In case that the link information is delivered via the Internet, the link information is made by the HTML format, and transmitted to the clients having a Web browser by the HTTP by using a Web server.

Next, a first modified example of the twenty-first embodiment is explained. At this first modified example, in case that the twenty-first embodiment uses the database of the degree of interest in broadcast programs 3a, in which the number of messages for a program is stored every scene, used at the fifth or sixth embodiment, the number messages every scene can be obtained. And the number of messages every scene is shown in the formats shown in FIG. 51 as the same as at the eighteenth embodiment. When a user selects a period in one of the formats, the message list in the period is shown.

Next, a second modified example of the twenty-first embodiment is explained. At the second modified example, in case that the twenty-first embodiment uses the program list delivering means 9, the program list delivering means 9 displays a button for making to start the program information delivering means 12b in the program information of the program list. That is, when a user selects program information in the program list, the program is designated and the program information delivering means 12b is started.

Next, referring to the drawings, a twenty-second embodiment of a server and a method delivering the degree of interest in broadcast programs of the present invention is explained. The twenty-second embodiment corresponds to the example (3-5-a) mentioned above. That is, at the twenty-second embodiment, programs are delivered to users in the order that their number of messages is large.

FIG. 56 is a block diagram showing a structure of a part of the server delivering the degree of interest in broadcast programs at the twenty-second embodiment of the present invention. As shown in FIG. 56, the server provides a database of the degree of interest in broadcast programs 3 and a ranking delivering means 13. The database of the degree of interest in broadcast programs 3 is the same at the first, second, third, and fourth embodiments. The ranking delivering means 13 deliveries the ranking of programs to users, by using the data in the database of the degree of interest in broadcast programs 3.

Operation of the ranking delivering means 13 is explained. The ranking delivering means 13 compares the number of messages for programs storing in the database of the degree of interest in broadcast programs 3, and delivers program information such as the program tag and other program information of a program in the order that their number of messages is large.

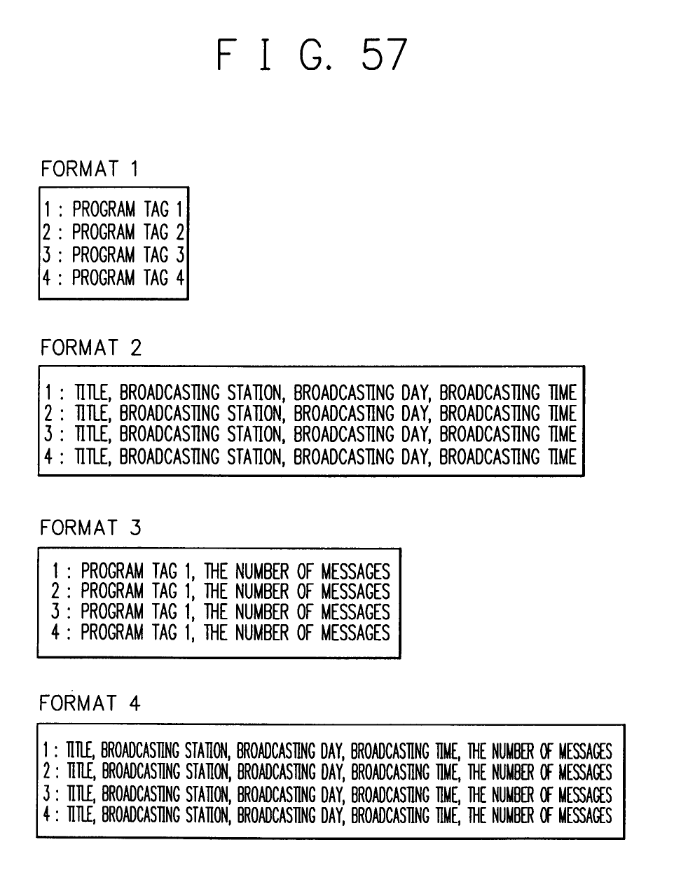

FIG. 57 is a diagram showing formats of ranking information at the ranking delivering means 13 at the twenty-second embodiment of the present invention. Referring to FIG. 57, examples of the ranking information are explained. In FIG. 57, as examples, four formats are shown. In the format 1, the ranking number and its program tag are shown in the order that the number of messages for the program tag is large. That is, in the first line, the ranking number 1 and its program tag 1 are shown. In case that the number of messages for program tags is the same, the same ranking number is used for the program tags. In the format 2, instead of the program tag, the title, the broadcasting station, the broadcasting day, and the broadcasting time of the program are shown. In the format 3, in addition to the format 1, the number of messages for the program is attached. And in the format 4, in addition to the format 2, the number of messages for the program is attached.

At the twenty-second embodiment, there are three modified examples. At a first modified example, in case that the number of messages for both of a program and a series of programs is stored in the database of the degree of interest in broadcast programs 3, only the number of messages for the program is used.

At a second modified example, in case that the number of messages for both of a program and a series of programs is stored in the database of the degree of interest in broadcast programs 3, only the number of messages for the series of programs is used.

At a third modified example, in case that the twenty-second embodiment uses the message list delivering means 11 used at the fifteenth embodiment, a user selects a program from the ranking information at the ranking delivering means 13, and the message list delivering means 11 delivers the message list of the program to the user.

Further, there are two examples applied the twenty-second embodiment. As a first example, in case that the ranking information at the ranking delivering means 13 shows program tags, a user can reserve to record the program or to watch the recorded program, by using one of the program tags. As a second example, by making a user select a program from the ranking information at the ranking delivering means 13, the user can obtain detailed information of this program.

Next, a twenty-third embodiment of a server and a method delivering the degree of interest in broadcast programs of the present invention is explained. The twenty-third embodiment corresponds to the example (3-5-b) mentioned above. That is, at the twenty-third embodiment, programs are delivered to users in the order that their number of messages is large, but the number of messages for the programs is stored every designated period. Therefore, at the twenty-third embodiment, the database of the degree of interest in broadcast programs 3b, used at the seventh and eighth embodiments, is used. Except this, the twenty-third embodiment is the same as the twenty-second embodiment.

That is, the operation of the ranking delivering means 13 is the same as at the twenty-second embodiment, except the following operation. First, at the time when the number of messages for programs is compared, a period when messages were stored is designated. Second, the number of messages is obtained from the database of the degree of interest in broadcast programs 3b, by designating a period.

Next, a twenty-fourth embodiment of a server and a method delivering the degree of interest in broadcast programs of the present invention is explained. The twenty-fourth embodiment corresponds to the example (3-6-a) mentioned above. That is, at the twenty-fourth embodiment, scenes of a program are delivered to users in the order that their number of messages for the scenes is large, in this, the scene signifies a scene at every designated interval of a program. Therefore, at the twenty-fourth embodiment, the database of the degree of interest in broadcast programs 3a, used at the fifth and sixth embodiments, is used. Except this, the twenty-fourth embodiment is the same as the twenty-second embodiment.

That is, the operation of the ranking delivering means 13 is the same as at the twenty-second embodiment, except the following operation. At the time when the number of messages is counted, the messages are counted every scene (designated interval) of a program in a designated period.

Next, a twenty-fifth embodiment of a server and a method delivering the degree of interest in broadcast programs of the present invention is explained. The twenty-fifth embodiment corresponds to the example (3-6-b) mentioned above. That is, at the twenty-fifth embodiment, scenes of a program are delivered to users in the order that their number of messages for the scenes is large, but the number of messages stored in a designated period is used. Therefore, at the twenty-fifth embodiment, the database of the degree of interest in broadcast programs 3b, used at the seventh and eighth embodiments, is used. Except this, the twenty-fifth embodiment is the same as the twenty-second embodiment.

That is, the operation of the ranking delivering means 13 is the same as at the twenty-second embodiment, except the following operation. The number of messages is counted, base on the messages that were supplied from viewers every designated period.

As the period in which the messages are stored, a period such as today, this week, this month, or this year, in which the day delivering the program information is included, can be used. Further, as the period, a period being previous to the delivering day such yesterday, last week, last month, and last year, can be use. With this, the usability for the users increases largely. Further, the number of messages can be delivered by adding the number of messages in plural periods such as in four days, two weeks, and three months.

Message supplying methods at the present invention are explained in more detail. As the message supplying methods at the embodiments of the present invention, there are a method that messages are directly supplied to a server of the present invention from viewers, and a method that the messages are supplied to the server via the Internet by using a Web page or a BBS. In case that the Internet is used, a structure of a search engine used generally can be used. That is, messages are collected by similar operation of a current search engine that obtains data from Web sites. The server of the present invention collects the messages for programs by searching Web sites directly. Or the server gives a designated search condition to current search engines and extracts messages from the searched result by using the current search engines.

In case that a BBS is used for collecting messages for programs, the address of the BBS is registered beforehand and viewers supplies the messages to the BBS, and the server refers to the messages in the BBS automatically or manually. Or plural servers having the same function as the server delivering the degree of interest in broadcast programs has are provided, and messages in the plural servers are used commonly. In this case, each server accesses to other servers at a designated time or a designated interval and obtains the messages.

Message counting methods at the present invention are explained in more detail. At the first, second, and fifth embodiments, first, messages were stored in the message storing means 2, and the messages were processed later. At the third, fourth, and sixth embodiments, first, messages were processed, and the processed messages were stored in the message storing means 2 later. At the former case, the time when the messages were processed previously is recorded, and messages supplied after this time are processed and the number of messages counted at this time is added to the number of messages in the database of the degree of interest in broadcast programs. In this case, the messages are processed at each time, therefore its processing time at each time can be shortened.

Message managing methods every supplied period are explained in more detail. A first modified example is explained. At the embodiments of the present invention, the number of messages is managed every designated period. As this designated period, plural periods such as one day, one week, and one month are set, and data in these plural periods are stored and managed. With this, a user can select one of the plural periods, and more detailed information can be delivered to the user.

A second modified example is explained. At the embodiments of the present invention, all of the messages in the designated period are stored, however, some old data can be discarded. For example, the newest data such as on today and this week and the previous data such as on yesterday and last week are stored, and the older data than these are discarded. With this, a function to reduce the capacity of the message storing means 2 can be given to users who are not interested in the old data.

A third modified example is explained. As mentioned above, at the first, second, and fifth embodiments, messages were stored in the message storing means 2, and the messages were processed later. And at the third, fourth, and sixth embodiments, messages were processed, and the processed messages were stored in the message storing means 2 later. At the former case, messages being counted can be limited to the messages supplied in the newest several days, several weeks, or several months. With this, a function to reduce the number of messages being counted can be given to users who are not interested in the old data, and its processing time can be reduced.

A fourth modified example is explained. Messages supplied for the first week are kept every one day, and data for the one week are gathered after one week passed. For example, by gathering the data from Monday to Sunday, the data for one week are made at the end on the Sunday, and the made data are stored as one week data. That is, after data are stored for a period, the stored data are gathered as the data for a longer period. Data in this week are kept every one day, but the data being previous week, month, or year are gathered in one week unit, one month unit, or one year unit. In this case, some old data can be discarded. With this, the newest data are kept in a detailed state, and the old data are stored in a minimum requirement state. Therefore, the capacity of the message storing means 2 can be reduced.

A fifth modified example is explained. In the first, second, and fifth embodiments, the messages were stored first, and the messages were processed later, at the fourth modified example, the messages storing in the message storing means 2 can be processed in one day unit, one week unit, or one month unit depending on respective message supplying periods.

A modified message supplying period for making a message list is explained. At the embodiments of the present invention, messages are managed every message supplying period. However, the messages can be managed for a specified message supplying period. With this, a message list by using messages supplied for a specified period can be made.

A case that one program is broadcast at different plural regions and (at different time) is explained. In this case, messages for the program from the different regions are handled as the messages for the program, by recognizing the program is the same. In order to realize this, a region conversion database is further provided. The correspondence among program tags of the same programs in the different regions is described in this region conversion database. With this, when the number of messages for the program is counted, by using the region conversion database, the number of messages for the same program can be counted up, and the number of messages can be registered in the message list.

In case that the same program is broadcast by plural broadcasting stations, the same program can be handled as one program. That is, the same program can be handles every region, or can be handled as one program by making a key broadcasting station be a representative. However, in case that the program is handled by only the key broadcasting station, when the number of messages for the program and the message list for the program are delivered, the number of messages and the message list are made by gathering all data from regional broadcast stations by using a region conversion database. With this, the degree of interest in the program in all regions can be obtained, and in each region can be also obtained. And the reaction from viewers for the program can be obtained easily.

A case that a program is broadcast plural times is explained. At the embodiments mentioned above, in case that a program is broadcast plural times, that is, a program is rebroadcast, the program can be handled as one program. That is, when the same program is broadcast plural times, the messages for the program are counted for the program by recognizing plural broadcast times. In this case, this operation can be realized easily by using a broadcast database. In the broadcast database, program tags of the plural broadcasts are described, that is, correspondence among the program tags of the plural broadcasts is described in the broadcast database. With this, the number of messages for the program can be counted by using the broadcast database, and the message list can be registered by using the broadcast database.

Further, the same program can be handled as one program every broadcast, or can be handled as one program by making only the main broadcast a representative, not including the rebroadcast. When only the main broadcast is used, the number of messages for the program and the message list are made by searching the one for the main broadcast in the broadcast database, or are made by searching the one for the plural broadcasts in the broadcast database. With this, the degree of interest in the program can be obtained for the main broadcast or for the plural broadcasts. And the reaction from viewers for the program can be obtained easily.

At the embodiments mentioned above, the degree of interest in a broadcast program is shown by that the number of messages for the program is simply added, however, its calculation is not limited to only the addition of the number of messages. For example, weighting is applied to each message corresponding to the amount of data in each message, and the degree of interest in the broadcast program can be calculated by the weighted results. Or the weighting is applied to the time difference between the broadcast time and message supplied time, and the degree of interest in the broadcast program can be calculated by using the weighted results. That is, the degree of interest in broadcast programs can be calculated by an arbitrary calculation format by deciding a calculation rule and a calculation equation.

As mentioned above, a rating of a broadcast program is calculated at the time when the program is broadcasting. However, the degree of interest in a program can be calculated even before the program is broadcast by that viewers supply messages for the program by referring to a general program list. Therefore, the degree of interest in broadcast programs at the present invention can be used effectively.

As mentioned above, the server delivering the degree of interest in broadcast programs of the present invention provides a message storing means for storing messages supplied from viewers, a database of the degree of interest in broadcast programs for storing the number of messages for each program, and a message counting means for counting the number of messages for each program by taking out the messages from the message storing means by using the program tag in the messages and for storing the counted number of messages for each program in the database of the degree of interest in broadcast programs.

In order to meet a case that a program belongs to a series of programs, the server delivering the degree of interest in broadcast programs of the present invention further provides a database of a series of programs. The message counting means judges whether the program belongs to a series of programs or not by using the database of a series of programs, and when a program belongs to a series of programs, the message counting means counts the message for the program and also the message for the series of programs. And the message counting means stores the number of counted messages for both the program and for the series of programs in the database of the degree of interest in broadcast programs.

In case that a program is divided into many parts by setting a designated interval, the number of messages every designated interval (scene) for the program are stored in the database of the degree of interest in broadcast programs. In this case, the message counting means counts the number of messages every scene of the program, and stores the number of counted messages every scene of the program in the database of the degree of interest in broadcast programs.

In case that a period when the messages are counted is designated, the message counting means counts the number of messages for each program supplied every designated period, and stores the number of counted messages for each program every designated period in the database of the degree of interest in broadcast programs.

The server delivering the degree of interest in broadcast programs of the present invention provides a message storing means for storing messages for programs, a database of the degree of interest in broadcast programs for storing the number of messages for each program, and a message classifying means for classifying the messages into messages for each program when the messages are supplied from viewers and for counting the number of messages for each program based on the classified result and storing the number of counted messages for each program in the database of the degree of interest in broadcast programs when the program tag of the message matches with the program tag in the database of the degree of interest in broadcast programs. Further the message classifying means stores the counted up messages in the message storing means.

In order to meet a case that a program belongs to a series of programs, the server delivering the degree of interest in broadcast programs of the present invention further provides a database of a series of programs. The message classifying means judges whether the program belongs to a series of programs or not by using the database of a series of programs, and when a program belongs to a series of programs, the message classifying means counts up the number of messages for both each program and each series of programs in the database of the degree of interest in broadcast programs when the program tag of the message matches with the program tag in the database of the degree of interest in broadcast programs. Further the message classifying means stores the counted up messages in the message storing means.

In case that a program is divided into many parts by setting a designated interval, the number of messages every designated interval (scene) for the program are stored in the database of the degree of interest in broadcast programs. In this case, the message classifying means counts up the number of messages every scene in the database of the degree of interest in broadcast programs when the program tag of the message for the scene matches with the program tag in the database of the degree of interest in broadcast programs. Further the message classifying means stores the counted up messages in the message storing means.

The database of the degree of interest in broadcast programs stores the number of messages every period when the messages are supplied, by using the message classifying means.

In case that plural program tags relating to one program or one series of programs are included in one message, the message counting means counts the plural program tags as one program tag.

And also in case that plural program tags relating to one program or one series of programs are included in one message, the message classifying means counts the plural program tags as one program tag.

The program tag has a structure to show that a message is for a program or for a series of programs, and the message counting means counts the message having this program tag as a message for a series of programs, when the program belongs to a series of programs.

The program tag has a structure to show that a message is for a program or for a series of programs, and the message classifying means counts the message having this program tag as a message for a series of programs, when the program belongs to a series of programs.

The server delivering the degree of interest in broadcast programs of the present invention further provides a database of message lists for storing information including reference information for each program, and a message list making means, which obtains messages for each program from the message storing means and makes a message list including reference information for each program and stores the message list for each program in the database of message lists.

In case that a program belongs to a series of programs, the message list making means makes a message list including reference information for the series of programs, and stores the message list for the series of programs in the database of message lists.

In case that the messages for each program are counted every designated period, the message list making means makes the message list including reference information for each program every designated period and stores the made message list in the database of message lists.

The server delivering the degree of interest in broadcast programs of the present invention further provides a database of program information for storing information of programs and a program list making means. The program list making means makes a program list, in which programs and the number of messages for each of the programs are included, based on information from the database of program information and the database of the degree of interest in broadcast programs.

In case that a program belongs to a series of programs, the program list making means makes a program list, in which programs and the number of messages for a series of programs are included, based on information from the database of program information, the database of the degree of interest in broadcast programs, and the database of a series of programs.

Further, in case that a program belongs to a series of programs, the program list making means makes a program list, in which programs and the number of messages for each program and also for each of the series of programs are included.

In case that the number of messages is counted every designated period, or the number of messages for scenes of programs is counted every designated period, the program list making means makes a program list, in which programs and the number of messages every designated period for each of the programs or the number of message for scenes of each of the programs every designated period are included.

In case that the number of messages is counted every designated period, or the number of messages for scenes of programs is counted every designated period, and a program belongs to a series of programs, the program list making means makes a program list, in which programs and the number of messages every designated period for each of the programs or the number of message for scenes of each of the programs every designated period are included, further in which a series of programs and the number of messages every designated period for each of the series of the programs or the number of message for scenes of each of the series of the programs every designated period are included.

The message list making means makes a message list including reference information for a designated program or a designated series of programs, when the program or the series of programs is designated.

The program list making means makes a program list for designated programs or a designated series of programs, when the programs or the series of programs is designated, based on the information from the database of program information and the database of message lists.

The server delivering the degree of interest in broadcast programs of the present invention further provides a ranking delivering means for delivering ranking information of programs by making the ranking information based on the information from the database of the degree of interest in broadcast programs, in which the number of message for each program is stored.

In case that a program belongs to a series of programs, and the database of the degree of interest in broadcast programs stores the number of message for each program and also for each of the series of programs, the ranking delivering means delivers ranking information made by only the number of messages for each program.

In case that a program belongs to a series of programs, and the database of the degree of interest in broadcast programs stores the number of message for each program and also for each of the series of programs, the ranking delivering means delivers ranking information made by only the number of messages for each of the series of programs.

In case that the number of message for each program is counted every designated period, or the number of messages for a scene of each program is counted every designated period, the ranking delivering means delivers ranking information for programs or for scenes of the programs by making the ranking information every designated period.

In case that the number of message for each scene (designated interval) of a program is counted, the ranking delivering means delivers ranking information by making the ranking information for scenes of programs.

The messages for programs are supplied from viewers to the server delivering the degree of interest in broadcast programs of the present invention via the Internet.

The server delivering the degree of interest in broadcast programs of the present invention further provides a message obtaining means for obtaining messages from Web sites, chats, or bulletin boards in the Internet.

The server delivering the degree of interest in broadcast programs of the present invention further provides a message limiting means that limits messages to be counted to messages being not counted, by keeping the time when messages were counted previously at the message counting means.

The server delivering the degree of interest in broadcast programs of the present invention manages messages every designated period, for example, one day, one week, one month.

The server delivering the degree of interest in broadcast programs of the present invention further provides a message discarding means for making the message storing means discard older messages than a designated time.

The server delivering the degree of interest in broadcast programs of the present invention further provides a message selecting means for selecting messages to be counted from one of the designated periods.

The server delivering the degree of interest in broadcast programs of the present invention manages messages every designated period, for example, a 1^{st} period from the present to the 1^{st} time, a Nth period from the present to the Nth time (N is an integer being two or more), and the N-−1^{st} period is shorter than the Nth period.

The server delivering the degree of interest in broadcast programs of the present invention manages the message lists every period when the messages were supplied.

The server delivering the degree of interest in broadcast programs of the present invention delivers the program list from the program list delivering means, the message list from the message list delivering means, the program information from the program information delivering means, and the ranking information from the ranking delivering means to clients (users).

Each of the clients provides a program list showing means for showing a program list to users by obtaining the program list from the program list delivering means in the server delivering the degree of interest in broadcast programs of the present invention.

Each of the clients further provides a program list selecting means, which makes a user select one program list from program lists for programs and for a series of programs, in case that a program belongs to a series of programs.

The program list selecting means provides buttons on the program list selecting means, by which a user selects either a program list for programs or for a series of programs, in case that a program belongs to a series of programs.

Each of the clients further provides a program information showing means, which obtains the number of messages for programs every designated period from the database of the degree of interest in broadcast programs in the server delivering the degree of interest in broadcast programs of the present invention, and shows the obtained number of messages to users.

The program information showing means obtains reference information for programs from the database of message lists in the server delivering the degree of interest in broadcast programs of the present invention, and shows users the obtained reference information for the programs.

The program information showing means obtains reference information for scenes (designated interval) of programs from the database of message lists in the server delivering the degree of interest in broadcast programs of the present invention, and shows users the obtained reference information for the programs.

Each of the clients further provides a message list showing means, which obtains the number of messages for a scene of a program every designated period and shows the obtained number of messages to users.

The program list delivering means in the server delivering the degree of interest in broadcast programs of the present invention shows tools to make the program information showing means in the clients work, on the program list delivering means.

Each of the clients further provides a ranking showing means, which shows ranking information to users, by obtaining the ranking information from the server delivering the degree of interest in broadcast programs of the present invention, and a ranking program selecting means, by which a user selects one from the ranking information. The ranking showing means obtains a message list for the selected program from the server delivering the degree of interest in broadcast programs of the present invention, and shows the program to the user.

The ranking showing means obtains program tags from the server delivering the degree of interest in broadcast programs of the present invention, and shows the program tags to users as the ranking information.

Each of the clients further provides a ranking program selecting means, by which a user selects a program in the ranking information shown by the ranking showing means. The ranking showing means shows detailed information of a program selected by the ranking program selecting means to the user, by obtaining the detailed information of the program from the server delivering the degree of interest in broadcast programs of the present invention.

As mentioned above, the method delivering the degree of interest in broadcast programs of the present invention provides the steps of; storing messages supplied from viewers, counting the number of messages for each program by taking out the stored messages by using the program tag in the messages, and storing the counted number of messages for each program in a database of the degree of interest in broadcast programs.

In order to meet a case that a program belongs to a series of programs, the method delivering the degree of interest in broadcast programs of the present invention further provides the steps of; judging whether a program belongs to a series of programs or not by using a database of a series of programs in which relation between a program and a series of programs is stored, counting the message for a program and also for a series of programs when the program belongs to the series of programs, and storing the number of counted messages for both the program and for the series of programs in the database of the degree of interest in broadcast programs.

In case that a program is divided into many parts by setting a designated interval, the method delivering the degree of interest in broadcast programs of the present invention further provides the steps of; counting the number of messages every scene (designated interval) of the program, and storing the number of counted messages every scene of the program in the database of the degree of interest in broadcast programs.

In case that a period when the messages are counted is designated, the method delivering the degree of interest in broadcast programs of the present invention further provides the steps of; counting the number of messages for each program supplied every designated period, and storing the number of counted messages for each program every designated period in the database of the degree of interest in broadcast programs.

The method delivering the degree of interest in broadcast programs of the present invention provides the steps of; classifying the messages into messages for each program when the messages are supplied from viewers, and counting up the number of messages for each program in the database of the degree of interest in broadcast programs when the program tag of the message matches with the program tag in the database of the degree of interest in broadcast programs, and storing the counted up messages.

In order to meet a case that a program belongs to a series of programs, the method delivering the degree of interest in broadcast programs of the present invention further provides the steps of; judging whether a program belongs to a series of programs or not by using a database of a series of programs in which relation between a program and a series of programs is stored by using the classified result, counting up the number of messages for a program and also for a series of programs in the database of the degree of interest in broadcast programs when the program belongs to the series of programs, and storing the counted up messages.

In case that a program is divided into many parts by setting a designated interval, the method delivering the degree of interest in broadcast programs of the present invention further provides the steps of; counting up the number of messages every scene (designated interval) of the program in the database of the degree of interest in broadcast programs when the program tag of the message for the scene matches with the program tag in the database of the degree of interest in broadcast programs, and storing the counted up messages.

In case that a period when the messages are counted is designated, the method delivering the degree of interest in broadcast programs of the present invention further provides the steps of; counting up the number of messages for each program supplied every designated period in the database of the degree of interest in broadcast programs, and storing the counted up messages.

In case that plural program tags relating to one program or one series of programs are included in one message, the message is counted as one message, at the method delivering the degree of interest in broadcast programs of the present invention.

And also in case that plural program tags relating to one program or one series of programs are included in one message, the message is counted up as one message, at the method delivering the degree of interest in broadcast programs of the present invention.

The program tag has a structure to show that a message is for a program or for a series of programs, and when a program belongs to a series of programs, a message having this program tag is counted as a message for a series of programs, at the method delivering the degree of interest in broadcast programs of the present invention.

The program tag has a structure to show that a message is for a program or for a series of programs, and when a program belongs to a series of programs, a message having this program tag is counted up as a message for a series of programs, at the method delivering the degree of interest in broadcast programs of the present invention.

The method delivering the degree of interest in broadcast programs of the present invention further provides the step of; obtaining messages including reference information for each program supplied from viewers, making a message list including reference information for each program, and storing the message list in a database of message lists.

In case that a program belongs to a series of programs, the method delivering the degree of interest in broadcast programs of the present invention further provides the steps of; making a message list including reference information for the series of programs, and storing the message list for the series of programs in the database of message lists.

In case that the messages for each program are counted every designated period, the method delivering the degree of interest in broadcast programs of the present invention further provides the steps of; making a message list including reference information for each program every designated period, and storing the made message list in the database of message lists.

The method delivering the degree of interest in broadcast programs of the present invention further provides the step of; making a program list, in which programs and the number of messages for each of the programs are included, based on information from a database of program information in which information of programs is stored and information from the database of the degree of interest in broadcast programs.

In case that a program belongs to a series of programs, the method delivering the degree of interest in broadcast programs of the present invention further provides the step of; making a program list, in which programs and the number of messages for a series of programs are included, based on information from the database of program information, the database of the degree of interest in broadcast programs, and the database of a series of programs.

Further, in case that a program belongs to a series of programs, the method delivering the degree of interest in broadcast programs of the present invention further provides the step of; making a program list, in which programs and the number of messages for each program and also for each of the series of programs are included.

In case that the number of messages is counted every designated period, or the number of messages for scenes of programs is counted every designated period, the method delivering the degree of interest in broadcast programs of the present invention further provides the step of; making a program list, in which programs and the number of messages every designated period for each of the programs or the number of message for scenes of each of the programs every designated period are included.

In case that the number of messages is counted every designated period, or the number of messages for scenes of programs is counted every designated period, and a program belongs to a series of programs, the method delivering the degree of interest in broadcast programs of the present invention further provides the step of; making a program list, in which programs and the number of messages every designated period for each of the programs or the number of message for scenes of each of the programs every designated period are included, further in which a series of programs and the number of messages every designated period for each of the series of the programs or the number of message for scenes of each of the series of the programs every designated period are included.

The method delivering the degree of interest in broadcast programs of the present invention further provides the step of; making a message list including reference information for a designated program or a designated series of programs, when the program or the series of programs is designated.

The method delivering the degree of interest in broadcast programs of the present invention further provides the step of; making a program list for designated programs or a designated series of programs, when the programs or the series of programs is designated, based on the information from the database of program information and from the database of message lists.

The method delivering the degree of interest in broadcast programs of the present invention further provides the step of; delivering ranking information of programs by making the ranking information based on the information from the database of the degree of interest in broadcast programs, in which the number of message for each program is stored.

In case that a program belongs to a series of programs, and the database of the degree of interest in broadcast programs stores the number of message for each program and also for each of the series of programs, the method delivering the degree of interest in broadcast programs of the present invention further provides the step of; delivering ranking information made by only the number of messages for each program.

In case that a program belongs to a series of programs, and the database of the degree of interest in broadcast programs stores the number of message for each program and also for each of the series of programs, the method delivering the degree of interest in broadcast programs of the present invention further provides the step of; delivering ranking information made by only the number of messages for each of the series of programs.

In case that the number of message for each program is counted every designated period, or the number of messages for a scene of each program is counted every designated period, the method delivering the degree of interest in broadcast programs of the present invention further provides the step of; delivering ranking information for programs or for scenes of the programs by making the ranking information every designated period.

In case that the number of message for each scene (designated interval) of a program is counted, the method delivering the degree of interest in broadcast programs of the present invention further provides the step of; delivering ranking information for scenes of programs based on the information from the database of degree of interest in broadcast programs.

At the method delivering the degree of interest in broadcast programs of the present invention, the messages for programs are supplied from viewers via the Internet.

The method delivering the degree of interest in broadcast programs of the present invention further provides the step of; obtaining messages from Web sites, chats, or bulletin boards in the Internet.

The method delivering the degree of interest in broadcast programs of the present invention further provides the steps of; limiting messages to be counted to messages being not counted, by keeping the time when messages were counted previously at the message counting means.

The method delivering the degree of interest in broadcast programs of the present invention manages messages every designated period, for example, one day, one week, one month.

The method delivering the degree of interest in broadcast programs of the present invention further provides the step of; discarding messages being older than a designated time.

The method delivering the degree of interest in broadcast programs of the present invention further provides the step of; selecting messages to be counted from one of the designated periods.

The method delivering the degree of interest in broadcast programs of the present invention manages messages every designated period, for example, a 1^{st} period from the present to the 1^{st} time, a Nth period from the present to the Nth time (N is an integer being two or more), and the N−1^{st} period is shorter than the Nth period.

The method delivering the degree of interest in broadcast programs of the present invention manages the message lists every period when the messages were supplied.

The method delivering the degree of interest in broadcast programs of the present invention further provides the step of; delivering the program list, the message list, the program information, and the ranking information to clients (users).

The method delivering the degree of interest in broadcast programs of the present invention further provides the step of; showing each of the clients the program list by delivering the program list.

The method delivering the degree of interest in broadcast programs of the present invention further provides the step of; making each of the clients select one program list from program lists for programs and for a series of programs, in case that a program belongs to a series of programs.

The method delivering the degree of interest in broadcast programs of the present invention further provides the step of; making each of the clients select one of buttons on the program list for making a user select either a program list for programs or a program list for a series of programs, in case that a program belongs to a series of programs.

The method delivering the degree of interest in broadcast programs of the present invention further provides the step of; making each of the clients show program information to users by obtaining the number of messages for programs every designated period from the database of the degree of interest in broadcast programs.

The method delivering the degree of interest in broadcast programs of the present invention further provides the step of; making each of the clients show reference information for programs to users by obtaining the reference information from the database of message lists.

The method delivering the degree of interest in broadcast programs of the present invention further provides the step of; making each of the clients show reference information for scenes (designated interval) of programs to users by obtaining from the database of message lists.

The method delivering the degree of interest in broadcast programs of the present invention further provides the step of; making each of the clients show a message list to users by obtaining a message list composed of the number of messages for a scene of a program every designated period.

The method delivering the degree of interest in broadcast programs of the present invention further provides the step of; showing tools for making each of the clients show the program information to users, on the program list.

The method delivering the degree of interest in broadcast programs of the present invention further provides the steps of; making each of the clients show ranking information to users, by obtaining the ranking information from the server delivering the degree of interest in broadcast programs of the present invention, and making each of the clients select one from the ranking information, and making each of the clients obtain a message list for the selected program and making each of the clients show the program to the user.

The method delivering the degree of interest in broadcast programs of the present invention further provides the steps of; making each of the clients show program tags as the ranking information to users by obtaining the program tags from the server delivering the degree of interest in broadcast programs of the present invention.

The method delivering the degree of interest in broadcast programs of the present invention further provides the steps of; making each of the clients select a program in the ranking information, and making each of the clients show to users the detailed information of the program.

In order to make the method delivering the degree of interest in broadcast programs of the present invention mentioned above work, a computer program is provided at the present invention.

The computer program of the present invention provides the steps of; storing messages supplied from viewers, counting the number of messages for each program by taking out the stored messages by using the program tag in the messages, and storing the counted number of messages for each program in a database of the degree of interest in broadcast programs.

In order to meet a case that a program belongs to a series of programs, the computer program of the present invention further provides the steps of; judging whether a program belongs to a series of programs or not by using a database of a series of programs in which relation between a program and a series of programs is stored, counting the message for a program and also for a series of programs when the program belongs to the series of programs, and storing the number of counted messages for both the program and for the series of programs in the database of the degree of interest in broadcast programs.

In case that a program is divided into many parts by setting a designated interval, the computer program of the present invention further provides the steps of; counting the number of messages every scene (designated interval) of the program, and storing the number of counted messages every scene of the program in the database of the degree of interest in broadcast programs.

In case that a period when the messages are counted is designated, the computer program of the present invention further provides the steps of; counting the number of messages for each program supplied every designated period, and storing the number of counted messages for each program every designated period in the database of the degree of interest in broadcast programs.

The computer program of the present invention provides the steps of; classifying the messages into messages for each program when the messages are supplied from viewers, and counting up the number of messages for each program in the database of the degree of interest in broadcast programs when the program tag of the message matches with the program tag in the database of the degree of interest in broadcast programs, and storing the counted up messages.

In order to meet a case that a program belongs to a series of programs, the computer program of the present invention further provides the steps of; judging whether a program belongs to a series of programs or not by using a database of a series of programs in which relation between a program and a series of programs is stored by using the classified result, counting up the number of messages for a program and also for a series of programs in the database of the degree of interest in broadcast programs when the program belongs to the series of programs, and storing the counted up messages.

In case that a program is divided into many parts by setting a designated interval, the computer program of the present invention further provides the steps of; counting up the number of messages every scene (designated interval) of the program in the database of the degree of interest in broadcast programs when the program tag of the message for the scene matches with the program tag in the database of the degree of interest in broadcast programs, and storing the counted up messages.

In case that a period when the messages are counted is designated, the computer program of the present invention further provides the steps of; counting up the number of messages for each program supplied every designated period in the database of the degree of interest in broadcast programs, and storing the counted up messages.

In case that plural program tags relating to one program or one series of programs are included in one message, the message is counted as one message, at the computer program of the present invention.

And also in case that plural program tags relating to one program or one series of programs are included in one message, the message is counted up as one message, at the computer program of the present invention.

The program tag has a structure to show that a message is for a program or for a series of programs, and when a program belongs to a series of programs, a message having this program tag is counted as a message for a series of programs, at the computer program of the present invention.

The program tag has a structure to show that a message is for a program or for a series of programs, and when a program belongs to a series of programs, a message having this program tag is counted up as a message for a series of programs, at the computer program of the present invention.

The computer program of the present invention further provides the step of; obtaining messages including reference information for each program supplied from viewers, making a message list including reference information for each program, and storing the message list in a database of message lists.

In case that a program belongs to a series of programs, the computer program of the present invention further provides the steps of; making a message list including reference information for the series of programs, and storing the message list for the series of programs in the database of message lists.

In case that the messages for each program are counted every designated period, the computer program of the present invention further provides the steps of; making a message list including reference information for each program every designated period, and storing the made message list in the database of message lists.

The computer program of the present invention further provides the step of; making a program list, in which programs and the number of messages for each of the programs are included, based on information from a database of program information in which information of programs is stored and information from the database of the degree of interest in broadcast programs.

In case that a program belongs to a series of programs, the computer program of the present invention further provides the step of; making a program list, in which programs and the number of messages for a series of programs are included, based on information from the database of program information, the database of the degree of interest in broadcast programs, and the database of a series of programs.

Further, in case that a program belongs to a series of programs, the computer program of the present invention further provides the step of; making a program list, in which programs and the number of messages for each program and also for each of the series of programs are included.

In case that the number of messages is counted every designated period, or the number of messages for scenes of programs is counted every designated period, the computer program of the present invention further provides the step of; making a program list, in which programs and the number of messages every designated period for each of the programs or the number of message for scenes of each of the programs every designated period are included.

In case that the number of messages is counted every designated period, or the number of messages for scenes of programs is counted every designated period, and a program belongs to a series of programs, the computer program of the present invention further provides the step of; making a program list, in which programs and the number of messages every designated period for each of the programs or the number of message for scenes of each of the programs every designated period are included, further in which a series of programs and the number of messages every designated period for each of the series of the programs or the number of message for scenes of each of the series of the programs every designated period are included.

The computer program of the present invention further provides the step of; making a message list including reference information for a designated program or a designated series of programs, when the program or the series of programs is designated.

The computer program of the present invention further provides the step of; making a program list for designated programs or a designated series of programs, when the programs or the series of programs is designated, based on the information from the database of program information and from the database of message lists.

The computer program of the present invention further provides the step of; delivering ranking information of programs by making the ranking information based on the information from the database of the degree of interest in broadcast programs, in which the number of message for each program is stored.

In case that a program belongs to a series of programs, and the database of the degree of interest in broadcast programs stores the number of message for each program and also for each of the series of programs, the computer program of the present invention further provides the step of; delivering ranking information made by only the number of messages for each program.

In case that a program belongs to a series of programs, and the database of the degree of interest in broadcast programs stores the number of message for each program and also for each of the series of programs, the computer program of the present invention further provides the step of; delivering ranking information made by only the number of messages for each of the series of programs.

In case that the number of message for each program is counted every designated period, or the number of messages for a scene of each program is counted every designated period, the computer program of the present invention further provides the step of; delivering ranking information for programs or for scenes of the programs by making the ranking information every designated period.

In case that the number of message for each scene (designated interval) of a program is counted, the computer program of the present invention further provides the step of; delivering ranking information for scenes of programs based on the information from the database of degree of interest in broadcast programs.

At the computer program of the present invention, the messages for programs are supplied from viewers via the Internet.

The computer program of the present invention further provides the step of; obtaining messages from Web sites, chats, or bulletin boards in the Internet.

The computer program of the present invention further provides the steps of; limiting messages to be counted to messages being not counted, by keeping the time when messages were counted previously at the message counting means.

The computer program of the present invention manages messages every designated period, for example, one day, one week, one month.

The computer program of the present invention further provides the step of; discarding messages being older than a designated time.

The computer program of the present invention further provides the step of; selecting messages to be counted from one of the designated periods.

The computer program of the present invention manages messages every designated period, for example, a 1^{st} period from the present to the 1^{st} time, a Nth period from the present to the Nth time (N is an integer being two or more), and the N−1^{st} period is shorter than the Nth period.

The computer program of the present invention manages the message lists every period when the messages were supplied.

The computer program of the present invention further provides the step of; delivering the program list, the message list, the program information, and the ranking information to clients (users).

The computer program of the present invention further provides the step of; delivering the program list, the message list, the program information, and the ranking information to clients (users).

The computer program of the present invention further provides the step of; showing each of the clients the program list by delivering the program list.

The computer program of interest in broadcast programs of the present invention further provides the step of; making each of the clients select one program list from program lists for programs and for a series of programs, in case that a program belongs to a series of programs.

The computer program of the present invention further provides the step of; making each of the clients select one of buttons on the program list for making a user select either a program list for programs or a program list for a series of programs, in case that a program belongs to a series of programs.

The computer program of the present invention further provides the step of; making each of the clients show program information to users by obtaining the number of messages for programs every designated period from the database of the degree of interest in broadcast programs.

The computer program of the present invention further provides the step of; making each of the clients show reference information for programs to users by obtaining the reference information from the database of message lists.

The computer program of the present invention further provides the step of; making each of the clients show reference information for scenes (designated interval) of programs to users by obtaining from the database of message lists.

The computer program of the present invention further provides the step of; making each of the clients show a message list to users by obtaining a message list composed of the number of messages for a scene of a program every designated period.

The computer program of the present invention further provides the step of; showing tools for making each of the clients show the program information to users, on the program list.

The computer program of the present invention further provides the steps of; making each of the clients show ranking information to users, by obtaining the ranking information from the server delivering the degree of interest in broadcast programs of the present invention, and making each of the clients select one from the ranking information, and making each of the clients obtain a message list for the selected program and making each of the clients show the program to the user.

The computer program of the present invention further provides the steps of; making each of the clients show program tags as the ranking information to users by obtaining the program tags from the server delivering the degree of interest in broadcast programs of the present invention.

The computer program of the present invention further provides the steps of; making each of the clients select a program in the ranking information, and making each of the clients show to users the detailed information of the program.

As mentioned above, according to the present invention, users can easily obtain the degree of interest in a program by receiving the number of messages for the program from the server delivering the degree of interest in broadcast programs. And the users can easily obtain the degree of interest in a scene (designated interval) of a program by receiving the number of messages for the scene of the program from the server delivering the degree of interest in broadcast programs.

Further, the users can easily obtain reference information (impressions and/or comments) for a program by receiving a message list for programs from the server delivering the degree of interest in broadcast programs. And also the users can easily obtain reference information (impressions and/or comments) for a scene of a program by receiving a message list for scenes of programs from the server delivering the degree of interest in broadcast programs.

According to the present invention, the users can obtain a program list, in which the title, the casts, the number of messages, and the degree of interest in each program are listed, from the server delivering the degree of interest in broadcast programs. Further, the number of message for each program supplied in a designated period can be counted.

According to the present invention, when a user judges whether the user watches/records a program or not, the users can easily obtain the degree of interest in the program of viewers and the reference information for the program of the viewers.

According to the present invention, when the number of messages for scenes (every designated interval) of a program is counted, the users can obtain the change of the degree of interest in the program in the passage of time. And the user can use this information, when the user wants to watch/record a specific scene of the program.

According to the present invention, when a program belongs to a series of programs, the users can easily obtain the degree of interest in both the program and the series of programs.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A server delivering the degree of interest in broadcast programs, comprising:
a counting means for counting the number of messages for each program supplied from viewers via a network; and
a delivering means for delivering the number of messages for each program that was counted at said counting means to users via a network as the degree of interest in each program.

2. A server delivering the degree of interest in broadcast programs in accordance with claim 1, further comprising:
a database of the degree of interest in broadcast programs for storing the number of messages for each program, counted at said counting means, and
said delivering means delivers the number of messages for each program to said users via said network as the degree of interest in each program by taking out the number of messages for each program from said database of the degree of interest in broadcast programs.

3. A server delivering the degree of interest in broadcast programs in accordance with claim 1, wherein:
said counting means further counts the number of messages for a scene of each program when said scene is designated, and also further counts the number of messages for each of a series of programs when a program belongs to a series of programs.

4. A server delivering the degree of interest in broadcast programs in accordance with claim 1, wherein:
each of said messages supplied from said viewers includes data identifying each of programs, and said counting means counts the number of messages for each program based on said data identifying each of programs, and
said delivering means delivers the number of messages for each program to said users, based on said data identifying each of programs.

5. A server delivering the degree of interest in broadcast programs in accordance with claim 3, wherein:
each of said messages supplied from said viewers includes data identifying each program and said scene of each program, and said counting means counts the number of messages for each program and said scene of each program based on said data identifying each program and said scene of each programs, and said delivering means delivers the number of messages for each program and said scene of each program to said users, based on said data identifying each program and said scene of each program, and
each of said messages supplied from said viewers includes data identifying each program and a series of programs, when a program belongs to a series of programs, and said counting means counts the number of messages for each program and each of said series of programs based on said data identifying each program and said series of programs, and said delivering means delivers the number of messages for each program and said series of programs to said users, based on said data identifying each program and said series of programs.

6. A server delivering the degree of interest in broadcast programs in accordance with claim 1, wherein:
said counting means counts the number of messages for each program supplied from said viewers via said network every designated period, and
said delivering means delivers the number of messages for each program counted at said counting means every designated period, to said users via said network, as the degree of interest in each program.

7. A server delivering the degree of interest in broadcast programs in accordance with claim 3, wherein:
said counting means counts the number of messages for each program and said scene of each program supplied from said viewers via said network every designated period, and said delivering means delivers the number of messages for each program and said scene of each program counted at said counting means every designated period, to said users via said network, as the degree of interest in each program and said scene of each program, and
said counting means counts the number of messages for each program and each of said series of programs supplied from said viewers via said network every designated period, and said delivering means delivers the number of messages for each program and each of said series of programs counted at said counting means every designated period, to said users via said network, as the degree of interest in each program and each of said series of programs.

8. A server delivering the degree of interest in broadcast programs in accordance with claim 1, further comprising:
a message list making means for making a message list for programs in which reference information for each program is stored, by obtaining said reference information for each program from said messages supplied from said viewers via said network, and
said delivering means delivers said message list to said users.

9. A server delivering the degree of interest in broadcast programs in accordance with claim 3, further comprising:
a message list making means for making a message list for each scene of programs in which reference information for each scene of programs is stored, by obtaining said reference information for each scene of programs from said messages supplied from said viewers via said network, and said delivering means delivers said message list to said users, further
said message list making means for making a message list for each of a series of programs in which reference information for each of a series of programs is stored, by obtaining said reference information for each of a series of programs from said messages supplied from said viewers via said network, and said delivering means delivers said message list to said users,

10. A server delivering the degree of interest in broadcast programs in accordance with claim 8, wherein:
said delivering means delivers a message in said message list to a user, when said message is selected by said user.

11. A server delivering the degree of interest in broadcast programs in accordance with claim 9, wherein:
said delivering means delivers a message every scene of a program in said message list to a user, when said scene is selected by said user, and
said delivering means delivers a message for a series of programs in said message list to a user, when said series of programs is selected by said user.

12. A server delivering the degree of interest in broadcast programs in accordance with claim 10, wherein:
said delivering means delivers said message list every designated period when said messages were supplied from said viewers to said users.

13. A server delivering the degree of interest in broadcast programs in accordance with claim 11, wherein:
said delivering means delivers said message list every designated period when said messages were supplied from said viewers to said users.

14. A server delivering the degree of interest in broadcast programs in accordance with claim 1, wherein:
said delivering means delivers a program list by designating a region or broadcasting stations and designating a broadcasting period to said users, wherein:
said program list includes program information in which a title of each program, the number of messages for each program or the modified degree of interest in each program that the number of messages for each program is divided by the number of messages for all programs in said program list are included.

15. A server delivering the degree of interest in broadcast programs in accordance with claim 14, wherein:
in case that each scene of programs is handled, said program list is made for each scene of said programs, and
in case that each of a series of programs is handled, said program list is made for each of said series of programs.

16. A server delivering the degree of interest in broadcast programs in accordance with claim 1, wherein:
said delivering means delivers a ranking list by designating a region or broadcasting stations and designating a broadcasting period to said users, wherein:
said ranking list shows programs in the order that their number of messages is large.

17. A method delivering the degree of interest in broadcast programs, comprising the steps of:
identifying each of messages, which include data identifying a program, supplied from viewers via a network, to which program each of said messages is related;
calculating the degree of interest in each program by using said identified messages; and
delivering the degree of interest in each program, calculated by using said identified messages, to users via a network.

18. A method delivering the degree of interest in broadcast programs, comprising the steps of:
identifying each of messages, which include data identifying a program and data identifying a scene in said program, supplied from viewers via a network, to which program and scene each of said messages is related;
calculating the degree of interest in each program and each scene of said program by using said identified messages; and
delivering the degree of interest in each program and each scene of said program, calculated by using said identified messages, to users via a network.

19. A method delivering the degree of interest in broadcast programs, comprising the steps of:
identifying each of messages, which include data identifying a program and data identifying a series of programs, supplied from viewers via a network, to which program and series of programs each of said messages is related, when said program belongs to a series of programs;
calculating the degree of interest in each program and each of said series of programs by using said identified messages; and
delivering the degree of interest in each program and each of said series of programs, calculated by using said identified messages, to users via a network.

20. A method delivering the degree of interest in broadcast programs in accordance with claim 17, wherein:
the degree of interest in each program is calculated every period when said messages were supplied from said viewers.

21. A method delivering the degree of interest in broadcast programs in accordance with claim 18, wherein:
the degree of interest in each program and each scene of said program is calculated every period when said messages were supplied from said viewers.

22. A method delivering the degree of interest in broadcast programs in accordance with claim 19, wherein:
the degree of interest in each program and each of said series of programs is calculated every period when said messages were supplied from said viewers.

23. A method delivering the degree of interest in broadcast programs, comprising the steps of:
identifying each of messages, which include data identifying a program and reference information for said program, supplied from viewers via a network, to which program each of said messages is related;
making a message list for programs by using said identified messages; and
delivering said message list to users via a network.

24. A method delivering the degree of interest in broadcast programs, comprising the steps of:
identifying each of messages, which include data identifying a program and data identifying a scene in said program, supplied from viewers via a network, to which program and scene each of said messages is related;
making a message list for programs and scenes of said programs by using said identified messages; and
delivering said message list to users via a network.

25. A method delivering the degree of interest in broadcast programs, comprising the steps of:
identifying each of messages, which include data identifying a program and data identifying a series of programs, supplied from viewers via a network, to which program and series of programs each of said messages is related, when said program belongs to a series of programs;
making a message list for programs and said series of programs by using said identified messages; and
delivering said message list to users via a network.

26. A method delivering the degree of interest in broadcast programs in accordance with claim 17, further comprising the steps of:
designating a region or broadcasting stations and designating a broadcasting period;
making a program list by obtaining program information in said designated region or broadcasting stations and said designated period and the degree of interest in each program; and
delivering said program list to said users via said network.

27. A method delivering the degree of interest in broadcast programs in accordance with claim 18, further comprising the steps of:
designating a region or broadcasting stations and designating a broadcasting period;
making a program list by obtaining program information in said designated region or broadcasting stations and said designated period and the degree of interest in each program and each scene of said program; and
delivering said program list to said users via said network.

28. A method delivering the degree of interest in broadcast programs in accordance with claim 19, further comprising the steps of:
designating a region or broadcasting stations and designating a broadcasting period;
making a program list by obtaining program information in said designated region or broadcasting stations and said designated period and the degree of interest in each program and each of said series of programs; and
delivering said program list to said users via said network.

29. A method delivering the degree of interest in broadcast programs in accordance with claim 17, further comprising the steps of:
designating a region or broadcasting stations and designating a broadcasting period;
making a ranking list by obtaining program information in said designated region or broadcasting stations and said designated period and the degree of interest in each program, and by disposing programs in said program information in the order that their degree of interest is large; and
delivering said ranking list to said users via said network.

30. A computer program delivering the degree of interest in broadcast programs, comprising the steps of:
identifying each of messages, which include data identifying a program, supplied from viewers via a network, to which program each of said messages is related;
calculating the degree of interest in each program by using said identified messages; and
delivering the degree of interest in each program, calculated by using said identified messages, to users via a network.

31. A computer program delivering the degree of interest in broadcast programs, comprising the steps of:
identifying each of messages, which include data identifying a program and data identifying a scene in said program, supplied from viewers via a network, to which program and scene each of said messages is related;
calculating the degree of interest in each program and each scene of said program by using said identified messages; and
delivering the degree of interest in each program and each scene of said program, calculated by using said identified messages, to users via a network.

32. A computer program delivering the degree of interest in broadcast programs, comprising the steps of:
identifying each of messages, which include data identifying a program and data identifying a series of programs, supplied from viewers via a network, to which program and series of programs each of said messages is related, when said program belongs to a series of programs;
calculating the degree of interest in each program and each of said series of programs by using said identified messages; and
delivering the degree of interest in each program and each of said series of programs, calculated by using said identified messages, to users via a network.

33. A computer program delivering the degree of interest in broadcast programs in accordance with claim 30, wherein:
the degree of interest in each program is calculated every period when said messages were supplied from said viewers.

34. A computer program delivering the degree of interest in broadcast programs in accordance with claim 31, wherein:
the degree of interest in each program and each scene of said program is calculated every period when said messages were supplied from said viewers.

35. A computer program delivering the degree of interest in broadcast programs in accordance with claim 32, wherein:
the degree of interest in each program and each of said series of programs is calculated every period when said messages were supplied from said viewers.

36. A computer program delivering the degree of interest in broadcast programs, comprising the steps of:
identifying each of messages, which include data identifying a program and reference information for said program, supplied from viewers via a network, to which program each of said messages is related;
making a message list for programs by using said identified messages; and
delivering said message list to users via a network.

37. A computer program delivering the degree of interest in broadcast programs, comprising the steps of:
identifying each of messages, which include data identifying a program and data identifying a scene in said program, supplied from viewers via a network, to which program and scene each of said messages is related;
making a message list for programs and scenes of said programs by using said identified messages; and
delivering said message list to users via a network.

38. A computer program delivering the degree of interest in broadcast programs, comprising the steps of:
identifying each of messages, which include data identifying a program and data identifying a series of programs, supplied from viewers via a network, to which program and series of programs each of said messages is related, when said program belongs to a series of programs;
making a message list for programs and said series of programs by using said identified messages; and
delivering said message list to users via a network.

39. A computer program delivering the degree of interest in broadcast programs in accordance with claim 30, further comprising the steps of:
designating a region or broadcasting stations and designating a broadcasting period;
making a program list by obtaining program information in said designated region or broadcasting stations and said designated period and the degree of interest in each program; and
delivering said program list to said users via said network.

40. A computer program delivering the degree of interest in broadcast programs in accordance with claim 31, further comprising the steps of:
designating a region or broadcasting stations and designating a broadcasting period;
making a program list by obtaining program information in said designated region or broadcasting stations and said designated period and the degree of interest in each program and each scene of said program; and
delivering said program list to said users via said network.

41. A computer program delivering the degree of interest in broadcast programs in accordance with claim 32, further comprising the steps of:
designating a region or broadcasting stations and designating a broadcasting period;
making a program list by obtaining program information in said designated region or broadcasting stations and said designated period and the degree of interest in each program and each of said series of programs; and
delivering said program list to said users via said network.

42. A computer program delivering the degree of interest in broadcast programs in accordance with claim 30, further comprising the steps of:
designating a region or broadcasting stations and designating a broadcasting period;
making a ranking list by obtaining program information in said designated region or broadcasting stations and said designated period and the degree of interest in each program, and by disposing programs in said program information in the order that their degree of interest is large; and
delivering said ranking list to said users via said network.
